(19) United States
(12) Patent Application Publication
(10) Pub. No.: US 2007/0288350 A1
(43) Pub. Date: Dec. 13, 2007

(54) Automated exchange for the efficient assignment of audience items

(75) Inventor: Mark M. Bykowsky, Bethesda, MD (US)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: Siena Holdings, LLC, Bethesda, MD (US)

(21) Appl. No.: 11/803,452

(22) Filed: May 14, 2007

Related U.S. Application Data
(60) Provisional application No. 60/799,907, filed on May 12, 2006.

(51) Int. Cl. G06Q 40/00; G06Q 30/00

(52) U.S. Cl. 705/37; 705/14

(57) ABSTRACT

An automated exchange system is provided which includes a smart electronic double auction for allocating audience items among prospective buyers and sellers and for calculating a set of prices for the audience items based on buyer bids from the buyers and seller offers from the sellers, including remote terminals for initiating and transmitting data including buyer bids and seller offers; and a central trade exchange system including a trading means for receiving buyer bids and seller offers from said remote terminals, simultaneously processing the buyer bids and the seller offers, identifying a set of trades in audience items between buyers and sellers which optimize gains obtained by buyers and sellers from the set of trades in audience items based on the bids and offers received by said trading means, and calculating a price for each audience item in the set of trades, and identifying rejected buyer bids and rejected seller offers.

### CROSS-REFERENCE TO RELATED APPLICATIONS

This application claims the benefit of priority under 35 U.S.C. 119(e) of U.S. Provisional Application No. 60/799,907, filed May 12, 2006, the entire disclosure of which is incorporated herein by reference.

### BACKGROUND OF THE INVENTION

This invention relates to an automated exchange and method for assigning advertising time and space, and, more specifically, to an electronic auction and method which determines, using complex mathematical algorithms, an efficient assignment of heterogeneous items between sellers to buyers and a set of transaction prices for such items, based upon “single-item” and “multiple-item” bids and offers.

Advertising time is currently assigned primarily through a burdensome series of sequential bilateral negotiations between buyers and sellers, or their representatives. Given the complex preferences buyers and sellers exhibit for these items, this method of assignment will likely not assign advertising time to those buyers that value it the most. For example, the vast majority of available blocks of television advertising time is subdivided into advertising spots and assigned through a series of bilateral negotiations between broadcasters/program syndicators and advertisers, or, more commonly, between a set of intermediaries acting on behalf of the respective parties. Economic theory suggests that the existence of the intermediaries creates a potential economic inefficiency. Intermediaries attempt to maximize their commissions. To this end, an intermediary acting on behalf of a seller compares the cost associated with finding an advertiser that is willing to pay more for a particular advertising spot, with the increased potential revenue from identifying such an advertiser. Due to the unavoidably high cost under bilateral negotiation of continuing to search for a buyer willing to pay a higher price, an intermediary currently has an incentive to find a reasonably “good” buyer, and then move on to find another buyer for a different advertising spot. On the other hand, a broadcaster/program syndicator maximizes its profits by finding the advertisers that value its advertising time available for sale most highly. Because of the different optimization problem that each attempts to solve, the seller cannot expect that its intermediary will necessarily act in a manner that maximizes the seller's profits given the intermediary's high search costs. An intermediary acting on behalf of a buyer creates a similar problem for the buyer. Because of these incentive problems, both buyers and sellers will likely leave “money on the table,” in that, viewed from the buy side, there exists a seller who is willing to sell the same spot for a lower price, or is willing to sell a better spot for the same or slightly higher price. Similarly, on the sell side, there exists a buyer that is willing to pay more for the spot than the current buyer.

Economic theory and experimental evidence strongly indicate that bilateral bargaining is unlikely to lead to the assignment of advertising time that optimizes the gains obtained by buyers and sellers. An inefficient assignment often occurs because of the lack of information that buyers and sellers have about each other's true willingness to participate in a trade—a situation described as “asymmetric information.” Problems caused by asymmetric information in bilateral bargaining environments are frequently observed. For example, a prolonged strike is a common outcome of a bilateral negotiation even though an agreement on terms would promote each party's welfare, or an opportunity is missed to sell an asset/service to the buyer that values it the most. Using a series of laboratory experiments described in “Auction Design for Composite Goods: The Natural Gas Industry” (Journal of Economic Behavior and Organization, September 1990, pp. 127-149), McCabe, Rassenti, and Smith report that when bilateral bargaining is used to trade natural gas the outcomes are Pareto-inferior (all parties make less profit) than when the market is coordinated with a smart auction. In general, both sides of the market left money on the table due to non-optimal trades. Such trades often impose important economic losses upon society.

There is no reason to believe that bilateral bargaining will lead to more efficient assignments of advertising time than it does for other items. Under bilateral bargaining, a buyer (seller) attempts to buy (sell) advertising spots by bargaining with, in a sequential manner, various sellers (buyers). To increase his share of the gains from trade, each bargainer has an incentive to misrepresent his willingness to trade. Bargainers attempt to limit the effect of this misrepresentation by soliciting bids or offers from alternative sources. Problems of obtaining the solicited information, combined with the fact that it is also likely to be misrepresented, often causes the bilateral bargaining mechanism to exhibit a poor ability to discover competitive market prices (i.e., prices that insure that no money is left on the table), which in turn ensures an inefficient assignment of advertising time. It has been found through an analysis of a series of laboratory experiments that the current process by which “traditional” (i.e., non-Internet media) media are traded is only 61% efficient. That is, the current sequential bilateral bargaining process advertisers and media sellers employ to trade traditional media only allows them to capture 61% of the available gains of trade. Given that over $100 billion in traditional media are traded each year in the U.S. alone, this analysis demonstrates that advertisers and media sellers are currently leaving multiple billions of dollars on the table each year by employing the current process to buy and sell media. Moreover, while the analysis took into account many of the most important features of the current buying and selling process, it did not take into account all of the factors that would likely reduce the efficiency of the current buying and selling process. Therefore, the derived efficiency estimate is likely to overstate the efficiency of the current buying and selling process.

In any environment where multiple items are up for sale, generating efficient assignments requires that buyers have the opportunity to place bids on the complete array of different, yet substitutable, items up for sale. Similarly, sellers must have the opportunity to place offers to sell their items to all buyers that may have an interest in acquiring them. Without such opportunities for buyer and sellers, the efficient assignment of items is not guaranteed, even if participants truthfully reveal their willingness to participate in a trade. For example, broadcast television advertisers often demonstrate a willingness to acquire advertising spots on multiple programs, subject to the condition that each spot provides access to a particular type of viewer (the advertiser's “target audience”). Virtually all programs attract a portfolio of different types of viewers. Consequently, an advertiser can typically acquire his desired level of access to his target audience in multiple ways, where a “way” is defined as any combination of advertising spots on one or more programs that in total attract the desired type and number of viewers.

Consider the following simple example. Suppose that an advertiser wishes to buy a set of advertising spots that will provide access to at least 100 female viewers, ages 18-49, in a given broadcast television market between 10:00-10:30 am on Monday morning.

Suppose, further, that the five stations that operate in that market attract the following number of such viewers to the programs being shown at that time:

Broadcast Television Station Viewers
(Monday: 10:00-10:30 AM

| | Station₁ | Station₂ | Station₃ | Station₄ | Station₅ |
|---|---|---|---|---|---|
| Viewers | 30 | 70 | 30 | 70 | 100 |
| (Females, 18-49) | | | | | |

The advertiser has the opportunity to buy a set of spots that will provide access to 100 female viewers in the following six different ways
Station₅=100
Station₁+Station₂=100
Station₂+Station₃=100
Station₃+Station₄=100
Station₂+Station₄>100
Station₁+Station₄=100

To increase the likelihood of obtaining access to his desired viewers at the least cost, the advertiser must simultaneously negotiate with five different television stations and throughout this negotiation process calculate and compare the cost effectiveness of the six alternatives. For example, a change in Station4's offer to sell a spot requires the advertiser to recalculate the cost effectiveness of three different alternatives (i.e., Station₃+Station₄; Station₂+Station₄; and Station₁+Station₄). The number of re-calculations that must take place given a change in any one station's offer increases significantly with an increase in the number of television stations in a given market and the number of programs that attract the buyer's target audience.

The above evaluation and re-evaluation are unthinkable under the current method by which advertising time is bought and sold because television stations typically do not submit their offers to sell advertising time to buyers simultaneously, and because of the very large number of combinations of advertising spots on various programs and various stations that can often satisfy an advertiser's requirements.

There are many other reasons why the current method for assigning advertising time is highly unlikely to produce efficient assignments. For example, broadcasters typically have blocks of continuous seconds of advertising time to assign to advertisers, in which each continuous block of seconds can be partitioned in several different ways. Moreover, advertisers typically request a particular advertising spot length. This heterogeneity in spot length preference among advertisers makes it possible to partition, say, a 60-second block of continuous seconds in multiple ways—four 15-second spots, two 30-second spots, one 30-second and two 15-second spots, or simply a single 60-second spot. To ensure the efficient assignment of time, broadcasters must evaluate and compare the numerous ways in which a block of seconds can be partitioned and sold to buyers. However, under current trading methods, time is assigned approximately on a first-come, first-serve basis. Consequently, each sequential assignment of advertising spots limits the set of spots that may be assigned subsequently and, in so doing, may make it impossible to assign spots to the advertisers that value them most.

Advertising spots are typically acquired weeks, and in some cases months, in advance of airing advertisements. Because of stochastic events (e.g., news events, unanticipated competitive responses, worker strikes, mergers and acquisitions), the value an advertiser places on an advertising spot fluctuates during the period beginning when the spot is acquired and ending when the advertisement is finally aired. Changes in such valuations expose broadcasters and syndicators to the risk of selling their advertising time too cheaply, while advertisers incur the risk of overpaying for their acquired spots. Both sides of the market respond to their respective risks by selling and buying advertising time over an extended period of time.

Participants have developed other methods for managing the price risk. For example, broadcasters respond to the risk by selling a portion of their advertising time on a “preemptable” basis. A preemptable spot is a spot sold to an advertiser that the broadcaster may take back and resell for a higher price prior to the airing of the advertisement. The cost a broadcaster incurs from managing its price risk in this manner is equal to the price discount it must provide an advertiser to compensate it for assuming the risk of being preempted.

Some advertisers manage the price risk by simply walking away from a purchase agreement. Their ability to walk away occurs because, first, an advertising spot is currently paid for only after the advertisement is aired, and second, it is simply too costly for broadcasters to go after defaulters. The cost advertisers currently pay for handling price risk in this manner is equal to the “default premium” broadcasters impose upon all advertisers (both defaulters and non-defaulters).

The tendency for broadcasters and advertisers to sell and buy advertising time weeks, and sometimes months, in advance of the airing of the advertisement also creates uncertainty regarding the exact number of target viewers that will be attracted to a given program. This uncertainty exposes both buyers and sellers to “audience delivery” risk. More precisely, broadcasters face the risk, in selling advertising time on a particular program, of underestimating the number of targeted viewers that will be attracted to the program, while advertisers face the risk of overestimating the access that will ultimately be provided.

To handle audience delivery risk, advertisers often obtain a guaranty from broadcasters that a particular advertising spot will provide access to a minimum number of targeted viewers. Such a guaranty is, in effect, an insurance policy for which advertisers pay a premium over the cost of acquiring the spot on an “uninsured” basis. Broadcasters handle audience delivery/access risk by providing a high estimate of the number of likely viewers that can be accessed through a spot on a given program. When the estimated number of viewers is insured, the cost of an overly optimistic estimate comes in the form of having to “make good” by providing additional access to targeted viewers in the future. While there is no direct cost associated with an overly optimistic estimate when the broadcaster does not insure, he does incur a cost equal to the price discount he must provide to induce an advertiser to buy advertising spots on an uninsured basis. The efficient assignment of advertising time requires that audience delivery risk and price risk be assigned to the buyers and sellers that are most willing to assume such risk. However, the crude approach by which the current method attempts to assign audience delivery risk and price risk makes it unlikely that such risks will be assigned efficiently.

There are numerous other reasons why the current method is highly unlikely to assign advertising time in an efficient manner. For example, sellers often require that advertising time be sold only on a “program” basis, as opposed to a “day-part” basis. This decision would lead to an inefficient assignment if advertisers were willing to pay more for spots when acquiring them on a “day-part” basis. In addition, sellers sometimes bundle advertising time on a highly desired program with advertising time on a less desired program. The seller's desire to do this arises, in part, from its concern that it may be unable to sell the advertising time on the less desirable program. Under the current methods, in such a situation a single buyer must acquire an entire bundle of advertising spots. However, there are numerous situations in which such bundling will not lead to the efficient assignment of spots to advertisers. Consider an example where there are two advertising spots (Spot A and Spot B) for sale, each on a different television program, and where three different advertisers uniformly prefer Spot A to Spot B. For purposes of illustration, suppose the three advertisers place the following values on Spot A and Spot B.

Commercial Spot Assignment

| | Spot A | Spot B |
|---|---|---|
| Advertiser #1 | 10* | 3 |
| Advertiser #2 | 9 | 5 |
| Advertiser #3 | 7 | 6* |

The efficient assignment assigns Spot A to Advertiser #1 and Spot B to Advertiser #3. However, this assignment is impossible when the seller requires that both spots be sold on a bundled basis to a single buyer.

Finally, national advertisers currently buy access to a large national audience from the networks (e.g., ABC, CBS, NBC) through a single bilateral negotiation with each network. While this may be transaction-cost-minimizing, such network advertising has an important undesirable feature from some advertisers' perspectives. Under network advertising, the advertiser is constrained to buy advertising spots from all of the network's affiliates that have elected to exhibit the network's program, regardless of whether such spots are good buys in each affiliate's local broadcast market. There may be local broadcast stations that, from the advertisers' perspective, can provide much better buys. In addition, some of the network advertising spots may occur in local broadcast markets that are outside the geographic service area of the advertiser. This undesirable feature of network advertising is due to “station bundling.” Importantly, the existing National Spot Market, in which national advertisers buy advertising spots directly from local broadcast stations or their agents, can never effectively overcome the problems associated with station bundling because buyers find it too expensive to negotiate with the sellers in the many individual geographic areas for which a more efficient assignment of advertising time from sellers to buyers is possible.

Because of the current method's poor price discovery features, the substantial price risk it imposes upon market participants, the importance of assigning audience delivery risk to the entity that can assume it most efficiently, participants' reliance on intermediaries whose incentives may differ from their own because of intermediaries' high search costs, the inefficiencies associated with network advertising, the inefficiencies associated with the bundling of advertising spots, and the absence of a mechanism to evaluate complex preferences to create an assignment of advertising time from sellers to buyers that will optimize the gains from trade, a more economically efficient method of assigning broadcast television advertising time is needed. However, because buyers (e.g., television advertisers and ad agencies) and sellers (broadcasters and cable operators) vary in their preferences regarding the manner in which advertising time should be sold (e.g., preemptable versus non-preemptable), the geographic location and demographic characteristics of the viewers attracted to the offered and desired spots, as well as, the day and time location of such spots, it is widely believed that the preferences that buyers and sellers exhibit are simply too complex to allow trading by any method other than through a sequential bilateral bargaining process.

While the Internet has lead to new approaches for the buying and selling of advertising time, none has solved the advertising time assignment problem. For example, BuyMedia (http://www.BuyMedia.com), which ultimately failed, provided software that allowed advertisers to communicate directly to broadcast television stations their interest in buying advertising spots. Following such an expression of interest, the television station and advertiser attempted to complete a trade through bilateral negotiation.

OneMediaPlace (http://www.OneMediaPlace.com), which ultimately failed, provided advertisers the opportunity to submit via the Internet a “Request for Proposal” (“RFP”) to acquire advertising spots. This RFP was sent to member sellers who are capable of satisfying the buyer's needs. Interested sellers responded by sending an offer to sell to the buyer. The buyer attempted to complete a trade with one or more sellers through a series of sequential bilateral negotiations.

MediaPassage.com (http://www.mediapassage.com) is another Internet “portal” that enabled buyers to submit an “avail request” to a collection of prospective sellers in the hope of obtaining advertising spots or written copy space. Again, any trade took place after a series of sequential bilateral negotiations. OneMediaPlace (also referred to as AdAuction) has attempted to employ an auction to assign advertising spots to buyers. Under this process, which ultimately failed, buyers competed against each other to acquire spots from broadcasters.

More recently, eBay has attempted to institute a centralized market wherein cable networks compete with each other to satisfy a national advertiser's need for spots. The eBay system allows advertisers to reveal to cable networks the number of cable viewers they wish to have to. Cable networks respond by expressing, in the form of an ask price, their willingness to sell their attracted viewers to the advertisers. Armed with this information, advertisers attempt to induce each cable network to lower their asking prices in an effort to obtain a lower price for their desired viewers. According to recent reports, cable networks have decided not to participate in this simple bulletin board-like trading process, believing that it does not represent a more efficient trading process and that it will not allow them to earn more revenue than the revenue they earn from the current buying and selling process. In the analysis of a series of laboratory experiments referenced above, it was found that the proposed eBay trading platform is even less efficient than the current buying and selling process. Moreover, the analysis demonstrated that the proposed eBay trading platform would have reduced not only the revenue earned by media sellers (e.g., cable networks), but would have also lowered the financial return advertisers earn from their advertising investments.

The above and other Internet-based methods (i.e., http://www.AdOutlet.com, http://www.MediaSpaceBank.com) are similar in that none provides a fundamental change in the way in which advertising time is currently bought and sold. With the exception of AdAuction's and later eBay's use of a simple auction to assign advertising spots, each existing approach simply attempts to create an Internet version of the current method. The “simple” auction proposed by AdAuction and eBay do not permit advertisers to express their complex preferences and, furthermore, by inducing only one side of the market, buyers in the case of AdAuction and sellers in the case of eBay, to compete among themselves for the right to engage in a trade, it assigns a disproportionate amount of the gains from trade to the side of the market that is not required to compete. This same can be said for the one-sided (i.e., single seller (Google), multiple buyers) auction employed by Google for assigning Internet users to competing buyers. That is, by eliminating any possibility that sellers may compete among themselves to sell to buyers, the auction process employed by Google to sell access to Internet users to advertisers is biased in favor of Google, and against buyers. Moreover, the Google auction process does not permit advertisers to express their complex preferences. More importantly, none of the proposed methods for the trading of traditional advertising time attempts to address the issue of creating a market that represents a “win/win” for both buyers and sellers. That is, none of these new methods addresses the problem of creating a market that enables buyers to earn more money from their advertising investments and allows media sellers to obtain higher prices for their sold spots, simultaneously.

In addition to auctions that assign advertising time, there has generally been a rapid growth, particularly on the Internet, in the use of one-sided auctions (e.g., single seller, multiple buyers) to assign items for sale to competing buyers. The auctions used are “simple” in that they permit prospective buyers to submit bids for individual items only (e.g., an IBM computer or a Hewlett Packard printer). Because of the bid's single-item nature, an individual that wishes to acquire two items (e.g., an IBM computer and a Hewlett Packard printer) must, in a “simple” auction, submit an independent bid for each item. From the auctioneer's perspective a “simple” auction has the advantage that identifying the winning bid is straightforward. In the case where “n” homogeneous units of the item are up for sale, selecting the winning bidders involves simply identifying the “n”-highest bids (assuming each winning bidder requests no more than one unit). In addition, despite the variety of possible auction pricing rules (e.g., pay one's bid, pay the highest rejected bid), identifying the prices for the sold items in a “simple” auction is also straightforward.

Items for sale are considered “heterogeneous” when a prospective buyer does not consider one item a perfect substitute for another. The use of a “simple” auction to assign heterogeneous items is appropriate if the value placed on each item by any buyer, or the cost of providing each item by a seller, is independent of which other items he buys or provides.

If each buyer's valuation and each seller's cost of providing any collection of items is purely additive (e.g., the value a buyer places on items A and B as a package is simply the sum of the value the buyer places on them individually), there exists a host of market mechanisms that can create an efficient assignment of heterogeneous items to the buyers that value them the most. However, in many instances, the valuations prospective buyers have for a collection of items may be super-additive. For example, a buyer may desire to purchase a printer only if he also purchases a computer. The value of a combination of items is said to be super-additive if the value of the combination exceeds the sum of the individual values. Similarly, the cost to provide a combination of items is sub-additive if the cost to provide the combination is less than the sum of the costs to provide the individual items. The use of a “simple” auction to assign multiple items in such circumstances may generate several undesirable outcomes, including an inefficient assignment of items and, in some instances, financial losses for participants.

Assignment problems become even more complicated when, in addition to the existence of super-additive valuations and sub-additive costs, there are multiple sellers and buyers. Under such conditions, the identification of the efficient assignment of items and the prices at which the items should trade becomes problematic. These problems are exacerbated in instances where the items traded are “multi-dimensional.” An item may be considered “single-dimensional” if the quantity demanded and supplied for the item can be accurately measured using a single metric or dimension. For example, the quantity demanded and supplied involving the right to emit a pre-specified gas into the earth's atmosphere (a so-called “pollution emission credit”) can be fully measured in terms of a single dimension—weight (e.g., pounds, tons). An item may be considered “multi-dimensional” if the quantity demanded and supplied for the item can only be fully measured using multiple dimensions.

For example, an advertising spot on a television program is a multi-dimensional item in that it attracts a variety of different viewer types (e.g., males and females) and, moreover, these different viewer types are considered non-substitutes (i.e., heterogeneous) from the perspective of the buyer of the advertising spot. The number of dimensions of an advertising spot is a function of the number of different viewer types who are attracted to the program in which the advertising spot is inserted.

Advanced economic thinking, the ability to conduct laboratory research experiments to test any auction's efficiency, reductions in the cost of computer processing power, and the data transmission capabilities of communications networks now make it possible to design market mechanisms that solve difficult assignment problems. Taken together, these factors can lead to the development of entirely new and, importantly, more economically efficient methods of solving assignment problems involving heterogeneous, multi-dimensional items, and involving multiple buyers and sellers. For example, it is now possible to solve assignment problems in which participants constrain the set of feasible assignments through the specification of a set of “complex preferences.” Broadly speaking, a “complex preference” is specified when a buyer or seller places one or more logical constraints on the set of items they would be willing to buy or sell. For example, a complex preference is specified by a buyer (seller) who has super-additive values (sub-additive costs) and declares a “package” bid (offer) such as, “I will buy (sell) item A if and only if I also buy (sell) item B.” A complex preference is also specified by a buyer (seller) who is indifferent to buying (selling) some subset of items and declares a “subset” bid, for example, “I wish to buy (sell) at most (at least) three of the following five items C, D, E, F, or G.” A complex preference may also be specified by a buyer (seller) who is indifferent between trading a specific item with one set of associated characteristics or another and declares, for example, “I will pay (accept) $100 for item H if it is provided with a two-year warranty, but only $40 if it is provided with a one-year warranty.” The last type of complex preference is particularly interesting. In many instances, an item can be defined by a set of characteristics that includes both “fixed” and “flexible” characteristics. A “fixed” characteristic is one that is established prior to sale, while a “flexible” characteristic is one that is established at the time of sale from a set of mutually exclusive alternatives. For example, an advertising spot is characterized by a set of fixed characteristics (of day location, geographic location) and by a set of flexible characteristics (e.g., “Insured Audience Delivery/Non-Insured Audience Delivery”).

Assignment problems whose solutions involve the assignment of flexible characteristics to items may be referred to as “characteristic-defining” assignment problems. Identifying important flexible characteristics in trading environments and solving characteristic-defining assignment problems can result in much more efficient assignments. For example, excessive demand for electricity at peak-load periods may require service interruption for some consumers. The risk of such interruption cannot be assigned to those consumers least willing to pay for reliable service unless consumers have the opportunity to clearly express their willingness to acquire electricity on both an “interruptible” and “non-interruptible” basis during peak-load periods.

One method of satisfying a set of complex preferences among buyers and sellers over a variety of heterogeneous items involves creating a single, centralized market for such items, wherein buyers and sellers can place single and multi-item bids and offers which specify their complex preferences and the individual price levels of which differ according to a set of characteristics that help define the nature of the traded items. Under such a single, centralized market, one or more specially tailored mathematical algorithms can be used to identify a set of assigned items, the collection of buyers and sellers that are included in the assignment, and a set of prices for items assigned from sellers to buyers. Such a single, centralized market that uses mathematical algorithms to process bids and offers collected via a computer network from both buyers and sellers is called a “smart” electronic double auction (“SEDA”). Several examples follow.

The first published example of a “smart” auction that handles complex buyer preferences was designed and experimentally tested to trade packaged combinations of airport takeoff and landing slots (“A Combinatorial Auction Mechanism for Airport Time Slot Allocation,” Stephen J. Rassenti, Vernon L. Smith, and Robert L. Bulfin, Bell Journal of Economics, Fall 1982). Sellers (various airport authorities) could offer a limited number of slots per 15 minute time period during each day, and buyers (airlines) could express their willingness to pay for various routes (packages of slots) given their logistic constraints. The auction was conducted as a one-shot sealed bid. The allocation that maximized total revenue to the airports was computed, and prices for each similar slot were computed to be as close to uniform as possible. The airport slot auction was based on the Ph.D. dissertation of Stephen Rassenti (“0-1 Programming Problems” University of Arizona, 1981), which also discussed how to use a “smart” auction to differentially assign the costs of producing public television programs to the PBS member stations who each have complex preferences with regard to the set of programs they would prefer to air. The airport slot auction does not solve a “characteristic-defining” assignment problem.

An article authored by Jeffrey Banks, John Ledyard, and David Porter entitled “Allocating Uncertain and Unresponsive Resources: An Experimental Approach,” Rand Journal of Economics (Vol. 20 (1) Spring 1989, pp. 1-25), describes a SEDA, termed the Adaptive User Selection Mechanism (“AUSM”), that allocates multiple resources among users in the presence of supply and demand uncertainties, no supply inventories, fixed production capacity, and significant demand indivisibilities. AUSM is an experimental auction in which buyers (e.g., private firms that design an instrument that uses Space Station resources to produce an output) submit single-item bids for access to a single resource (e.g., pressurized volume within the Space Station or data management services) and multi-item bids for packages of such resources. Suppliers of the fixed resources submit offers to provide the resources. Based upon these bids and offers a mathematical algorithm solves for the “allocation” that maximizes reported gains from trade (i.e., reported consumer demand plus producer surplus). To facilitate solving a “threshold problem,” buyers that wish to acquire single or small packages of such resources can coordinate with other buyers in an attempt to defeat a buyer with a high package bid for an encompassing collection of resources. The tentative total surplus maximizing allocation and the prices that support it are revealed to the market participants. Constrained by certain rules, participants have the opportunity to revise their bids and offers and, following these revisions, the algorithm calculates another allocation and a set of prices consistent with that allocation. The process continues until no participant changes his submitted bid or offer. AUSM does not solve a “characteristic-defining” assignment problem.

An article authored by Stephen Rassenti, Stanley Reynolds, and Vernon Smith entitled “Cotenancy and Competition in an Experimental Auction Market for Natural Gas Pipeline Networks,” which appeared in Economic Theory (Vol. 4 (1) 1994, pp. 41-66) describes a triple auction, Gas Auction Net, that determines an allocation of gas and pipeline capacity among sellers, buyers and transporters, and a set of prices, one for every gas intake, and withdrawal node in the network. Gas Auction Net is an experimental smart electronic triple auction in which wholesale buyers of gas submit bids to purchase gas delivered to their specific locations; gas suppliers submit offers to sell gas from their specific locations; and pipeline owners submit offers to sell transportation capacity over particular segments of the gas pipeline network. Based upon these bids and offers, a mathematical algorithm solves for an initial tentative allocation of resources that would maximize gains from trade, which are revealed to the market participants. Constrained by the rule that they may only increase their bids or decrease their offers, participants are given several rounds in which to make revisions.

After each revision the algorithm recalculates the tentative allocation and the set of prices that support it. The process ends at a pre-specified final round. The Gas Auction Net does not need to solve a “characteristic-defining” assignment problem as the item of value to any buyer at a particular location is of uniform delivered cost regardless of its source.

The Automated Credit Exchange formerly operated a SEDA for the trading of a variety of items known generically as “pollution emission credits.” ACE's largest market was for those credits called RECLAIM Trading Credits (“RTCs”), which grant their owner a license to emit one pound of oxides of nitrogen or sulfur (specified by the emission credit) into the Los Angeles air basin. ACE participants submitted single-item and/or multi-item bids and offers to buy, sell, and swapped up to 120 different types of RECLAIM emission credits, or 28 types of other pollution emissions credits. Based upon these bids and offers, a mathematical algorithm determined that collection of trades that maximized the revealed gains from trade. In addition, a separate mathematical algorithm determined a set of prices that were consistent with this allocation. Participants were confidentially notified whether their order(s) are part of this allocation. All participants received the prices that were consistent with this allocation, as well as high bids and low offers for credit types where the allocation showed no trade. The double auction proceeded in a sequence of bidding rounds in which the participants had the opportunity to add new bids and offers, improve those bids and offers that were included in the current allocation, and remove or revise other bids and offers. After each successive round an algorithm calculated another allocation and a set of prices. In most cases, the process continued for a minimum of three and a maximum of five rounds. Following the third round, if the change in the total surplus and the change in trading volume was less than 5% between rounds, the auction “closed.” Following the “close” of the double auction, trades for all emission credit types were “executed.” In general, non-marginal orders traded at their respective market prices, while marginal orders traded within each order's requirements (i.e., sellers received no less than they asked while buyers paid no more than they bid), subject to the condition that the resulting prices supported the optimized allocation. Trade execution involved the transfer of funds from buyers to sellers via an intermediate settlement account and emission credits from sellers to buyers via an intermediate settlement account. The RECLAIM version of the Automated Credit Exchange solved a form of “characteristic-defining” assignment problem in the flexible characteristics defined by “zone” and “cycle.”

### BRIEF SUMMARY OF THE INVENTION

The invention applies to an automated exchange and method for the trading of audience items that are currently traded primarily through a burdensome and inefficient series of sequential bilateral negotiations between buyers and sellers, or their representatives. The current trading method is particularly inappropriate given the complex preferences participants exhibit for the traded items. The automated exchange of the present invention, by means of a “smart” electronic double auction (“SEDA”), makes it possible to create entirely new methods by which participants can express their complex preferences for multiple, heterogeneous, multi-dimensional audience items, and have such preferences properly evaluated to create an assignment of items from sellers to buyers that will optimize the gains from trade. The automated exchange of the invention also represents an entirely new method by which participants can trade audience items, with substantial efficiency advantages over the current method by which audience items are traded. Such advantages include substantially improving the process (i.e., the price discovery process) by which market prices guide market participants to the set of trades that generate the greatest gains of trade, reducing transaction costs, enabling buyers to express in a simple and concise manner their complex buy orders and have those market orders filled quickly and efficiently, assigning price and audience access risks to those entities most willing to assume such risks, increasing the amount and quality of the market information regarding the willingness of participants to trade items in existing and new configurations, enabling sellers to express their willingness to assume the risk of selling different “demographics” on an insured/guaranteed basis, enabling buyers to better express the value they place on having their advertising positioned near another firm's advertisement, better aligning the interests of the intermediary and the buyer and seller by lowering search costs, and by processing the complex set of preferences submitted electronically, the automated exchange represents an entirely new method by which participants can trade audience items.

Analyzing the results from a series of laboratory experiments described in a report entitled “eBay Versus an NYSE-like Market: The Effect of Changing the Media Buying and Selling Process on Market Participants,” the present inventor found that the present invention represents a vast improvement over the current process by which traditional (i.e., non-Internet) media are bought and sold. For example, according to the analysis, the present invention enables market participants to capture 82% of the gains of trade that are available to be captured in the advertising market, compared to only 61% for the existing buying and selling process. Moreover, according to the analysis, the present invention represents a “win/win” for both buyers and sellers. In particular, the present invention allows advertisers to earn substantially higher returns from their advertising investments and enables media sellers to earn more money from their advertising spots, simultaneously. The efficiency improvements made possible from the present invention will enable advertisers and media sellers to earn billions in additional financial gains each year.

The automated exchange of the invention employs a SEDA, which uses specially tailored mathematical algorithms to process complex bids and offers for audience items submitted electronically to the exchange by buyers and sellers. An audience item is any form of advertising time and/or space in any media environment. Examples of audience items include advertising time or commercial spots on cable television, broadcast television, direct broadcast satellite television, and radio programs; and written copy space in magazines and newspapers and display space on billboards. Since advertising ultimately provides access to recipients of the advertisement, audience items are also referred to herein as access to recipients, i.e., viewers, listeners, readers, etc., and other terms describing exposure events of a recipient(s) to the advertisement, such as impressions, eyeballs, etc. An audience item may also include advertising time and/or space provided electronically by an interconnected network of computers (e.g., the Internet) and access to the recipients, such as viewers and listeners, associated therewith. The automated exchange of this invention uses a SEDA to determine an efficient assignment of heterogeneous audience items from competing sellers to competing buyers, and a set of transaction prices for the assigned items based upon the single and multiple-item bids and offers submitted. The assignment of items is considered efficient when no other feasible assignment can produce higher gains for all buyers and sellers given their submitted bids, offers and constraints.

The present invention offers several essential improvements to automated exchanges, including that presented in U.S. Patent Application Publication No. 2002/0013757 A1 for U.S. patent application Ser. No. 09/731,785 filed Dec. 8, 2000, which is incorporated by reference for all purposes, (hereinafter “the '785 application”). Like the '785 application, the present invention employs a “smart” electronic double auction (“SEDA”) for the assignment of audience items and involves the submission of single item and multi-item bids and offers and a set of logical constraints to a centralized trading platform and a set of specialized mathematical algorithms that determine the efficient assignment of audience items based upon those submitted bids and offers and logical constraints, and a set of prices that is consistent with the efficient assignment of such items.

However, the present invention greatly improves upon the efficiency of the final assignment. Among other things, the present invention improves upon the price signals that guide participants to establish the set of “flexible” characteristics that assist in defining an audience item. For example, in contrast to the '785 application, with the present invention sellers are able to assign a unique offer price to each demographic category (e.g., Males 18-49, Females 50-64) across the four different bases upon which audience items are typically sold (i.e., preemptable, insured; preemptable, uninsured; non-preemptable, insured; and non-preemptable, uninsured basis). With this capability, the present invention can satisfy the real-world complex needs of buyers and sellers of audience items and provide the efficient assignment of audience items, and the rights that define such items, across buyers and sellers.

While a seller may demand little or no premium for guaranteeing the number of Males attracted to a given television or radio program, the same seller may demand a substantial premium for guaranteeing the number of Females attracted to the same program. The difference in the seller's willingness to guarantee one demographic (e.g., Males) versus another demographic (e.g., Females) reflects the fact that different demographics may have different program viewing substitution possibilities. The greater the viewing or listening substitution possibilities for a given demographic and the greater the changes in those substitution possibilities, the greater the uncertainty regarding the quantity of that demographic that will be delivered by a given program.

The inability of a seller with the invention of the '785 application to assign a unique offer price to each demographic category (e.g., Males 18-49, Females 50-64) across the four different bases upon which audience items are typically sold (i.e., preemptable, insured; preemptable, uninsured; non-preemptable, insured; and non-preemptable, uninsured basis) will distort the information the market receives regarding the willingness of sellers to trade the audiences delivered by their exhibited programs and, therefore, will distort the price signals market participants receive regarding the relative cost and benefits of acquiring a particular demographic and/or audience item on a particular basis. This distortion in price signals can prevent the efficient assignment of audience items, as well as the efficient assignment of rights across buyers and sellers.

The present invention improves upon the '785 application in other important ways. When buying audience items, buyers often wish to satisfy “reach” and “frequency” requirements. The term “reach” refers to the number of unduplicated viewers that are exposed to an advertisement, while the term “frequency” refers to the number of times the average viewer is exposed to an advertisement. When acquiring audience items, buyers often wish to access a minimum number of unduplicated viewers, while at the same time wish to ensure that the average viewer is exposed to the advertisement, say, three times within a given period of time. Using industry terminology, a buyer that is buying time in the national spot market, may wish to acquire access to Females, 18-49 years of age, in the New York DMA, acquire 250 “ratings points” involving that demographic (commonly referred to as targeted ratings points), and acquire a frequency of 3.5 over a period of one week. Here, a ratings point is simply the percentage of the Female, 18-49 year old population in the New York DMA that is reached by the advertisement. Together, the combination of a buyer's reach and frequency requirements defines the buyer's buy program.

However, under the '785 application, the buyer cannot establish those exact buy parameters. Rather, the buyer must resort to crude proxies for these desired and industry-accepted buy parameters. By making it impossible for the buyer to express exactly its buy preferences, the use of proxies distorts the buy information submitted to the market. In particular, it distorts information the market receives regarding what the buyers truly wish to acquire. It also distorts the information the market receives regarding the willingness of buyers to pay for the spots up for sale. Taken together, these distortions will lead to the wrong price signals and, thus, to an inefficient assignment of audience items. In addition, by increasing the likelihood that their buy order will be filled with less or undesirable spots, the use of proxies reduce the financial return buyers earn from their advertising investment. This reduction in financial return reduces the value buyers place on participating in the market. The present invention eliminates this significant impediment to an efficient and successful market by allowing buyers to employ the same buy parameters they employ in the current buying and selling process. Moreover, the present invention enables buyers to define their buy programs in even more precise terms by enabling them to express their willingness to acquire multiple spots within a single episode of a given television or radio program.

In addition, the present invention provides both buyers and sellers the flexibility they need to reduce the likelihood that they will conduct a trade with an undesirable trading partner. For example, unlike the invention of the '785 application, the present invention permits sellers to examine provisional trades and to reject those trades which, although the bid price exceeds the ask price, the bid price fails to compensate the seller for the sub-standard nature of the advertisement. In addition, unlike the invention of the '785 application, the present invention permits buyers to more precisely identify the set of programs from which their acquired viewers can be drawn.

Finally, the present invention improves upon application '785 in another important way. Buyers sometimes desire to have their advertisements placed after or before a competitor's advertisement or before or after an advertisement that has a complementary relationship with its own advertisement. Unlike the invention of '785 application, the present invention permits buyers to identify where to place its own advertisement in relationship to another firm's advertisement.

The invention includes an automated exchange system including a smart electronic double auction for allocating audience items among prospective buyers and sellers and for calculating a set of prices for the audience items based on buyer bids from the buyers and seller offers from the sellers, comprising: remote terminals for initiating and transmitting data including buyer bids and seller offers; and a central trade exchange system including a trading means for receiving buyer bids and seller offers from said remote terminals, processing the buyer bids and the seller offers, identifying a set of trades in audience items between buyers and sellers which optimize gains obtained by buyers and sellers from the set of trades in audience items based on the bids and offers received by said trading means, and calculating a price for each audience item in the set of trades, wherein the audience items comprise a plurality of categories, and wherein the sellers can submit a unique offer for each category in the plurality of categories.

In one embodiment, the plurality of categories consist essentially of: (1) preemptable, insured; (2) preemptable, uninsured; (3) non-preemptable, insured; and (4) non-preemptable, uninsured basis.

In another embodiment, the system is adapted so that each of the buyers can specify its own reach and frequency requirements. Further, the system can be adapted so that a seller can identify a specific prospective buyer as an undesirable buyer and adjust an asking price of the seller upward in order to reduce the likelihood of a trade with the undesireable buyer and/or system can be adapted so that the undesireable buyer can bid again with a higher bid.

In yet a further embodiment, the audience items include available advertising time on specified broadcast shows, other programming, viewing content and/or listening content, and wherein the system is adapted so that a buyer can bid on available advertising time on specified broadcast shows, other programming, viewing content and/or listening content, wherein the specified broadcast show, other programming, viewing content and/or listening content that the buyer bids on is selected from a list, and the list is generated from a search procedure over content that satisfies self-identified buy program parameters of the buyer. The system may also be adapted such that one buyer can specify a placement relationship for an audience item with respect to a placement of an audience item by another buyer.

The invention also includes an automated method of allocating audience items among prospective buyers and sellers based on buyer bids from the buyers and seller offers from the sellers, comprising the steps of: receiving, in a computer, buyer bids to buy audience items and seller offers to sell audience items, wherein the buyer bids specify reach and/or frequency requirements; processing the buyer bids and the seller offers; identifying, given constraints imposed by individual reach and/or frequency of requirements of buyers, all different possible sets of trades between buyers and sellers in audience items and identifying a set of trades in audience items which optimize gains obtained by buyers and sellers based on the bids and the offers received by the computer; calculating a price for each audience item in a set of trades that optimize gains obtained by buyers and sellers; identifying rejected buyer bids and rejected seller offers; transmitting electronic notifications of accepted buyer bids and seller offers forming the set of trades, said rejected buyer bids and said rejected seller offers, to respective remote buyer terminals and remote seller terminals.

In one embodiment of that method, the audience items comprise more than one type of audience item, and wherein the seller offers can differ for each type of audience item. The audience items can also be in the form of access to television viewers, where the demographic type refers to a distinct viewer demographic.

In another embodiment, the buyer bids further specify spots per episode requirements of the individual buyers and the different possible sets of trades identified take into account the spots per episode requirements of the individual buyers. Buyers may create a buy program that includes parameters, wherein reach, frequency and spots per episode are the parameters, and wherein the buyers can set a minimum and a maximum of the reach, frequency, and spots per episode parameters for the buy program.

In another embodiment of the method, the audience items are in the form of access to television viewers, radio listeners, and internet users, there is more than one type of a distinct viewer demographic, listener demographic, or internet user demographic and wherein viewing, listening and/or internet use data are provided for measuring the number of viewers, listeners and/or users, by viewer, listener and/or user demographic, for the viewing, listening or internet using content, and the method further comprises adjusting the viewing, listening and/or internet use data by applying statistical analyses to the viewing, listening and/or internet use data for determining an extent to which viewers view a program episode after episode, listeners listen or migrate across a radio broadcast program and/or the internet users use and visit a specific website.

In a further embodiment, a prospective trade is found between a particular seller and a particular buyer, and the method further comprises showing the particular seller the identity of the particular buyer. It may also be the case that the particular seller rejects the particular buyer's bid, wherein there are multiple rounds of buyer bids and seller offers, and wherein the particular buyer can submit a higher bid in a subsequent round.

In yet a further embodiment, each of a first buyer and a second buyer submit bids, further comprising specifying a logical condition for the first buyer's bid of a form “bid X for an N-Second spot that immediately follows/precedes a spot acquired by the second buyer” so that the second buyer's bid is accepted only if the first buyer's bid is accepted. Each of a first buyer and a second buyer may submit bids, and the method then further comprises specifying a logical XOR condition for the first buyer's bid so that its bid is only accepted if the second buyer's bid is not.

In a further embodiment, the audience items are opportunities to advertise to viewers of viewing content, listeners of listening content and/or internet users of an internet website, wherein each of the first and second buyers' bids are accepted, and the method further comprises specifying that the second buyer's opportunity to advertise occurs after the first buyer's opportunity to advertise.

The invention also includes a method for sellers to sell advertising spots and for buyers to buy the advertising spots, comprising the steps of: providing a computer system adapted to receive asking prices from sellers and bid prices from buyers, wherein the computer system is adapted to compare the bid price for a spot with the asking price for the spot; adapting the computer system so that sellers can designate different asking prices for each viewer demographic category; adapting the computer system so that buyers can designate reach, frequency, and/or spots per episode; showing a first seller a prospective trade with a first buyer; and allowing the first seller to reject the prospective trade with the first buyer.

In one embodiment, a third buyer can specify a time or spacing relationship between an advertising spot that the third buyer bids on and a different advertising spot that a fourth buyer bids on. The advertising spots may be in a media selected from the group consisting of television, radio, movies, magazines, newspapers, billboards, computer files, internet and telephone.

In yet a further embodiment, the method also comprises the steps of receiving and processing seller asking prices and buyer bid prices during a first set of bidding rounds; receiving and processing modified seller asking prices and modified buyer bid prices during a second set of bidding rounds including accepting and processing modified seller asking prices during the second set of bidding rounds which are less than the seller asking prices during the first set of bidding rounds, rejecting modified seller asking prices during the second set of bidding rounds which are greater than the seller asking prices during the first set of bidding rounds; accepting and processing modified buyer bid prices during the second set bidding rounds which are greater than the buyer bid prices during the first set of bidding rounds; and rejecting modified buyer bid prices during said second set of bidding rounds which are less than the buyer bid prices during the first set of bidding rounds.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown. In the drawings:

FIG. 1 presents the total number of viewers attracted to the programs (i.e., Rivera Live, College Basketball, and The Tom Green Show) offered by a set of cable television networks (i.e., CNBC, ESPN, MTV) during the Weekdays 7:30-8:00 PM, segmented by age of viewer;

FIG. 2 illustrates an Offer Array that includes a set of hypothetical offers, arranged in ascending order, submitted by MTV for the sale of the 24,000 viewers attracted to its “The Tom Green Show” program;

FIG. 3 illustrates an Offer Array that includes a set of hypothetical offers, arranged in ascending order, submitted by MTV for the sale of the 12,000 18-49 year old viewers attracted to its “The Tom Green Show” program;

FIG. 4 illustrates a Bid Array which includes a set of hypothetical bids arranged in descending order, submitted by Intel, Ford, Xerox, Ford, and P&G, for the acquisition of the 12,000 18-49 year old viewers attracted to The Tom Green Show;

FIG. 5a depicts the intersection of the “The Tom Green Show” offer and bid arrays and the price at which the demand for blocks of 240 seconds of access to the 12,000 18-49 year old viewers equals the supply of such blocks;

FIG. 5b depicts the intersection of the “The Tom Green Show” offer and bid arrays and the price at which the demand for blocks of 240 seconds of access to the 12,000 12-17 year old and the 12,000 18-49 year old viewers equals the supply of such blocks;

FIG. 5c depicts the intersection of the “College Basketball” offer and bid arrays and the price at which the demand for blocks of 240 seconds of access to the 3,000 12-17 year old and the 6,000 18-49 year old viewers equals the supply of such blocks;

FIG. 6 presents a diagrammatic representation of the automated exchange and its component elements;

FIG. 7 is a flowchart showing the required steps for operating the iterative version of the automated exchange;

FIG. 8 is a flowchart showing the required steps for operating the non-iterative version of the automated exchange;

FIG. 9 depicts the variety of ways in which “The Tom Green Show viewers” can be offered for sale under the invention;

FIG. 10 depicts the information sellers must submit to the automated exchange;

FIG. 11 depicts the “types” of buy orders buyers can submit to the automated exchange;

FIG. 12 depicts the information buyers must submit to the automated exchange when bidding on a program basis;

FIG. 13 depicts the bid information buyers must submit to the automated exchange when bidding on a demographics basis;

FIG. 14 depicts the information sellers receive on an inter-round basis regarding the status of their submitted offers;

FIG. 15 depicts the information buyers that bid by “day-part” receive on an inter-round basis regarding the status of their submitted bids;

FIG. 16 depicts the information buyers that bid “by program” receive on an inter-round basis regarding the status of their submitted bids;

FIG. 17 depicts a set of offers and bids that, because of buyer flexibility in the number of viewers they desire, a set of competitive equilibrium prices exist;

FIG. 18 depicts a set of offers and bids that, because of buyer inflexibility in the number of viewers they desire, a set of competitive equilibrium prices does not exist;

FIGS. 19-46 illustrate various screens for permitting buyers and sellers to interface with the present system by, for example, allowing for the entry and submission of bid and offer information while also displaying important inter-round and other information;

FIG. 47 depicts a situation in which the ABC local affiliate is simply requested to provide two different ask prices—one ask price reflects the minimum payment the seller requests for selling the 10,000 Males and 10,000 Females that are estimated to be attracted to a single episode of its “Wheel of Fortune” program on an insured basis, while the other one reflects the minimum payment the seller requests for selling its estimated attracted viewers (i.e., 10,000 Males and 10,000 Females) on an uninsured basis;

FIG. 48 illustrates a set of hypothetical bids submitted by P&G and Avon for buying access to the estimated 10,000 Females attracted to one episode of the “Wheel of Fortune” on both an insured and on an uninsured basis;

FIG. 49 combines the set of hypothetical asks submitted by the ABC local affiliate for the sale of, on both an insured and uninsured basis, 10,000 Female and 10,000 Male viewers expected to be attracted to a single episode of its “Wheel of Fortune” program and the set of hypothetical bids submitted by P&G and Avon, given that P&G and Avon only wish to acquire access to Female viewers;

FIG. 50 illustrates a hypothetical set of bids submitted by Intel and IBM for buying access to the estimated 10,000 Male viewers attracted to one episode of the “Wheel of Fortune” on both an insured and on an uninsured basis;

FIG. 51 combines the set of hypothetical asks submitted by the ABC local affiliate for the sale of, on both an insured and uninsured basis, 10,000 Female and 10,000 Male viewers expected to be attracted to a single episode of its “Wheel of Fortune” program and the set of hypothetical bids submitted by Intel and IBM, given that Intel and IBM only wish to acquire access to Male viewers;

FIG. 52 presents the economic surpluses generated from hypothetical trades between the ABC local affiliate and between P&G, Avon, Intel, and IBM on either an insured or uninsured basis for the 10,000 Female and 10,000 Male viewers attracted to “Wheel of Fortune,” and the economically efficient trades where the ABC local affiliate is unable to express and submit to the exchange unique offer prices for the Female and Male viewers attracted to that program for the two bases (i.e., insured and uninsured) upon which the viewers can be sold;

FIG. 53 illustrates an Offer Array which includes a set of hypothetical offers submitted by the ABC local affiliate for the sale of, on both an insured and uninsured basis, 10,000 Female viewers that the ABC local affiliate expects to be attracted to a single episode of its “Wheel of Fortune” program and where the seller is free to express and submit to the exchange a unique offer price for the Female viewers attracted to that program;

FIG. 54 illustrates a Bid Array which includes a set of hypothetical bids, arranged in descending order, submitted by P&G and Avon for the acquisition of, on both an insured and uninsured basis, the 10,000 Female viewers that the ABC local affiliate expects to be attracted to a single episode of “Wheel of Fortune” program;

FIG. 55 depicts the intersection of the Wheel of Fortune offer and bid arrays for the 10,000 Female viewers that the ABC local affiliate expects to be attracted to a single episode of its “Wheel of Fortune” program and where the ABC local affiliate is free to submit an unique offer price for the Female and Male viewers attracted to that program;

FIG. 56 illustrates an Offer Array which includes a set of hypothetical offers submitted by the ABC local affiliate for the sale of, on both an insured and uninsured basis, 10,000 Male viewers that the ABC local affiliate expects to be attracted to a single episode of its “Wheel of Fortune” program and where the seller is free to express and submit to the exchange an unique offer price for the Male viewers attracted to that program;

FIG. 57 illustrates a Bid Array which includes a set of hypothetical bids, arranged in descending order, submitted by Intel and IBM for the acquisition of, on both an insured and uninsured basis, the 10,000 Male viewers that the ABC local affiliate expects to be attracted to a single episode of the “Wheel of Fortune” program;

FIG. 58 depicts the intersection of the Wheel of Fortune offer and bid arrays for the 10,000 Male viewers that the ABC local affiliate expects to be attracted to a single episode of its “Wheel of Fortune” program and where the ABC local affiliate is free to express and submit to the exchange an unique offer price for the Male viewers attracted to that program;

FIG. 59 presents the economic surpluses generated from hypothetical trades between the ABC local affiliate and between P&G, Avon, Intel, IBM on either an insured or uninsured basis for the 10,000 Female and 10,000 Male viewers attracted to “Wheel of Fortune,” and the economically efficient trades when the ABC local affiliate is free to express and submit to the exchange unique offer prices for the Female and Male viewers attracted to that program for the two bases (i.e., insured and uninsured) upon which the viewers can be sold;

FIGS. 60-62 illustrate various screens disclosing how sellers interface with the present system to enter and submit detailed offer information across different demographics and the four different bases upon which those demographics can be traded while also displaying important inter-round and other information;

FIG. 63 is an example of a screen interface by which a buyer can submit a bid;

FIG. 64 is a further example of a screen interface by which a buyer can submit a bid;

FIG. 65 is an example of a screen interface by which a buyer can revise its bid;

FIG. 66 is an example of a screen interface by which a seller can submit an offer;

FIG. 67 is a further example of a screen interface by which a seller can submit an offer;

FIG. 68 is an example of a screen interface of a seller's order book;

FIG. 69 is an example of a screen interface by which a buyer can submit an order book consisting of demographic bids;

FIG. 70 is an example of a screen interface by which a buyer can submit an order book consisting of program bids;

FIG. 71 is an example of a screen interface providing market and other information to sellers;

FIG. 72 is an example of a screen interface providing a seller with individual trade information; and

FIG. 73 is an example of a screen interface providing a buyer with individual trade information.

### DETAILED DESCRIPTION OF THE INVENTION

The invention applies to a system and method that enables the development and operation of an automated exchange for the trading of audience items that are currently traded primarily through a burdensome and inefficient series of sequential bilateral negotiations between buyers and sellers, or their representatives. The current trading method is particularly inappropriate given the complex preferences participants exhibit for the traded items. The automated exchange of the present invention, by means of a “smart” electronic double auction (“SEDA”), makes it possible to create entirely new methods by which participants can express their complex preferences for multiple, heterogeneous, multi-dimensional audience items, and have such preferences properly evaluated to create an assignment of items from sellers to buyers that will optimize the gains from trade. By reducing transaction costs, assigning price and audience access risks to those entities most willing to assume such risks, increasing the amount and quality of the market information regarding the willingness of participants to trade items in existing and new configurations, and by processing the complex set of preferences submitted electronically, the automated exchange represents an entirely new method by which participants can trade audience items with substantial efficiency advantages over the current method by which audience items are traded.

The automated exchange of the invention employs a SEDA, which uses specially tailored mathematical algorithms to process complex bids and offers submitted electronically to the exchange by buyers and sellers. An audience item is any form of advertising time and/or space in any media environment. Examples of audience items include advertising time or commercial spots on cable television, broadcast television, direct broadcast satellite television, and radio programs; and rights to written copy space in magazines and newspapers and display space on billboards. Since advertising ultimately provides access to recipients of the advertisement, audience items are also referred to herein as access to recipients, i.e., viewers, listeners, readers, etc., and other terms describing exposure events of a recipient (s), such as impressions, eyeballs, etc. An audience item may also include advertising time and/or space provided electronically by an interconnected network of computers (e.g., the Internet) and access to the recipients, such as viewers and listeners, associated therewith. The automated exchange of this invention uses a SEDA to determine an efficient assignment of heterogeneous audience items from competing sellers to competing buyers, and a set of transaction prices for the assigned items based upon the single and multiple-item bids and offers submitted. The assignment of items is considered efficient when no other feasible assignment can produce higher gains for all buyers and sellers given their submitted bids, offers and constraints.

One particular application of this invention is an automated exchange for the trading of television advertising time that provide advertisers access to viewers attracted to various programs. Under such an application, sellers or their agents submit to the automated exchange “sell orders” that reflect their complex preferences. Each sell order is a single or multiple-item offer that identifies a block of advertising time, to be assigned to buyers in the form of one or more advertising spots, on various programs in various geographic areas that the seller has the right to provide. Buyers (advertisers or their agents) submit to the automated exchange “buy orders” that reflect their complex preferences. Each buy order is a single or multiple-item bid that identifies the “type” of viewers (e.g., Males, Ages 18-49) that the buyer wishes to access, the geographic areas in which they wish to access those viewers and certain bank account information that permits an authorized third-party to transfer funds from the buyer's bank account in the event that he is assigned any advertising spots. The SEDA of the automated exchange can either be an “iterative” or a non-iterative, sealed-bid auction. In contrast to a non-iterative, sealed-bid version where buyers and sellers have no opportunity to modify a submitted buy or seller order before trades are completed, in the iterative version of the auction, buyers and sellers have one or more opportunities to modify a previously submitted buy or sell order before trades are conducted. In Round #1, sellers “move” first by creating and submitting sell orders that identify the time interval for which the order holds, and the day, day-part, program, and geographic location of each block of advertising time they wish to offer for sale. Sellers also provide an estimate of the expected number of the various types of viewers that will be accessed during each block of advertising time. In addition, sellers identify the number of blocks of advertising time they wish to sell, as well as the length, measured in terms of continuous seconds, of such blocks. Finally, sellers also identify an “offer price,” defined as the minimum amount of money each requires in order to sell a block of continuous seconds of advertising time. Within a given sell order, the sellers have the opportunity to identify a set of offer prices that may differ according to the flexible characteristics (e.g., Insured, Preemptable) with which access to the viewers can be provided.

In Round #2, buyers “move” second by creating and submitting buy orders that identify the time interval for which their orders hold, the “type” of viewers they wish to access defined in terms of demographics (e.g., sex, age), the geographic, day and day-part location of such access, and the set of programs from which access to viewers can be provided. In addition, buyers indicate the length of the advertising spots (in continuous seconds) they wish to be assigned. Before buyers submit their buy orders in Round #2, the automated exchange evaluates the internal consistency of each buy order and whether there are one or more sell orders that can fill a buy order. This reduces the probability that a buy order may be rejected because no seller has offered access to the desired viewers. Finally, buyers identify a “bid price,” defined as the maximum amount of money each is willing to pay, expressed on a cost per thousand (CPM) viewers basis, for access to their desired viewers. Within a given buy order, the buyers have the opportunity to establish one or more bid prices, each of which corresponds to a unique set of flexible characteristics (e.g., Insured, Preemptable). Each bid price represents the maximum amount of money the buyer is willing to pay for advertising time based upon the specified set of flexible characteristics. To encourage buyers to truthfully reveal their willingness to trade, bid price information is never revealed to sellers.

Following Rounds #1 and #2, based upon the submitted sell and buy orders of the first two rounds, a specially tailored mathematical algorithm identifies the set of trades that optimizes the gains from trade, and a second specially tailored algorithm generates a set of prices that, as nearly as possible, discriminates perfectly between accepted and rejected bids and offers. The phrase “optimizes the gains from trade” refers to a process that, constrained by certain technical factors such as algorithm processing time and the quality of the hardware and software employed in executing the numerical computations required by the algorithms, attempts to discover the optimum benefits that can be shared between buyers and sellers as revealed in the bids and offers they have submitted. As discussed below, in a preferred embodiment for the trading of audience items related to cable television advertising, the optimization process attempts to maximize the revealed gains from trade shared by buyers and sellers. Based upon such numerical computations, sellers receive information regarding the number of blocks of continuous seconds they have tentatively sold, the flexible characteristics (e.g., Uninsured, Preemptable) under which such blocks have tentatively sold, the tentative price of each block, as well as the tentative price of a block when tentatively sold under a different set of flexible characteristics. Similarly, buyers receive information regarding whether they have tentatively acquired access to viewers and, if so, the flexible characteristics under which such access is tentatively acquired, the tentative price of such access, expressed on a cost per thousand viewers basis, and the tentative prices for access to such viewers under different sets of flexible characteristics.

Participants are then permitted to modify their buy and sell orders in one or more subsequent rounds. In Rounds #3 and #5 buyers are inactive and sellers can only lower their offer prices, while in Rounds #4 and #6 sellers are inactive and buyers can only raise their bid prices. No other modifications of the buy and sell orders are permitted. All buy and sell orders that have not been modified are automatically entered “as is” into the next round.

Modified buy and sell orders that are entered into the next round replace the previously submitted buy and sell orders. The calculated total gains from trade can only increase in each subsequent round as modified buy and sell orders provide increasingly beneficial terms for trade. The SEDA of the automated exchange ends after Round #4 if there are no tentative trades immediately following Round #2; otherwise, it ends after Round #6. After each round of modifications a new tentative assignment is computed. When the SEDA ends, the tentative assignment becomes final and all trades are executed accordingly by the automated exchange.

In a specific preferred embodiment discussed below, the automated exchange of the present invention is employed to facilitate the trading of audience items in the form of access to television viewers that are attracted to the television programs shown by cable television networks and carried by cable operators and offered for sale by such networks and operators.

However, the automated exchange of the present invention may be applied to the trading of audience items in any media environment that attracts viewers, listeners, or readers. To this end, the automated exchange of the present invention may be used by participants to trade other types of audiences items, including access to broadcast television viewers, and/or direct broadcast satellite viewers, and/or radio listeners and/or movie theater viewers, and/or magazine and newspaper readers, and/or billboard viewers; and/or viewers of electronically displayed files over a computer network (e.g., Internet); by the airing, printing, or displaying of messages, as provided by or assigned to advertisers, program syndicators, program producers, broadcast television stations, radio stations, television networks, radio networks, basic cable networks, pay cable channels, cable operators, direct broadcast satellite providers, movie theatre owners, magazine and newspaper publishers, billboard owners or the appointed agents (e.g., advertising agencies, intermediaries) of any one of these users. For simplicity when referring to audience items hereafter, audience items will be referred to as blocks of advertising time (or their subdivision into advertising or commercial spots), or access to viewers.

An “exchange” is simply a set of rules that define: (1) the range of permissible behavior on the part of participants; (2) the amount and type of information made available to such participants; (3) a process that uses prices to allocate one or more items among competing users; (4) a procedure for identifying the prices at which the items trade; and (5) a process for executing trades. A “double auction” is a process in which buyers submit to an exchange “bids” to buy one or more items and sellers submit “offers” to sell one or more items. A “transaction” price—a price that equates or attempts to equate the demand and supply for the good—is determined through a series of “rounds” in which buyers compete for the opportunity to acquire a given quantity of items, while sellers compete to sell a given quantity of items to buyers. In a “simple” double auction a trade for a given quantity of items is executed whenever a buyer's bid is equal to a seller's offer. Because individual trades occur whenever a bid price is equal to an offer price, such auctions generate non-uniform prices for the traded items. Employing trading pits, in which bids and offers are announced orally, numerous securities and other markets are organized as simple, double auctions. For more information on automated exchanges, see U.S. Pat. No. 6,405,180, issued to Tilfors et al., and U.S. Pat. No. 6,778,968, issued to Gulati, each of which is incorporated by reference for all purposes.

The automated exchange of the present invention determines, using one or more mathematical algorithms, the assignment of audience items from buyers to sellers and a set of transaction prices for the assignments of such audience items. Under the system and method of the present invention, transaction prices are calculated in a manner that attempts to establish a uniform price to all buyers that acquire audience items in the same supply unit same block of continuous seconds of advertising time) offered for sale. Under the system and method of the present invention participants are able to express their “complex preferences” regarding audience items. In general, a “complex preference” is one in which the participant (i.e., buyer or seller) places one or more constraints on the manner in which its market order can be filled. Under the system and method of the present invention, buyers are able to express their complex and other preferences by submitting multi-item and single-item bids to buy (i.e., buy orders), while sellers are able to express their complex and other preferences by submitting multi-item and single-item offers to sell (i.e., sell orders). Multi-item orders come in two varieties in the current context. A “package bid” consists of a market order to buy/sell a complete set of items or none at all. For example, a buyer is able to create and submit a buy order that indicates that it wishes to acquire access to a minimum number of viewers in a given week or none at all. Similarly, a buyer is able to create and submit a buy order that specifies the minimum number of advertising spots (sometimes referred to herein as “commercial spots”) it wishes to acquire from a given program across the entire length of the buyer's buy campaign. In addition, a seller is able to create and submit a sell order that indicates that it wishes to sell advertising time in Programs A and B as a “package,” or none at all. However, unlike conventional methods by which advertising time is generally traded, the system and method of the present invention permits multiple buyers to acquire the packaged commercial spots. If the commercial spots are assigned to more than one buyer, the sale of the commercial spots is subject to the condition that either the complete set of bundled spots is sold, or none at all. Permitting more than one buyer to acquire the bundled commercial spots increases the likelihood that the commercial spots, and the viewers that are attracted to such spots, are assigned to those buyers that value such spots the most. The automated exchange of the present invention also permits sellers to package advertising time across two or more geographic areas.

The second variety of a multi-item order is a “subset bid.” A “subset bid” consists of a bid to buy “n” number of “m” selected items, where n<m. Under such a bid and under the present invention, a buyer is able to create a bid that indicates that it wishes to acquire one or more commercial spots inserted, for example, into “Hardball With Chris Mathews” at a specific price or one or more commercial spots inserted into “Rivera Live” at a specific price, but not both. Another form of a subset bid is a “day-part” bid, which consists of a bid to buy access to a particular “type” (e.g., Female; 18-49) and number of viewers within a particular day-part within a particular geographic area subject to the restriction that the viewers are drawn from a subset of the programs shown during that time interval within that geographic area. Finally, under the present invention participants are able to express their willingness to trade audience items under a set of different terms and conditions. These terms and conditions represent a set of flexible characteristics the final identification of which help define the nature of the traded audience items. For example, under the system and method of the present invention buyers and sellers are able to express their willingness to trade access to viewers on an “insured” basis and on an “uninsured” basis.

The accommodation of the above and other complex preferences in a market for the assignment of audience items requires the use of advanced mathematics to allocate audience items among buyers and sellers consistent with the set of restrictions imposed by each participant. Allowing participants to express their willingness to trade audience items with flexible characteristics converts an already complex assignment problem into a more complex “characteristic defining” assignment problem.

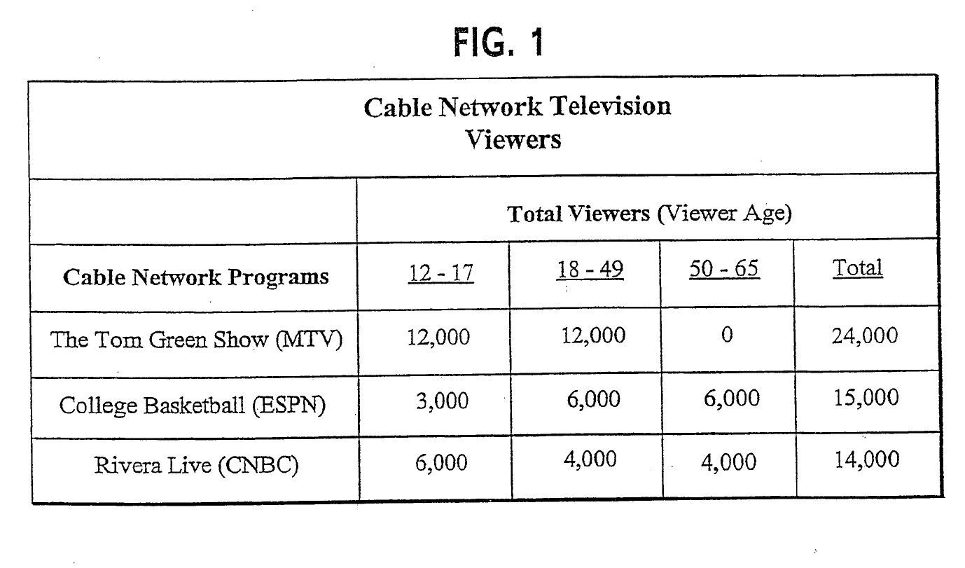

The invention recognizes the complexity of the advertising time buying and selling process. In particular, television advertisers gain access to viewers through the acquisition of commercial spots. Although programs differ in the number of viewers they attract, all attracted viewers fall into a set of discrete categories defined by, for example, the sex and age of the viewer. An advertiser places a higher value on a commercial spot that attracts viewers that are more likely to purchase its product—an advertiser's so-called “target audience”—than a commercial spot that attracts the advertiser's non-target audience. An advertiser's preference for one type of viewer over another means that viewers are “heterogeneous.” Moreover, it means that a commercial spot is multi-dimensional, where the number of dimensions is equal to the number of target audiences desired by advertisers. For example, FIG. 1 presents three sets of viewers, broken out by viewer age, attracted to three different cable network television programs. Each set of viewers corresponds to a different commercial spot dimension. A necessary condition for the efficient assignment of audience items involves providing buyers the ability to express their willingness to gain access to a particular type of viewer (i.e., target audience). Another necessary condition for the efficient assignment of audience items involves providing sellers the ability to express their willingness to sell their audience items. Conventional program exhibition technology allows only one advertiser at a time to gain access to the complete set of heterogeneous viewers, including those viewers that represent its target audience and those viewers that do not represent its target audience. A simple example can be used to illustrate some of the basic features of an automated exchange involving the trading of access to viewers. Suppose that a local cable system carries three cable networks (i.e., CNBC, ESPN, and MTV) and, furthermore, that the television programs shown by these cable networks during weekdays between 7:30-8:00 PM are expected to attract the viewers, broken out by age of viewer (or target audience category), shown in FIG. 1.

For purposes of simplicity, assume for the moment that a commercial spot is single-dimensioned in that all advertisers have the same target audience (i.e., 18-49 year old viewers). Finally, suppose that each cable network has the authority to insert 720 seconds of commercial time into the exhibited program.

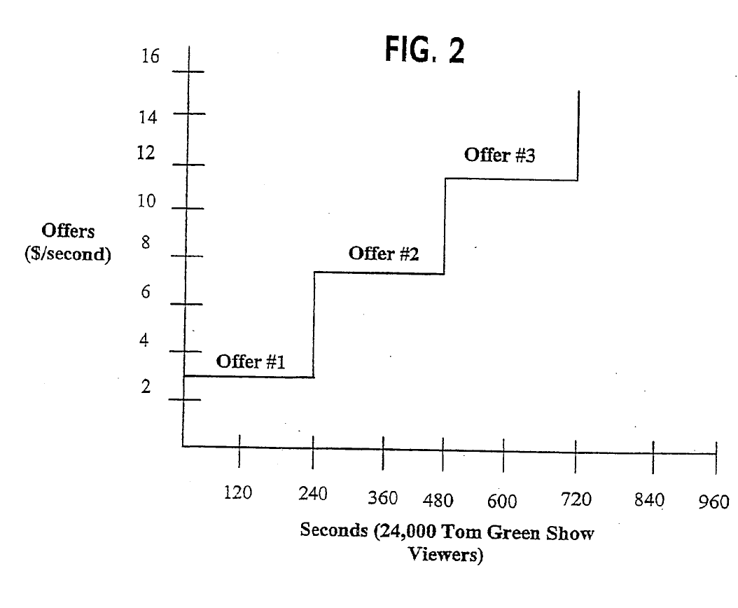

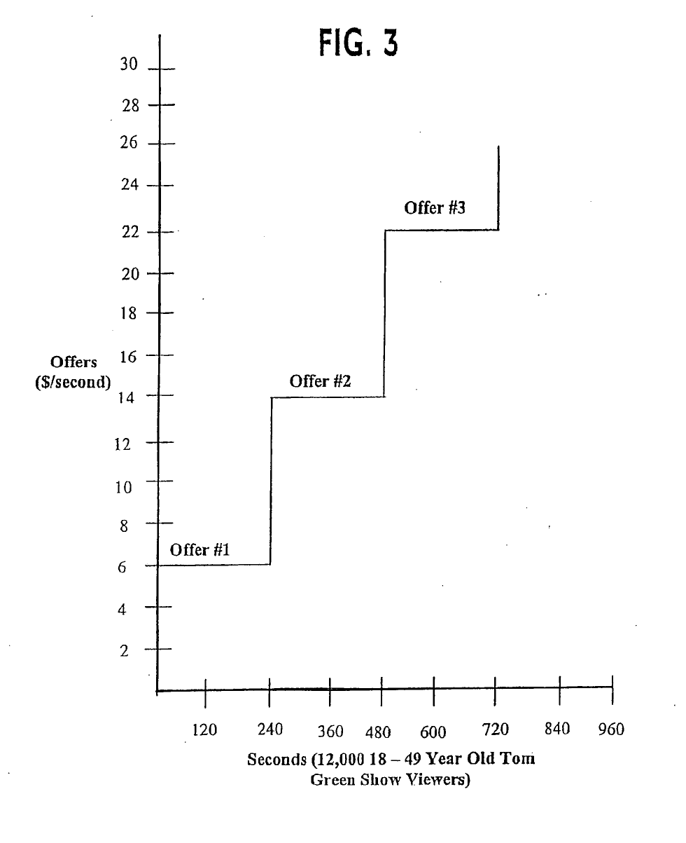

Under the automated exchange of the present invention, cable networks or their agents submit “offers” to sell into the exchange. For purposes of the example, consider MTV. Based upon the cost it incurs from exhibiting “The Tom Green Show” as well as its estimate of the willingness of advertisers to pay for access to its viewers, MTV may submit the offers to sell shown in FIG. 2. The length of each horizontal section or “step” corresponds to the number of continuous seconds, expressed in terms of a block length, the cable network MTV is willing to sell. The number of steps corresponds to the number of discrete blocks of continuous seconds MTV wishes to sell. The height of the step represents the minimum financial payment MTV requires—on a $/second basis (or some equivalent measure)—in exchange for access to the 24,000 viewers attracted to The Tom Green Show program. FIG. 3 depicts the set of offers submitted by MTV expressed in units of the assumed target audience (i.e., 18-49 year old viewers) to be accessed.

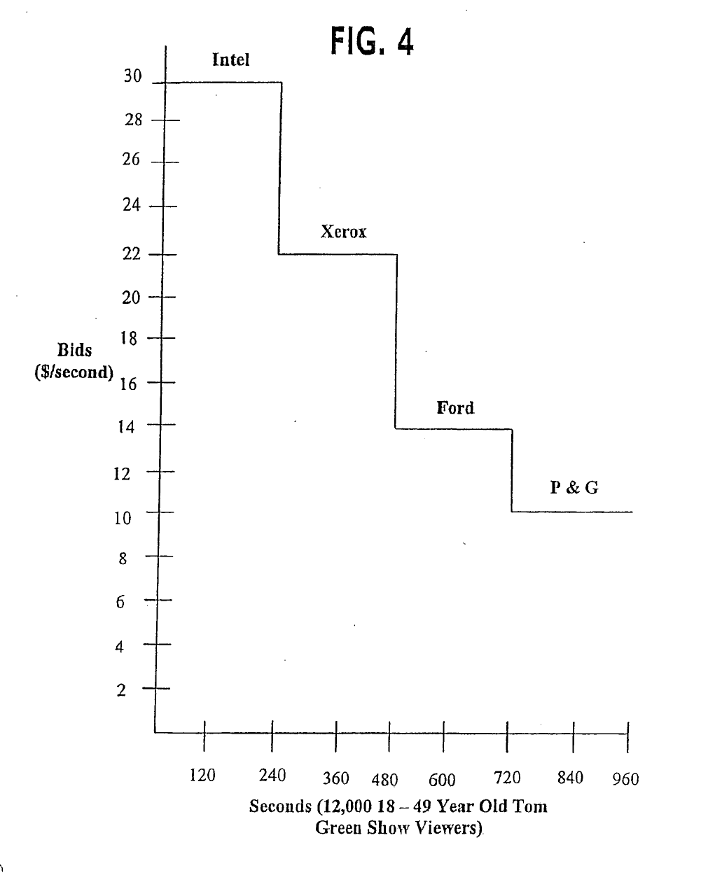

Under the automated exchange of the present invention, advertisers or their agents submit “bids” into the exchange. Each bid is based upon the revenue the advertiser expects to earn from obtaining access to its target viewers, and may also be based on the expected bids of their competitors. Upon receiving the respective bids, an algorithm within a central computer would, based upon this simple example, arrange the bids in descending order to form a “bid array.” FIG. 4 lists a collection of hypothetical bids expressed in $/second (or some equivalent measure) that Intel, Proctor & Gamble, Ford, and Xerox are willing to pay for access to the 12,000 18-49 year old viewers that are attracted to The Tom Green Show. The differences in the bids placed result from the fact that advertisers may place different values on access to the same target audience. The length of each horizontal section or “step” corresponds to the number of commercial seconds the advertiser wishes to acquire. The height of the horizontal section represents the maximum amount the advertiser is willing to pay on a $/second basis (or some equivalent measure) in exchange for access to the 12,000 18-49 year old viewers attracted to The Tom Green Show.

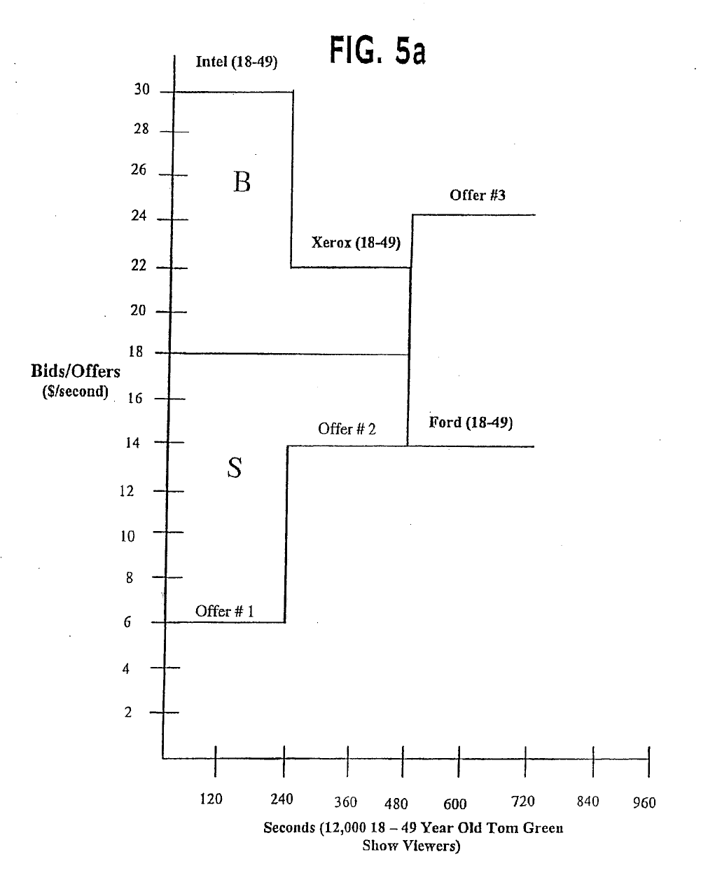

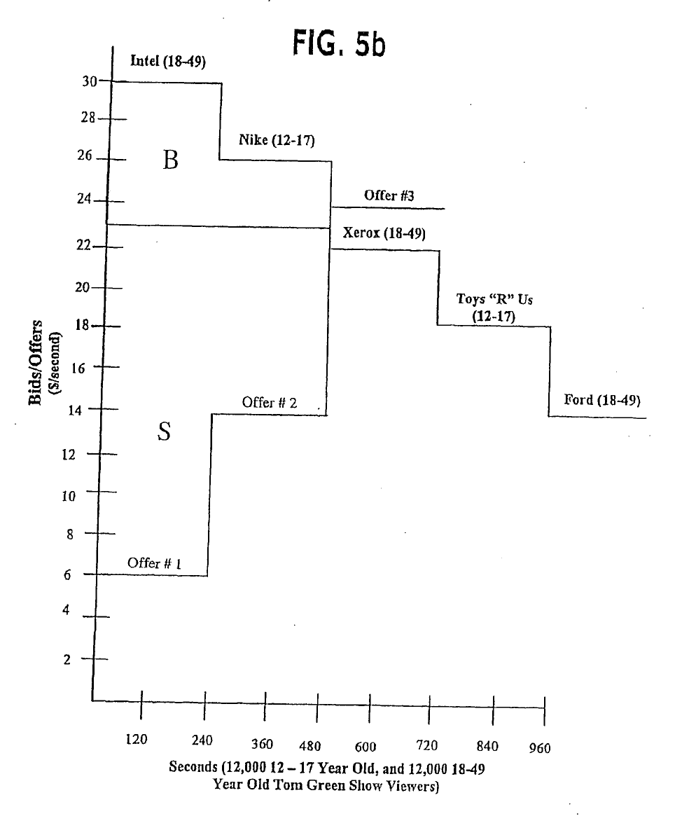

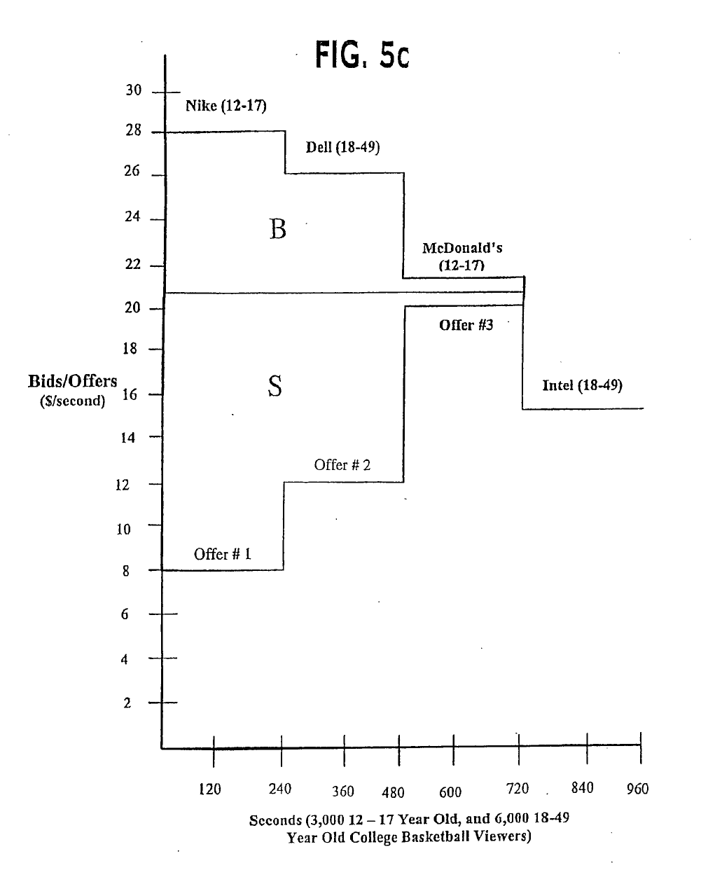

The price at which demand for access to The Tom Green Show viewers equals supply is termed the “transaction price.” This price is determined by the point of intersection between the offer and bid arrays. The point of intersection also determines the number of commercial seconds that are assigned from sellers to buyers at the transaction price. The point of intersection of the two arrays in the hypothetical example is shown in FIG. 5a.

Given the form of the arrays, there is no unique intersection “point” but rather an intersection “interval” ranging from $14/second to $22/second. Consequently, there is no unique transaction price, but rather a set of transaction prices represented by the points located within the interval—$14/second—$22/second. Under such conditions, the system and method of the preferred embodiment of the present invention selects the mid-point of the intersection interval as the transaction price which, in this case, is $18/second. At this price (or for that matter any price within the $14/second—$22/second interval), 480 seconds of commercial time are sold for The Tom Green Show. Given this quantity of seconds sold, the buyers are Intel and Xerox.

Each of these buyers obtains 240 commercial seconds. The number of commercial spots sold depends upon the length of the commercial spot each buyer wishes to “run.” In the above example, the identified transaction price effectively sorts buyers and sellers into two groups—those that successfully trade (i.e., buy or sell access to a targeted audience for an acceptable cash payment) and those that do not. The resulting assignments have an important and very desirable feature; that is, the successful buyers and sellers are those for whom gaining access to a given target audience generates the greatest revealed gains from trade. Using a uniform price, $18/second that all buyers pay and all sellers receive regardless of their bids and offers provides participants the incentive to truthfully reveal the values they place on trading. As shown in FIG. 5a, these gains are measured by the combined size of Area B, which represents the monetary value of the revealed gains obtained by the buyers of the commercial spots, and Area S, which represents the revealed gains obtained by the sellers from selling the commercial spots. Total revealed gains are maximized when buyers that place the highest value on the offered items and sellers that are able to offer them most cheaply successfully trade.

The example has been simplified to draw attention to some of the important elements of the present invention. For example, the illustration assumed that all advertisers have the same target audience and, therefore, it ignores the multi-dimensional aspect of a commercial spot. However, the multi-dimensional nature of a commercial spot, combined with the constraint that only a single advertiser can be assigned a particular spot, are important elements of the assignment problem. The importance of these elements to the assignment process can be described by modifying the example to include an additional target audience.

FIG. 5b depicts a set of hypothetical bid and offer arrays for blocks of 240 seconds of access to the 12,000 12-17 year old and the 12,000 18-49 year old viewers simultaneously attracted to The Tom Green Show. To promote the efficient assignment of commercial spots, the preferred embodiment of the present invention compares the revealed gains from trade involving the different target audiences and selects the assignment that generates the largest economic pie. Based upon the offer and bid arrays contained in FIG. 5b, under the system and method of the present invention, a mathematical algorithm would assign the commercial spots to Intel based upon its bid for access to 18-49 year old viewers, and to Nike based upon its bid for access to 12-17 year old viewers. In this case the gains-maximizing uniform price that both buyers pay and the seller receives, $23/second, would be determined by the fact that 480 seconds can be assigned at prices midway below the lowest rejected offer ($24) and above the highest rejected bid ($22 by Xerox).

Under the system and method of the present invention, the assignment of audience items to advertisers takes into account the complex preferences of buyers. For example, apart from day-part location, some advertisers are not overly sensitive to the programs from which their access to viewers is provided. Under the present invention advertisers can demonstrate this insensitivity by bidding for access to their target audience on a “day-part” basis. By bidding on this basis, the buyer is expressing his willingness to have his buy order filled with viewers attracted by one, or more, out of many programs. In addition to specifying the exact “type” of viewer he wishes to access, under a day-part bid the buyer would also specify the minimum and maximum number of commercial spots he wishes to acquire during his buy campaign, the minimum number of viewers that he wishes to access each week, and the maximum price that he is willing to pay for access to such viewers.

In other instances, advertisers are sensitive to the programs from which their access to viewers is provided. Under the present invention, advertisers can demonstrate this sensitivity by bidding for access to their target audience on a “program” basis. By bidding on this basis, the buyer is expressing his willingness to have his buy order filled with viewers attracted by a particular program. In addition to specifying the exact “type” of viewer the buyer wishes to access, such a bid would also specify the maximum number of commercial spots per program episode that he is willing to acquire, the minimum number of viewers that he wishes to access each week, and the maximum price the buyer is willing to pay for access to such viewers.

Based upon the buy and sell orders submitted, the system and method of the preferred embodiment of the present invention identifies the gains-maximizing assignment of audience items and the prices at which such items trade.

The previous example can be expanded to include the expression of complex preferences by buyers in the presence of multiple sellers. Suppose that both MTV and ESPN place offers to sell access to their viewers. FIG. 5c depicts a set of hypothetical bid and offer arrays for blocks of 240 seconds of access to the 6,000 18-49 year old viewers attracted to ESPN's College Basketball program and the 3,000 12-17 year old viewers simultaneously attracted to that same program, while FIG. 5b continues to show us the bid and offer arrays for MTV's The Tom Green Show.

Of particular interest is Intel's buy order. In contrast to the other buy orders, Intel's buy order can be thought to represent a day-part bid. The day-part nature of Intel's bid is demonstrated by its appearance on the bid arrays demanding access to 18-49 year old viewers of both programs, and a common price (cost per thousand (CPM) viewers per second of access) submitted for both bids. Notice Intel is willing to pay $30 per second for access to the 12,000 viewers attracted to The Tom Green Show, or $15 per second for access to half as many (6,000) of the same type of viewers attracted to College Basketball. These bids are both equivalent to $2.50 per thousand viewers per second. Under the preferred embodiment of the system and method of the present invention, a mathematical algorithm evaluates the gains from trade for every feasible assignment of commercial spots from sellers to buyers and selects the assignment that maximizes the revealed gains from trade. Given all the orders to buy and sell, 240 second time blocks are sold to Intel and Nike on The Tom Green Show for $23/second, and to Dell, Nike and McDonald's on College Basketball for $20.50/second. Notice that Intel's common bid of $2.50 per thousand viewers per second was enough to win one spot on The Tom Green show, but not on College Basketball.

The above example is simplified in that it also ignores several other important features of the conventional commercial spot buying and selling process. For example, in addition to cable networks, cable operators also have the ability to offer commercial spots for sale. Thus, the system and method of the present invention provides both cable networks and cable operators with the opportunity to offer commercial spots for sale. In addition, participants often desire to trade commercial spots in a particular geographic area (e.g., “national” versus “local”) during a particular period of time. Under the system and method of the present invention, both buyers and sellers can select the exact geographic areas, herein defined as Designated Marketing Areas (“DMA's), in which to buy and sell audience items. In addition, under the system and method of the present invention, buyers have the opportunity to specify the campaign period, in weeks, over which their buy order applies. Under the system and method of the present invention, a buyer is able to express the minimum and maximum number of commercial spots it desires to acquire during the campaign period and the maximum number of commercial spots it wishes to acquire within a given program episode within a given cable television system.

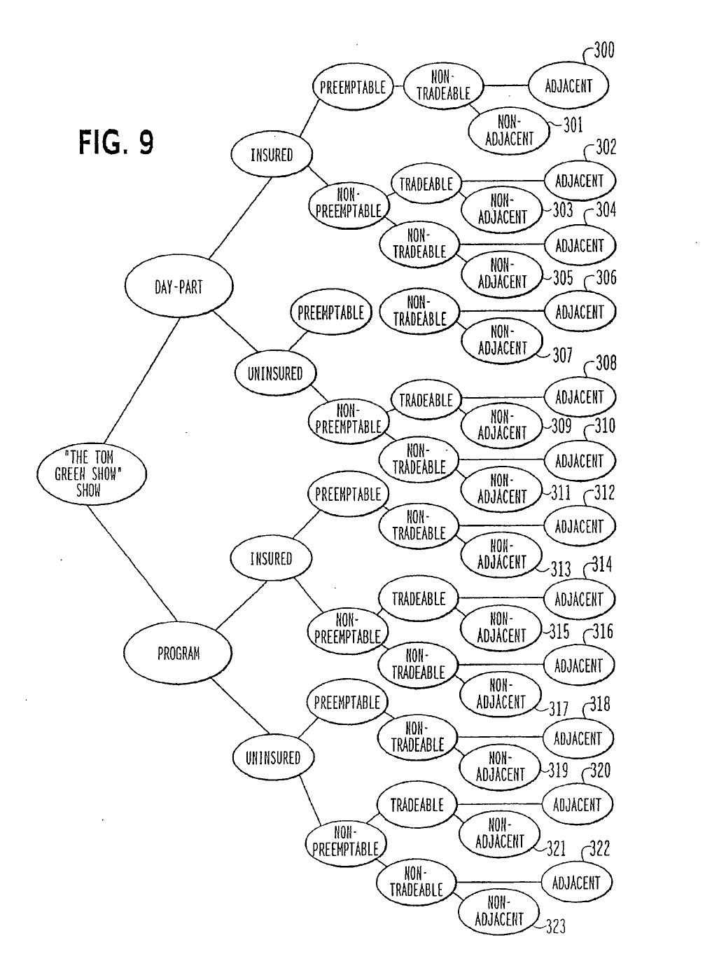

The system and method of the present invention is designed to accommodate other attributes of the audience item market not fully presented by the above simplified examples nor efficiently managed and effectively processed by the conventional method. Under the system and method of the present invention, participants have the opportunity to submit different bids and offers for each different set of flexible characteristics under which they would trade an audience item. For example, the buyers and sellers of cable television commercial spots may wish to specify various prices under which access to a prespecified number of viewers is insured or not insured by the seller. They may also wish to specify various prices under which the seller retains the right to take back and resell a spot (preemptable) or sells a firm right (nonpreemptable) to the buyer to show his advertisement at the specified time. These participants would then have four conditions to price: Preemptable/Insured; Preemptable/Uninsured; Non-Preemptable/Insured; and Non-Preemptable/Uninsured. These and other terms and conditions, illustrated in FIG. 9, identify the “flexible characteristics” of an audience item. Under the system and method of the present invention, one or more mathematical algorithms simultaneously identify the assignment of audience items from buyers to sellers and the flexible characteristics of each assigned item that maximize the gains from trades enjoyed by both buyers and sellers.

Because the characteristics of items are established at the time of assignment, the present system and method, using mathematical algorithms, solves a “characteristic-defining” assignment problem.

The above examples are also simplified in other ways. For instance, the examples assume that the number of seconds of advertising time offered by the seller is equal to the number of seconds demanded by each of the buyers. This assumption will rarely, if ever, hold in practice. Under the preferred embodiment of the present invention, the process of assigning blocks of commercial time from sellers to buyers involves identifying the length of commercial spots desired by buyers such that the revealed gains from trade obtained by both buyers and sellers are maximized. To identify such an assignment, the present invention evaluates every possible way in which a continuous block of seconds offered by a seller can be partitioned into spots of particular lengths that buyers wish to acquire. The new trading institution created by the system and method of the present invention also provides participants the opportunity to trade an audience item under entirely new terms and conditions. For example, the present invention provides a seller the opportunity to assign to a buyer the right to “re-trade” an audience item. Under the system and method of the present invention, buyers have the opportunity to express the premium they are willing to pay, over the price of a non-tradeable audience item, to acquire the item on a tradeable basis. Likewise, sellers have the opportunity to express the premium they must receive, over the price of a non-tradeable audience item, to sell the audience item on a tradeable basis. Furthermore, some buyers may have a strong preference to have their advertisements placed early in a given television program. Commercial spots located early in a program are termed “adjacencies”. Under the system and method of the present invention, advertisers have the opportunity to express the premium they are willing to pay, over the price of a non-adjacency, to acquire a commercial spot on an adjacency basis.

The new trading institution created by the system and method of the present invention recognizes the possibility that the complex preferences of buyers and sellers may reduce “market liquidity.” In this instance, the term “market liquidity” refers to the extent to which buyers and sellers can quickly conduct a trade and do so in a manner that does not adversely affect the price at which the transaction takes place. In the current context, market liquidity would be reduced if a buy order was rejected simply because it cannot be “filled,” independent of price, by one or more existing sell orders. To reduce this possibility, the system and method of the present invention evaluates the internal consistency of each buy order and whether there are one or more sell orders that can fill each buy order. If a buy order cannot be filled, the system and method of the present invention instructs the buyer on how to change the buy order so that it can be filled. Market liquidity concerns are further reduced by the opportunity for participants to express their willingness to acquire audience items under different flexible characteristics. The system and method of the present invention makes it easy for participants to take advantage of this opportunity. The order creation process involves providing a buyer a list of each different set of flexible characteristics.

Advances in technology will soon make it possible for sellers to show, within a given program, different advertisements to different viewers. Under these conditions, the basic audience item to be assigned is no longer the access to a group of individuals who cannot be subdivided, but the access to every individual who is now able to receive a different buyer message. After delivering this technology, the seller would be provided the ability to establish a unique offer price for each target audience category, just as the buyers are able to bid on that basis. The automated exchange of the present invention and the associated algorithms is easily adapted to incorporate such advances in technology.

Because it is less sensitive to problems associated with asymmetric information, the present invention identifies a set of trades among buyers (i.e., ad agencies) and sellers (i.e., cable networks/cable operators) that generates more gains from trade than the gains from trade generated through the existing conventional bilateral bargaining institution. As discussed previously, analyzing the results from a series of laboratory experiments described in a report entitled “eBay Versus an NYSE-like Market: The Effect of Changing the Media Buying and Selling Process on Market Participants,” the present inventor found that the present invention represents a vast improvement over the current process by which traditional (i.e., non-Internet) media are bought and sold as measured by the amount of gains from trade participants are able to capture. Moreover, the present invention creates a centralized exchange in which market participant orders reflect not only their willingness to either buy or sell a given item, but also their willingness to buy or sell substitutable items. By generating additional information on willingness to trade, the centralized, two-sided nature of the exchange makes it more likely, compared with the existing institutions, that access to viewers sold by sellers will be assigned to those buyers and sellers such that the total gains of trade, as revealed by their bids and offers, will be maximized.

Finally, the present invention's use of advanced mathematics, combined with the necessary information elicited from prospective buyers and sellers, allows participants to conduct complex trades that are unthinkable using existing trading methods.

Unlike conventional trading mechanisms, the present invention can, with the use of sophisticated mathematical algorithms, handle the complex preferences exhibited by buyers and sellers. The handling of such preferences will increase the gains from trade associated with obtaining and providing access to television viewers. For example, under the present invention, buyers are able to place orders to access millions of viewers within a given day and day-part and across a large group of selected geographic areas without the restriction that access to those viewers can only be provided by a single cable television network exhibiting a particular program in the particular package of geographic areas in which the cable network is carried—so called “national advertising.” Cable operators will benefit from the increased demand for their local advertising spots. A portion of this benefit will likely accrue to the cable networks in that they could, in theory, extract higher fees from the cable operator for carrying programs.

Compared to existing trading methods, the tentative prices calculated by the specialized mathematical algorithms of the present invention will provide more transparent and better price signals enabling advertisers to more reliably estimate the cost of a given “buy” campaign and cable networks to more reliably determine the best time to sell their commercial spots. In addition, the transaction costs of time and commissions associated with trading access to viewers will be significantly lower under the present invention than under the existing trading methods. The lower transaction costs can be expected to yield important indirect benefits, including providing buyers a greater opportunity to re-trade their assigned spots in response to changes in the value of such spots. Such trades will give rise to a secondary market for access to viewers and, in so doing, lower the price risk to which both cable networks and advertisers are currently subject. The system and method of the present invention solves a characteristic defining assignment problem in that it establishes the identity of the set of flexible characteristics (e.g., Insured/Non-Preemptable) associated with every item assigned. In addition, the new trading institution created by the system and method of the present invention enables market forces to determine, subject to restrictions imposed by the cable networks, the “best” way in which a block of continuous seconds offered for sale should be partitioned. Finally, the new trading institution created by the system and method of the present invention enables market forces to determine, subject to restrictions imposed by the cable networks, the order in which a buyer's commercial appears within a block of continuous seconds.

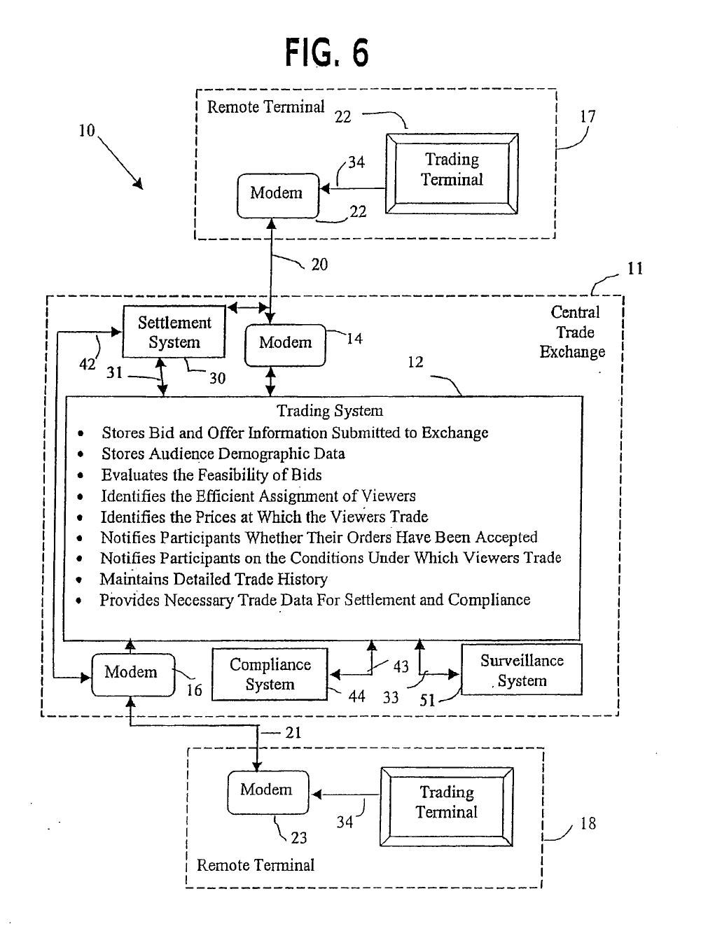

FIG. 6 is a diagrammatic representation of the innovative automated exchange generally designated by the number 10. The automated exchange 10 includes a central trade exchange 11 that includes a trading system 12 combined with data communication means, such as modems 14 and 16 connected to remote terminals 17 and 18 through common communications paths 20 and 21, respectively. Central trade exchange 11 also includes a settlement system 30, a compliance system 44 and a surveillance system 51. Thus, central trade exchange 11 functions as a remote data processing system, including hardware and software, to which terminals 17 and 18 are connected. Trading system 12 preferably includes a host or central computer including, for example, a processor and data storage. Trading system 12 also includes software, including suitable database application software, including algorithms discussed hereinbelow, residing in a computer readable storage medium in the form of encoded executable instructions for operating the automated exchange, including the SEDA, of the present invention. Trading system 12 can be built using a wide variety of operating systems, including Sun Solaris, IBM AIX, Linux, and Microsoft. The mathematical algorithms that are included in trading system 12 that solve the identified optimization problems can be implemented using a wide variety of optimization software, including Sunset XA and CPLEX. Trading system 12 can be located on a wide variety of servers, including Sun Java Server, Apache, and Webserver using HTML, DHTML, Javascript, Ruby, Python, Java, C, C++, Perl, and other software development languages. Trading system 12 can be built using a wide variety of database software, including Oracle, IBM, and MySQL.

Remote terminals 17 and 18 contain data communication means such as modems 22 and 23 that serve to transmit and receive information through communications paths 20 and 21. Communications paths 20 and 21 may include any data communications network capable of effectively transmitting the data, such as a worldwide interconnected network of computers (i.e., the Internet), the Public Switched Telephone Network (PSTN), or any other suitable data communication pathway. Also, the information/data may be transmitted using a variety of data communication paths such as phone lines, wireless transmissions and/or digital data lines. Users of remote terminals 17 and 18 send bids to buy and offers to sell to the central processor of the trading system 12.

Given a suitably designed central processor, any number of remote terminals 17 and 18 may be used, but for simplicity and ease of presentation, only two such terminals 17 and 18 are shown in FIG. 6.

Users of terminals 17 and 18 will be assigned a participant identification number by the central trade exchange 11. The identification number must be entered into the system by the remote terminals 17 and 18 before trading system 12 will accept information from it. If the identification number is correct, the trading system 12 stores subsequent information sent to it by the participant. The trading system 12 also stores audience demographic data, evaluates the feasibility of bids, identifies, based upon a set of algorithms, the efficient assignment of audience items from sellers to buyers and determines the prices at which such items trade. It also notifies participants whether their bids and offers have been accepted, notifies successful participants of the characteristics of the items they trade, maintains detailed trade history, provides necessary trade data for settlement and compliance, and provides real-time surveillance to monitor software and bidding irregularities.

Settlement system 30, which may or may not be located in the same geographic location as trading system 12, receives data from trading system 12 via connection 31, and transfers funds between financial accounts created by the trading participants prior to the start of the market. Assuming it is present at the same geographic location as trading system 12, the settlement system 30 delivers information on line 42 to modems 14 and 16 and, thereafter, via lines 20 and 21, to remote terminals 17 and 18, respectively. In like manner, compliance system 44 receives data from trading system 12 via connection 43 and checks data to determine if it meets predetermined bidding limits or requirements established for each participant. Surveillance system 51 is connected to the central processor of trading system 12 by connection 33 to enable exchange officers to review all information relating to the operation of the exchange. Surveillance system 51 provides real time surveillance to detect software and trading irregularities.

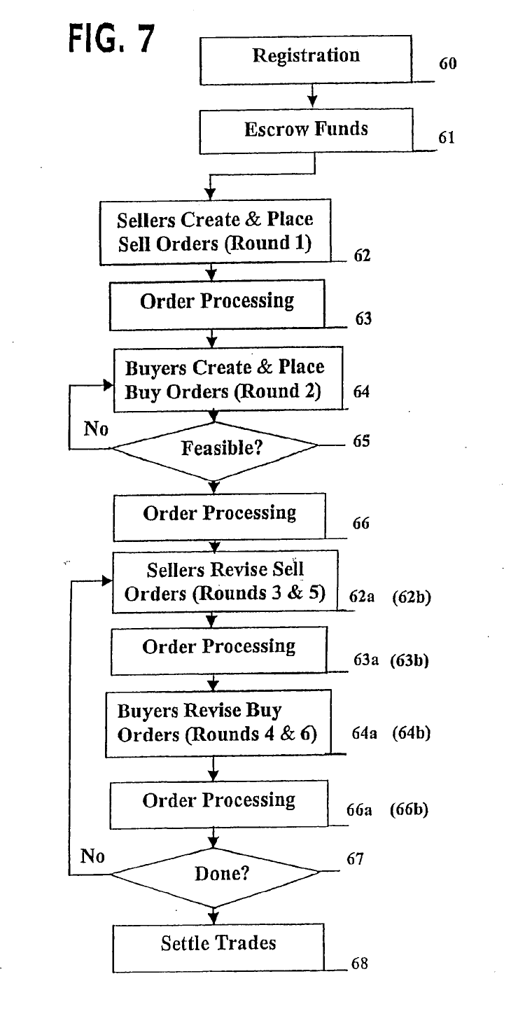

The flowchart represented in FIG. 7 depicts the series of steps in accordance with a specific embodiment of the SEDA of the present invention. It includes a registration process 60, an escrow funds submission process 61, sell order creation and submission process 62, sell order revision processes 62a, and 62b, order processing processes 63, 63a, and 63b, buy order creation and submission process 64, buy order revision processes 64a, and 64b, decision process 65 that determines bid feasibility given the orders to sell submitted into the exchange, order processing processes 66, 66a, and 66b, decision process 67 that determines whether the SEDA market remains open, and a trade settlement process 68. Under registration process 60, each registrant obtains a participant identification number from the registrar, which may or may not be the entity that operates the SEDA. Each seller creates a customized “seller profile” that identifies the geographic and program location of the viewers to which they have the authority to provide access. This customized profile enables each seller to eliminate irrelevant geographic and program locations when making choices in the process of creating a market sell order. Each buyer has the ability to identify, prior to the opening of the SEDA of the automated exchange, the set of geographic areas in which it wishes to acquire access to viewers. This customized “buyer profile” allows buyers to eliminate unnecessary geographic data elements. To reduce the risk that buyers will fail to pay for assigned audience items, in the escrow funds process 61, each registered buyer is required to either deposit money into a pre-specified escrow account or have one of its banks submit a letter of reference verifying the advertiser's ability to spend a specified amount of money. The SEDA opens following the registration and escrow funds processes.

Under the sell order creation and submission process 62 (Round #1), sellers, including but not limited to, program syndicators, cable operators, cable networks, and broadcast television stations or their representatives create and submit offers to sell commercial time.

Under the sell order creation and submission process 62 sellers can express their complex preferences. For example, under the sell order creation and submission process 62 sellers can express their desire to condition the sale of one block of continuous seconds of commercial time available within a particular television program on the sale of another block of continuous seconds of commercial time available within a different television program. The seller enters the desired sell order information into various data fields of one or more electronically displayable file. The order information is transmitted from a remote terminal 17, 18 (FIG. 6) to central trade exchange 11. Under the order processing process 63, algorithms determine, for a given DMA, the maximum number of commercial spots, assuming the minimum spot length, offered for sale, the maximum number of viewers of each given demographic type to which access is offered in each spot for sale, and the maximum number of weeks such spots and corresponding access to viewers are offered for sale. Under the buy order creation and submission process 64 (Round #2), buyers, including but not limited to, advertisers or their representatives, guided by the information generated from the calculations made under order processing process 63, create and submit bids to buy commercial spots. Under the buy order creation and submission process 64, buyers can express the complex preferences under which their buy orders must be filled to accept a trade.

The buyer likewise enters the desired sell order information into various data fields of one or more electronically displayable files and transmit the information to central trade exchange 11 (FIG. 6).

Under decision process 65, the system and method of the present invention, using a set of algorithms, determines whether each buyer's bid to buy is feasible given the offers to sell submitted into the SEDA and the constraints of each buyer's bid. Under this bid feasibility assessment, a set of algorithms determines, for example, the maximum number of viewers a buyer can acquire access to per week and notifies the buyer if he demands access to a minimum level of viewers which exceeds this maximum value. This evaluation also determines, for example, whether the constraints of a bid are internally consistent. For example, the system notifies the buyer if his request regarding the minimum number of spots per program schedule is inconsistent with his own request regarding the maximum number of spots per episode. Under the order processing process 66, algorithms identify the tentative efficient assignment of spots from sellers to buyers, the characteristics (e.g., Insured, Non-Preemptable) that apply to each spot assigned, the prices at which access to each type of viewer tentatively trades, and the amount of money each seller (buyer) would receive (owe) if the SEDA closed at that point. After receiving this information, sellers have the opportunity to lower their offer prices under order submission process 62a (Round #3).

Under the order processing process 63a, computer algorithms identify the tentative efficient assignment of spots from sellers to buyers, the characteristics (e.g., Insured, Non-Preemptable) that apply to each spot assigned, the prices at which access to each type of viewer tentatively trades, and the amount of money each seller (buyer) would receive (owe) if the SEDA closed at that point. After receiving this information, buyers have the opportunity to raise their bids under order submission process 64a (Round #4). Under the order processing process 66a, algorithms identify the tentative efficient assignment of spots from sellers to buyers, the characteristics (e.g., insured, non-preemptable) that apply to each spot assigned, the prices at which access to each type of viewer tentatively trades, and the amount of money each seller (buyer) would receive (owe) if the SEDA closed at that point.

Under decision process 67, in the preferred embodiment, the system applies a closing rule whereby if there are no tentative trades between a buyer and a seller following order processing process 66, the SEDA closes following order processing process 66a, otherwise the SEDA closes after order processing process 66b. The SEDA can be referred to as closed when, under the rules of the SEDA, buyers and sellers no longer have the opportunity to revise and resubmit the price terms of their market orders for consideration by the SEDA.

To encourage realistic initial bids and offers, the preferred embodiment of the present invention utilizes an “activity rule” in the SEDA that states that sellers can lower their offer prices in order submission process 62b (Round #5) only on those market orders that were tentatively accepted following order processing process 66. Similarly, under the present invention, buyers can raise their bid prices in order submission process 64b (Round #6) only on those market orders that were tentatively accepted following order processing process 66.

Thus, this activity rule provides each seller and buyer who owned those tentatively successful “66” orders one final opportunity to lower the price terms of only those tentatively successful “66” sell orders in order submission process 62b (Round #5) and raise the price terms of only those tentatively successful “66” buy orders in order submission process 64b (Round #6), respectively. T here are many other such “activity rules” that may be used instead of, or in addition to, the above rule that are consistent with the objective of promoting the efficient assignment of access to television viewers from sellers to buyers. Through public announcement to potential participants prior to any SEDA, the rules of the SEDA may be modified to change or add an “activity rule”.

Under the order processing process 66b, computer algorithms identify the efficient assignment of spots from sellers to buyers, the characteristics (e.g., insured, non-preemptable) that apply to each spot assigned, the prices at which access to each type of viewer trades, and the amount of money each seller (buyer) would receive (owe). The SEDA then closes following order processing process 66b. Through public announcement to potential participants prior to any SEDA, the rules of the SEDA may be modified to change the number of rounds before closing and the eligibility of various participants to participate in each round.

Under the settlement trade process 68, the SEDA computes the final transaction prices that sellers receive for each particular commercial spot they will provide to a buyer and buyers pay for each particular commercial spot received from a seller. The automated exchange then delivers trade confirmation receipts to the respective traders. Trade settlement process 68 also includes the transference of funds from accounts established by the buyers into accounts established by the sellers.

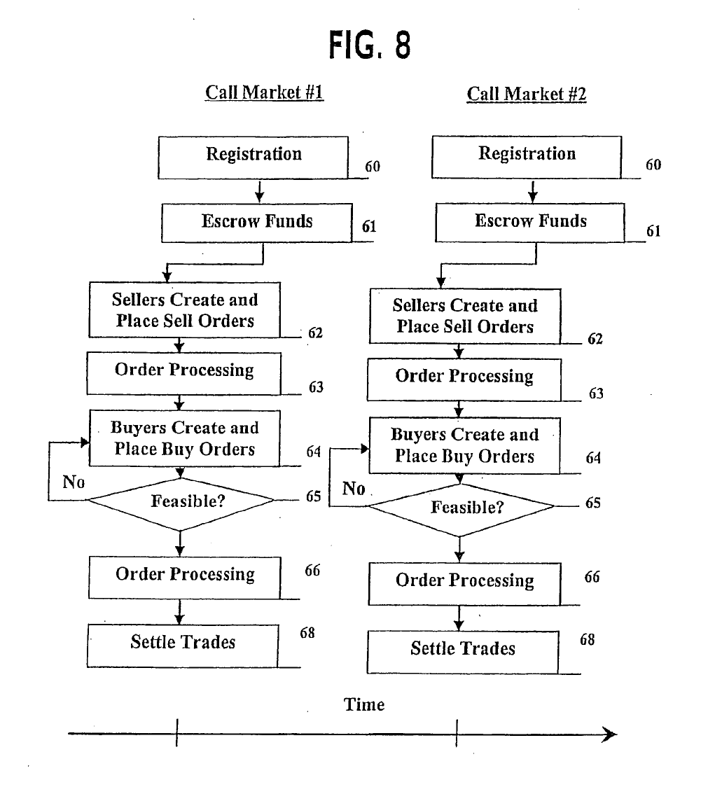

The system and method of the present invention involves the use of an iterative auction wherein both buyers and sellers have multiple opportunities to adjust their buy and sell orders. Under this approach the auction closes only after a given number of opportunities have presented themselves. An iterative auction is ideal for use in situations in which, for instance, the number of buyers and sellers, relative to the number of items up for sale, is low and where buyers and sellers do not demand immediate execution of their orders. However, there may be instances in which buyers and sellers demand immediate order execution. The flowcharts represented in FIG. 8 depict a sequence of steps in another embodiment of the automated exchange, the non-iterative automated exchange that permits participants only a single opportunity to submit buy and sell orders before the auction closes and final trades occur. The non-iterative automated exchange includes a registration process 60, an escrow funds submission process 61, a sell order creation and submission process 62, an order processing process 63, a buy order creation and submission process 64, decision process 65 that determines bid feasibility given the orders to sell submitted into the exchange and the characteristics of the buyer's bid to buy, an order processing process 66, and a trade settlement process 68.

FIG. 9 depicts the numerous flexible characteristics under which access to viewers can be assigned to buyers by the system and method of the present invention. Under the system and method of the present invention, buyers have the opportunity to express their willingness to acquire access to their desired viewers on each of the listed flexible characteristic bases. In addition to the characteristics preemptable/non-preemptable, insured/uninsured, and tradeable/non-tradeable, the system and method of the present invention defines an “adjacency” characteristic that provides buyers/sellers the opportunity to express their willingness to pay/receive a premium to obtain/provide access to viewers in the first block of commercial time offered in a particular program.

Advertisers often are not particularly sensitive to the programs in which their advertisements air. Under the system and method of the present invention, advertisers that bid on this basis are said to be bidding on a “day-part” basis. However, some advertisers are sensitive to the programs in which their advertisements air. Under the system and method of the present invention, advertisers that bid on this basis are said to be bidding on a “program” basis. In what follows, commercial spots are defined as “insured” if the seller guarantees that the buyer will obtain a minimum number of viewers of a particular demographic type; otherwise commercial spots are considered “uninsured.” Commercial spots are defined as “preemptable” if the seller may take back the spot from a buyer prior to airtime; otherwise spots are “non-preemptable.” Finally, commercial spots are defined as “tradeable” if the buyer may resell the spot prior to airtime; otherwise spots are “non-tradeable.” The creation of “tradeable spots” promotes the efficient assignment of commercial spots. Buyers typically purchase spots weeks, and sometimes months, before the actual airtime. During the intervening period, the value buyers place on the assigned spots may decline. This decline may be such that the current owner is not the most highly valued user of the commercial spot.

Consistent with the efficient assignment of spots, the current spot owner should sell the spot to the entity that values it most.

In FIG. 9, node 300 refers to The Tom Green Show spots that are bid for on a day-part, insured, preemptable, non-tradeable, adjacent basis. Node 301 refers to the spots that are bid for on a day-part, insured, preemptable, non-tradeable, non-adjacent basis. Node 302 refers to the spots that are bid for on a day-part, insured, non-preemptable, tradeable, adjacent basis. Node 303 refers to the spots that are bid for on a day-part, insured, non-preemptable, tradeable, non-adjacent basis. Node 304 refers to the spots that are bid for on a day-part, insured, non-preemptable, non-tradeable, adjacent basis. Node 305 refers to the spots that are bid for on a day-part, insured, non-preemptable, non-tradeable, non-adjacent basis. Node 306 refers to the spots that are bid for on a day-part, uninsured, preemptable, non-tradeable, adjacent basis. Node 307 refers to the spots that are bid for on a day-part, uninsured, preemptable, non-tradeable, non-adjacent basis. Node 308 refers to the spots that are bid for on a day-part, uninsured, non-preemptable, tradeable, adjacent basis. Node 309 refers to the spots that are bid for on a day-part, uninsured, non-preemptable, tradeable, non-adjacent basis. Node 310 refers to the spots that are bid for on a day-part, uninsured, non-preemptable, non-tradeable, adjacent basis. Node 311 refers to the spots that are bid for on a day-part, uninsured, non-preemptable, non-tradeable, non-adjacent basis. Node 312 refers to The Tom Green Show spots that are bid for on a program, insured, preemptable, non-tradeable, adjacent basis. Node 313 refers to the spots that are bid for on a program, insured, preemptable, non-tradeable, non-adjacent basis. Node 314 refers to the spots that are bid for on a program, insured, non-preemptable, tradeable, adjacent basis. Node 315 refers to the spots that are bid for on a program, insured, non-preemptable, non-tradeable, adjacent basis.

Node 316 refers to the spots that are bid for on a program, insured, non-preemptable, non-tradeable, adjacent basis. Node 317 refers to the spots that are bid for on a program, insured, non-preemptable, non-tradeable, non-adjacent basis. Node 318 refers to the spots that are bid for on a program, uninsured, preemptable, non-tradeable, adjacent basis. Node 319 refers to the spots that are bid for on a program, uninsured, preemptable, non-tradeable, non-adjacent basis. Node 320 refers to the spots that are bid for on a program, uninsured, non-preemptable, tradeable, adjacent basis. Node 321 refers to the spots that are bid for on a program, uninsured, non-preemptable, tradeable, non-adjacent basis. Node 322 refers to the spots that are bid for on a program, uninsured, non-preemptable, non-tradeable, adjacent basis. Node 323 refers to the spots that are bid for on a program, uninsured, non-preemptable, non-tradeable, non-adjacent basis. Of course, in another embodiment, any combination of flexible characteristics could be provided for selection by the buyer. Thus the system and method of the present invention permits numerous types of trades to be considered from multiple buyers and sellers in an automated fashion while determining the set of trades that optimize gains from trade.

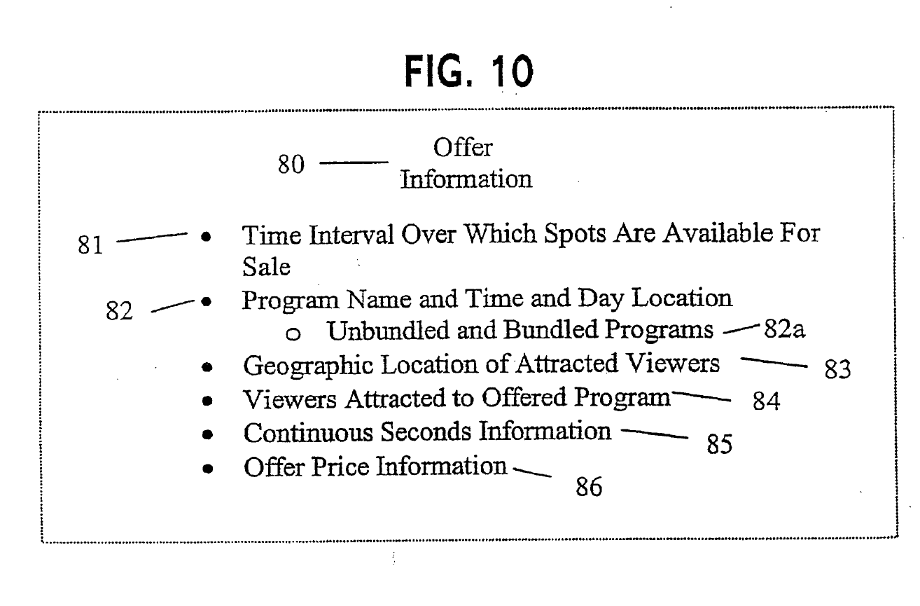

Advertisers or their representatives (“buyers”) and cable operators/cable networks or their representatives (“sellers”) employ software to transmit bid and offer information to the automated exchange 10 (FIG. 6). FIG. 10 depicts the information sellers transmit to the automated exchange 10. This information is referred to generally as offer information 80.

Offer information 80 includes time interval information 81, which identifies the period of time over which blocks of commercial time are offered for sale on each airing of a particular program. Offer information 80 also includes program information 82, which specifies the name of the program and its scheduled airtime and day-part location, and bundling information 82a, which identifies whether this offer is part of a set of programs that are being bundled together for sale. Offer information 80 also includes geographic location information 83, which identifies the specific DMA' of the offered spots, and viewer information 84, which specifies the total number of viewers, broken out by age and sex, expected to be attracted to the offered program. Viewer information 84 can either be downloaded by the seller into the trading system 12 (FIG. 6) or may already reside within such a system. Offer information 80 also includes continuous second information 85 that specifies both the length of the block of continuous seconds and the number of such blocks that are offered for sale. Offer information 80 also includes offer price information 86 in which the seller specifies, for each of the different characteristic defining ways to sell blocks of time (e.g., uninsured, preemptable, non-tradeable), the minimum payment it demands per block of time to provide access to viewers attracted to the program.

Advertisers have different preferences regarding the geographic location of viewers and the programs that attract them. FIG. 11 depicts the different ways in which buyers can bid for access to viewers under the present invention. This information is referred to generally as bid information 87. For example, as discussed above, it is possible under the present invention to permit buyers to bid for access to viewers on a “program” basis, in which they specify the exact program that must attract the viewers they will access. On the other hand, some advertisers are not particularly sensitive, apart from the day-part of the commercial spots they are assigned, to the programs that attract the viewers they access. By bidding on a “day-part” or “multi-program” basis, advertisers can demonstrate their willingness to accept access to viewers attracted to a given program that they select or the complete set of programs within a given day-part.

Finally, under the present invention buyers can specify the exact geographic location to which either their program or day-part bid applies by identifying whether they wish to obtain access to viewers across the entire set of DMA's or a subset of the DMA's within which a particular program is carried by cable operators. This information is referred to generally as bid information 87. For example, as discussed above, it is possible under the system and method of the present invention to permit buyers to determine the exact program in which their advertisements must air. In addition, it is possible under the system and method of the present invention to permit buyers to determine the set of programs in which their advertisements can air. In the former case, the bidder is said to be bidding on a “program” basis, while in the latter case, the bidder is said to be bidding on a “day-part” or “multi-program” basis. In addition, under the present invention, buyers can specify the exact geographic location to which their program or day-part bids apply. In FIG. 11, Node 87a refers to a bid in which a buyer wishes to acquire access to viewers drawn from a particular program (i.e., “program-specific viewers”) across all the DMA's in which that particular program is carried by cable operators. This bid may be call a “national program” bid. In this instance, the buyer specifies a single bid price for the package of DMA's in which it wishes to acquire access to its program-specific viewers.

Node 87b refers to a bid in which a buyer wishes to acquire access to viewers drawn from a particular program across a subset of all the DMA's in which that particular program is carried by cable operators. The bid may be called a “local program” bid. In this instance, the buyer can either specify a single bid price across the package of DMA's in which it wishes to acquire access to its program-specific viewers, or can specify a separate bid price for each DMA in which it wishes to acquire access to its program-specific viewers.

Node 88a refers to a bid in which a buyer is willing to acquire access to viewers drawn from one or more particular programs (i.e., “non-program-specific viewers”) across all the DMA's in which such programs are carried by cable operators. This bid may be called a “multi-DMA, day-part” bid. In this instance, the buyer specifies a single bid price for the package of two or more DMA's in which it wishes to acquire access to its non-program-specific viewers. Node 88b refers to a bid in which a buyer is willing to acquire access to viewers drawn from one or more particular programs within a given DMA in which such programs are carried by the local cable operators. This bid may be called a “single DMA, day-part” bid. In this instance, the buyer specifies a single bid price for each DMA.

For what follows it will be necessary to define the term “impression”. An impression is an event that corresponds to one targeted viewer being exposed to one commercial spot.

Therefore, for a buyer of advertising time, two impressions may either comprise two targeted viewers seeing his commercial one time each, or one targeted viewer seeing his commercial in two different spots.

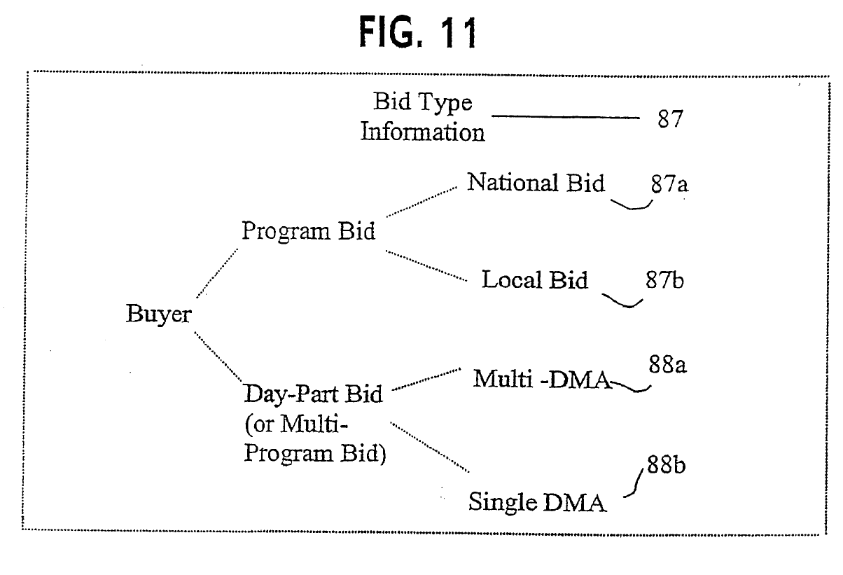

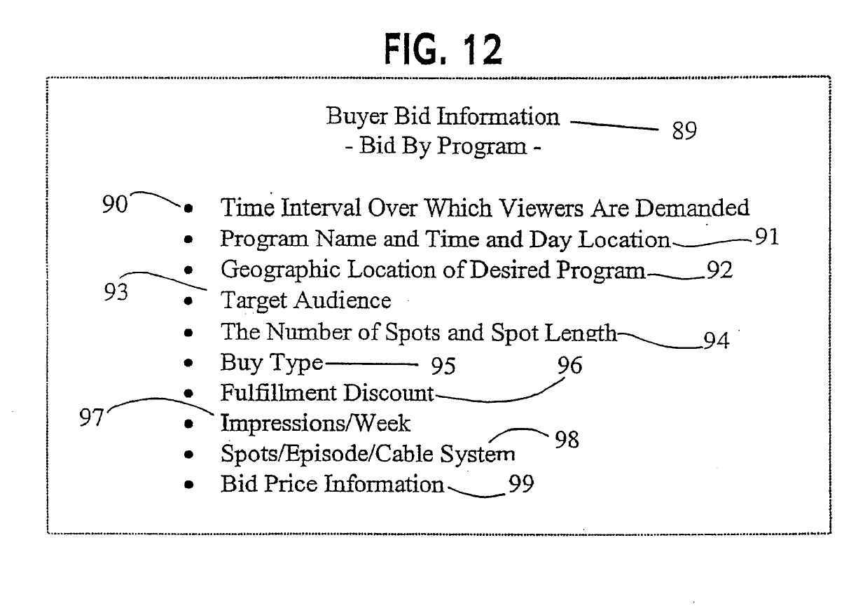

FIG. 12 depicts the type of information that buyers who wish to submit “program” bids transmit to the automated exchange 10. The submitted information is referred to generally as bid information 89. Bid information 89 includes the time interval of the advertising campaign 90, which identifies the period of time in weeks over which the buyer wishes to buy access to viewers; program specific information 91, which specifies the name of the program as well as its time and day-part location; geographic location information 92, which identifies the specific DMA's of the desired access; target audience information 93, which identifies the buyer's target audience by sex and age; spot and length information 94, which specifies the total number of spots the buyer wishes to acquire and the length (expressed in seconds) of those spots; buy type information 95, which permits the buyer to express whether it wishes to create a “local” or “national” bid; fulfillment discount information 96, which specifies the monetary discount the buyer demands for each commercial tape copy the buyer must distribute; impressions/week information 97, which identifies both the minimum and maximum number of impressions the buyer requires per week through the length of its advertising campaign; spots per episode per cable system information 98, which identifies the maximum number of spots per episode per cable system the buyer is willing to accept; and finally, bid price information 99, which specifies, for each of the different characteristic ways to acquire impressions through buying spots (e.g., uninsured, preemptable, non-tradeable), the maximum amount the buyer is willing to pay per thousand impressions of the specified target type that are attracted to the identified program.

Advertisers can demonstrate their willingness to accept access to viewers attracted to a broad variety of programs by bidding for their desired viewers on a “day-part” basis.

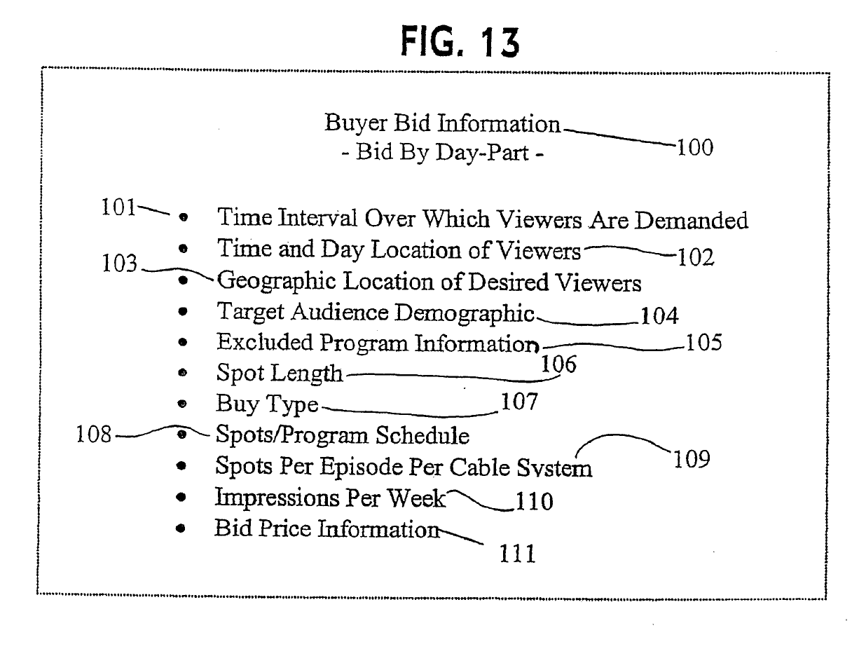

FIG. 13 depicts the type of information that buyers who wish to submit day-part bids transmit to the automated exchange 10. The submitted information is referred to as bid information 100.

Bid information 100 includes the time interval of the advertising campaign 101, which identifies the period of time in weeks over which the buyer wishes to access viewers; program specific information 102, which specifies the time and day-part location of programs eligible to provide access; geographic location information 103, which identifies the specific DMA's of the desired access; target audience information 104, which identifies the buyer's target audience by sex and age; excluded program information 105, which allows the buyer to specify the programs not eligible to provide access to viewers; spot length information 106, which specifies the desired commercial spot length (expressed in seconds); bid type information 107, which identifies whether the buyer wishes to create a multi-DMA or single-DMA bid; spots per program schedule 108, which identifies the minimum and maximum number of commercial spots the buyer wishes to acquire from a given program during the length of the program's schedule; spots per episode per cable system 109, which identifies the maximum number of spots the buyer is willing to accept in a given episode per cable system; impressions per week 110, which identifies the minimum and maximum number of impressions the buyer requires per week through the length of its advertising campaign; and finally, bid price information 111, which specifies, for each of the different characteristic defining ways to acquire impressions through buying spots uninsured, preemptable, non-tradeable), the maximum amount the buyer is willing to pay per thousand impressions of the specified target type that are attracted to any eligible program. The invention consists of an iterative, sealed-bid double auction. Under a sealed-bid auction, only the participant that submits the order knows the order's components. The auction is iterative in that participants have one or more opportunities in which to revise an initially submitted order to buy or sell access to television viewers. In between each round, sellers and buyers receive information regarding the status of their bids and offers.

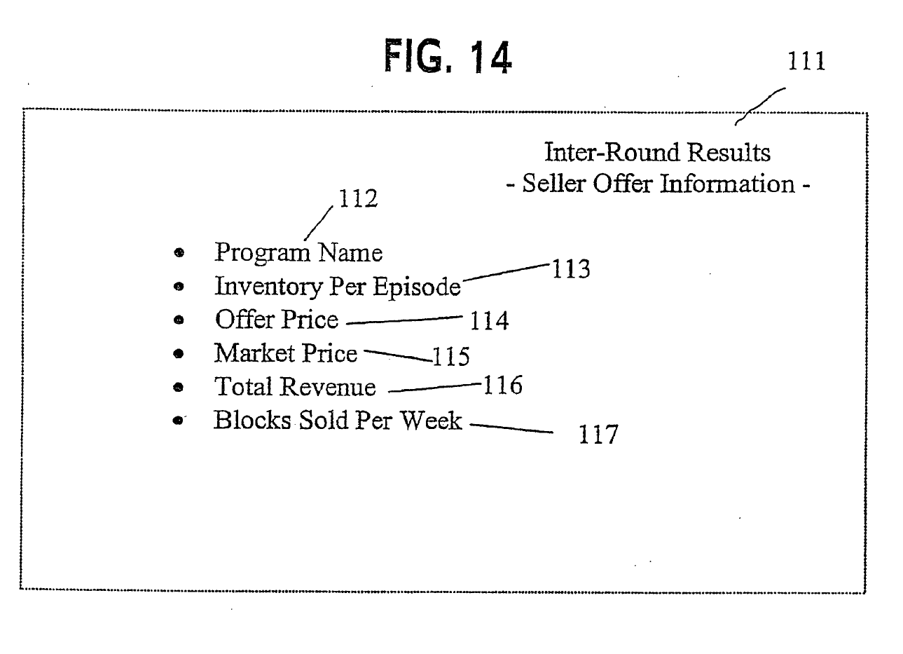

FIG. 14 presents the inter-round information received by the seller. Seller inter-round information 112 includes the program name 113, inventory per episode 114, offer price per block 115, calculated tentative price per block per week 116, total revenue 117, blocks sold per week 118.

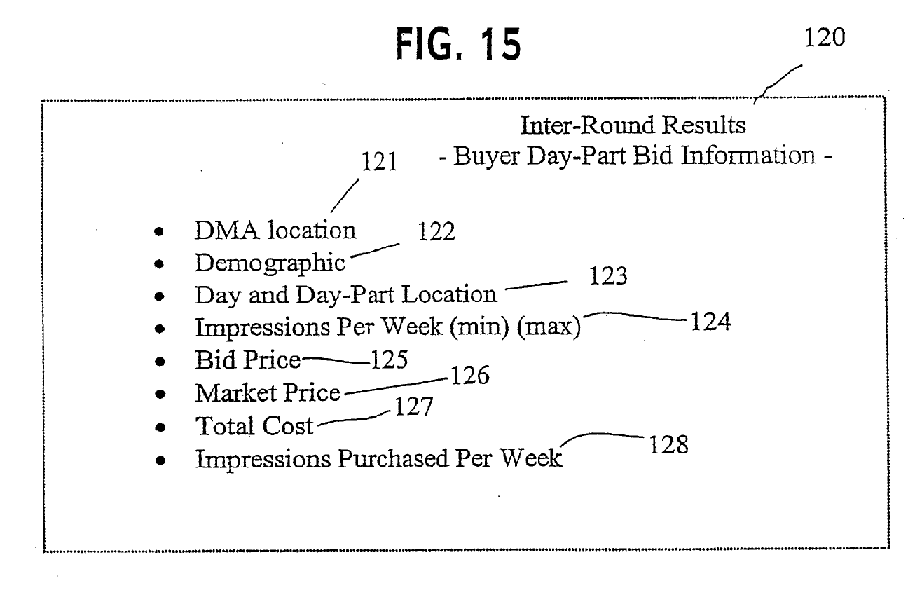

FIG. 15 presents the inter-round information received by the buyer, assuming the buyer bids on a day-part basis. Buyer inter-round information 120 includes the DMA location 121, target audience 122, day and day-part location 123, impressions per week (min) (max) 124, bid price 125, tentative price 126, trade cost 127, and impressions purchased per week 128. If the bid has been accepted, trade cost 127 will also show what the total cost would be if the buyer paid his bid, as opposed to his transaction price.

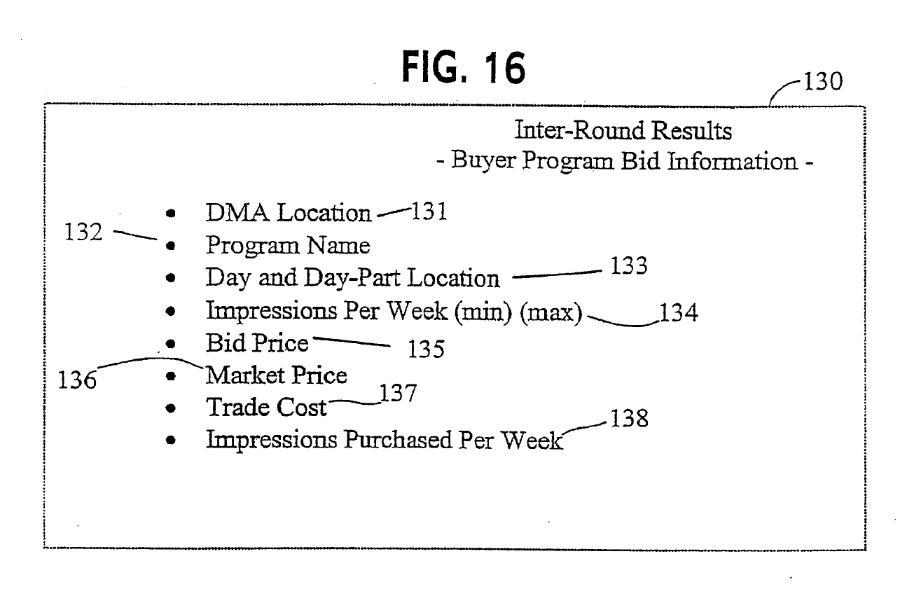

FIG. 16 presents the inter-round information received by the buyer, assuming the buyer bids by program. Buyer inter-round information 130 includes DMA location 131, program name 132, day and day-part location of program 133, impressions per week (min) (max) 134, bid price 135, tentative price 136, trade cost 137, and impressions purchased per week 138. If the bid has been accepted, trade cost 137 will also show what the total cost would be if the buyer paid his bid, as opposed to his transaction price.

The problem of identifying a set of trades that, as in the preferred embodiment described herein, maximizes the revealed gains from trade based upon the bids and offers placed in the market is herein referred to as the “assignment problem.” Solving the assignment problem at each round involves solving the following integer programming problem:

Maximize:

| | | |
|---|---|---|
| (1) | V = ΣₘΣₜΣ_{c}b_{mtc} · q_{mtc} | Gains From Exchange |
| (2) | dₘ = 0 or dₘ ∈ [αₘ, 1] ∀ m | Acceptance Level Constraints; |
| (3) | \|Qₘₜ↓\|\|qₘₜ\|\|Qₘₜ↑\| | Assignment Limit Constraints; |
| (4) | Σₘλₘ · q_{mtc} = 0 ∀(t, c) | Sold-Bought Balance Constraints; |
| (5) | Σₜfₘₜ · q_{mtc}/Fm = dₘ ∀ m | Equivalence Constraints; |
| (6) | Σ_{m∈Lij} int[dₘ] kᵢⱼ | Logical Constraints; |
| (7) | qₘₜ = Σ_{c}q_{mtc}, and q_{mtc} ∈ I ∀ | Feasibility Constraints; |
| | (m, t, c) | |

where:

V is the revealed sum of buyer and seller surplus;

m=1, . . . M indexes the buy and sell orders submitted;

c=1, . . . C indexes the characteristic ways in which to assign spots;

t=1, . . . T indexes the available commercial time blocks;

i=1, . . . I indexes the individual buyers and sellers;

and the decision variables are:

dₘ is the level at which order m is assigned;

q_{mtc}, the number of spots in block t that are assigned to order m under characteristic c;

q_{mtc}>0 indicates the buyer of order m buys q_{mtc} spots;

q_{mtc}<0 indicates the seller of order m sells q_{mtc} spots;

qₘₜ, the total number of spots in block t that are assigned to order m under any characteristic;

qₘ=(qₘ₁,qₘ₂, . . . q_{mT}) is the vector of spots allocated to market order m;

and the parameters (information) input by the buyers and sellers are:

λₘ ε [1, 2, 3, . . . ] is the number of seconds per spot for order m;

b_{mtc}, the monetary bid or ask submitted by the owner of order m to buy or sell 1 spot of length λₘ in block t under characteristic c;

b_{mtc}>0 indicates a buyer is willing to pay at most b_{mtc} to buy a spot;

b_{mtc}<0 indicates a seller is willing to accept no less than b_{mtc} to sell a spot;

Qₘₜ↓, the minimum number of spots in block t which can be assigned to order m;

Qₘₜ↓>0 indicates the buyer must buy at least Qₘₜ↓ spots;

Qₘₜ↓<0 indicates the seller must sell at least |Qₘₜ↓| spots;

Qₘₜ↑, the maximum number of spots in block t which can be assigned to order m;

Qₘₜ↑>0 indicates the buyer is willing to buy up to Qₘₜ↑ spots;

Qₘₜ↑<0 indicates the seller is willing to sell up to |Qₘₜ↑| spots;

Fₘ, the number of equivalent spots which are required to completely fill order m;

Fₘ>0 gives the buyer's maximum demand for equivalent spots;

F_{M}<0 gives the negative of the seller's maximum supply of equivalent spots;

|Fₘ/fₘₜ|, the number of spots of the type in block t that would be needed to completely fill order m;

Lᵢⱼ defines the jth logically bound subset of the set of orders that individual i submits;

αₘ ε [0, 1] is the minimum acceptable assignment level of order m.

The first input parameter, λₘ, specifies the length in seconds of the spots to be associated with filling order m. This would be 1 second for sellers who allow their offered block of continuous seconds to be sold to buyers who seek spots of various longer lengths.

The final input parameter, αₘ, specifies that the owner of order m is willing to have his order partially assigned as long as the acceptance level, dₘ, is greater than αₘ (constraint 2). The maximal total surplus generated by solving the above program, V*, is always greater than or equal to 0, the “do-nothing” alternative. The solution to the assignment problem is given by a set of assignment variables, {q_{mtc}}, that each assigns a particular number of spots from block t to order m under characteristic c. The total number of spots assigned from block t to order m under all characteristics, qₘₜ, has upper and lower bounds governed by constraint (3). Constraint (4) requires that the total assigned time bought for block t under characteristic c does not exceed the time sold that way. Constraint (5) requires that for any particular market order, m, the mix of spots from different blocks, t, assigned to satisfy that order, qₘₜ*, are subject to substitutability and capacity preferences specified by the submitter of the order (e.g., “to completely fill order #3, Buyer i must buy slots of type a, b and c in any proportions that satisfy the following equation: q₃ₐ+2q_{3b}+3q_{3c}=12”). Constraint (6) requires that of a orders a buyer or seller submit, those assigned must meet any set of logical constraints a buyer or sell may specify (e.g., “I'd like to fill order #3 or order #7 but not both.”). The assignment problem is a mixed-integer linear programming problem (MILP). There are many different methods to solve such a problem such as disclosed in Skiena, Steven (1997), The Algorithm Design Manual, Springer-Verlag, N.Y. In the current context, a MILP solution algorithm takes the collection of bids and asks at each iteration and finds that set of trades that maximizes, subject to the constraints listed above, gains from trade.

The SEDA of the present invention requires the calculation of a set of transaction prices for the spots bought and sold given the solution to the above assignment problem. The prices calculated must satisfy two criteria: successful buyers must pay no more than they bid while successful sellers must receive no less than they ask, and the total amount that buyers pay must balance the total amount that sellers receive. Such a calculation is complicated by the fact that there might not exist, given the set of bids, offers and constraints placed in the market, a set of competitive equilibrium prices, because the decision variable dₘ is semi-continuous and the variables qₘₜ are required to be integers. These prices would always exist if the decision variables were allowed to be real numbers within the specified ranges. Let the solution to the continuous version of the above gains maximization problem be the sets {dₘ^{R}} and {qₘ^{R}} of real numbers, which will be exactly equal to {dₘ*} and {qₘ*} when a competitive equilibrium solution does exist. Using the information generated by both solutions, the following optimization computes a set of competitive prices if it exists. Otherwise, it computes a set of prices that meet the two criteria above, and is, by the metric Δ, as close to equilibrium pricing as possible. It may sometimes be the case that more than one set of prices suffices to minimize Δ. The outer optimization can be used to minimize the difference between the total surplus of buyers and sellers when there is some pricing flexibility:

Minimize:
Σₘ ε S*,b>0 (ΣₘΣₜΣ_{c}b_{mtc}·q_{mtc}*−TPₘ)−Σₘ εS*,b<0 (ΣₘΣₜΣ_{c}b_{mtc}·q_{mtc}*−TPₘ) Surplus split; (8)

subject to:

| | | |
|---|---|---|
| (9) | Δ = inf.{Σ_{m ε S}* max[0, | Minimum distance; |
| | (TPₘ − ΣₜΣ_{c} (λₘ · π_{tc} + ρ_{mc}) · q_{mtc}*)]} | |
| (10) | (λₘ · π_{tc} + ρ_{mc}) ≦ b_{mtc} ∀ q_{mtc}^{R} ≧ 0 | Accepted assignment; |
| (11) | (λₘ · π_{tc} + ρ_{mc}) ≦ b_{mtc} ∀ q_{mtc}^{R} = 0 | Rejected assignment; |
| (12) | TPₘ ≦ ΣₘΣₜΣ_{c}b_{mtc} · q_{mtc}* ∀ m ε S* | Submitted price limits; |
| (13) | Σ_{m∈S}* TPₘ = 0 | Balanced budget. |

where:

Δ is a measure of distance from achieving competitive equilibrium prices;

S* is the set of successful orders (bids and asks) and ~ S* is the set of failed orders;

λₘ is the length in seconds of the spots for order m;

b_{mtc} is the original bid or ask submitted by the owner of order m for 1 spot of length λₘ in block t under characteristic c;

dₘ* is the optimal semi-continuous acceptance level of order m;

q_{mtc}* and q_{mtc}^{R} are the optimal integer and real number of spots in block t assigned to order m under characteristic c;

and the decision variables are:

TPₘ, the transaction price paid or received to fill order m at level dₘ;

π_{tc}, a price associated with 1 second of block t time under characteristic c; and

ρ_{mc}, a price associated with an order m under characteristic c.

The minimal aggregate distance from the competitive equilibrium prices, Δ*, will always be equal to 0 if competitive equilibrium prices exist. The solution to the above minimization problem is given by a set of transaction prices, {TPₘ*}, one for each successful market order ε S*; and two sets of assignment prices, {π_{tc}*} and {ρ_{mc}*}, which jointly affect the market price of assigning a spot in block t to an order m under characteristic c. The transaction price, TPₘ*, indicates precisely how much money the buyer is required to pay or the seller actually receives for the order accepted at level dₘ. When a competitive equilibrium exists, the transaction price, TPₘ*, will correspond exactly to the total cost at market prices, ΣₜΣ_{c} (λₘ·π_{tc}+ρ_{mc})·q_{mtc}*, of the optimal mix time slots assigned satisfy market order m. Constraints (10) and (11) state necessary conditions to find the market prices, λₘ·π_{tc}+ρ_{mc}, for each assignment, q_{mtc}^{R}, of the real version of the original maximization problem. Constraint (12) restricts the transaction price of a successful buy order to be at or below the submitted bid, and the transaction price of a successful sell order to be at or above the submitted offer. Constraint (13) guarantees that the total paid by all buyers will exactly match the total received by all sellers.

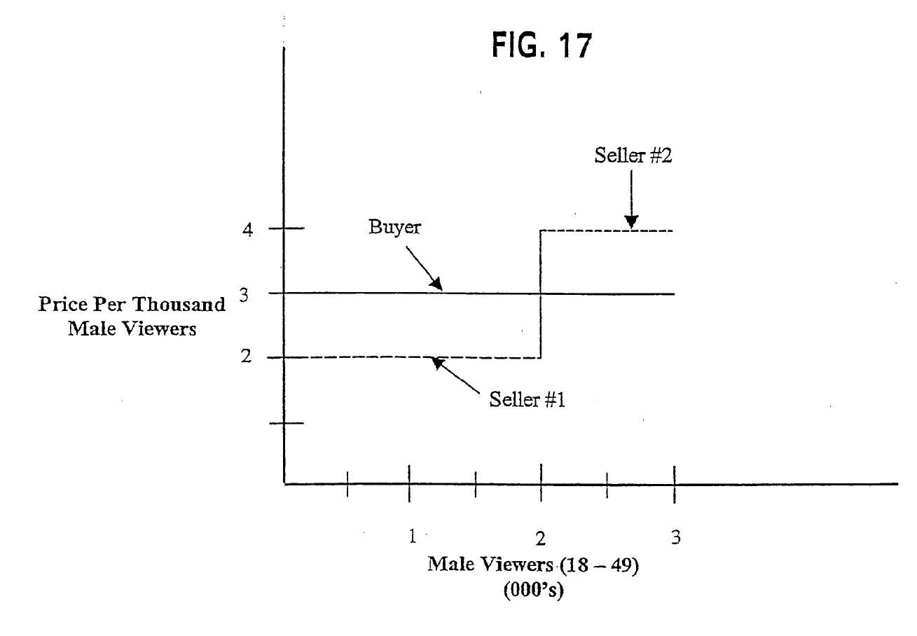

Given the bids and offers submitted to the market, there may or may not exist a set of competitive equilibrium prices. Consider the situation depicted in FIG. 17. Suppose the Buyer wishes to obtain access to any number between 1000 and 3000 Male viewers, 18-49 years of age, and is willing to pay $3 per thousand viewers for such access. Seller #1 is willing to sell 2 commercial spots A, which each provide access to 1000 Male viewers (18-49), at a price of $2 per thousand. Finally, Seller #2 is willing to sell 1 commercial spot B, which provides access to 1000 Male viewers (18-49), at a price of $4 per thousand. Gains from trade are maximized if not all orders are filled. The Buyer will purchase access to 2000 Male viewers (18-49) from Seller #1, and Seller #2's ask will be rejected. The maximal gains from exchange, V*=$2, will be the Buyer's bid times his level of acceptance, $9×⅔, minus Seller #1's ask times his level of acceptance, $4×1. The competitive equilibrium prices must exist because the integer and real solutions are equal. The Buyer's and Seller #1's transaction price would be $6. The competitive equilibrium price for commercial spot A must be $3 because there is excess demand at that price, while the competitive equilibrium price of commercial spots B can be anywhere between $3 and $4, say $3. 5, since that would simultaneously exclude the Buyer and Seller #2 from trading the third spot.

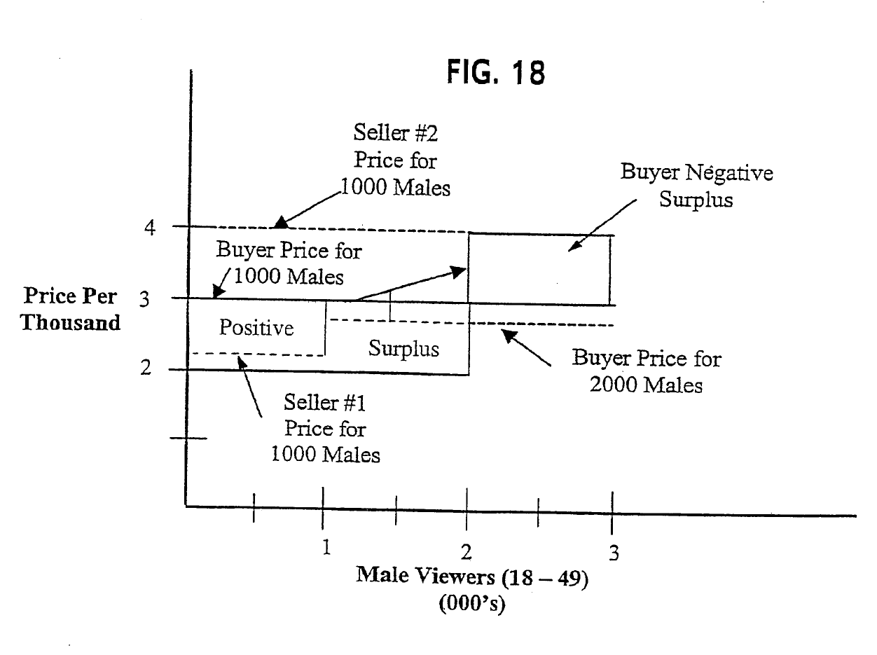

In FIG. 18 the situation just described is reconsidered. Suppose the buyer now insists on access to a minimum of 3000 Male viewers, 18-49 years of age and is still only willing to pay $3 per thousand for such access. Assume Sellers #1 and #2 submit the same asks as described above. Gains from trade are now maximized only if all orders are filled. The maximal gains from exchange are V*=$1: the Buyer's bid times his level of acceptance, $9×1, minus Seller #1's ask times his level of acceptance, $2×2, minus Seller #2's ask times his level of acceptance, $4×1. The maximal gains have been reduced by $1 because the buyer is imposing an additional constraint on the assignment. The buyer pays the cost of the constraint, $1, in addition to the offered costs of the commercial spots, $8, for a transaction price of $9. Seller # 1 receives $5 and Seller #2 receives $4 as those transaction prices are the closest to the equilibrium prices, 2×$3 and $3.50 that would arise if the buyer would not insist on completely filling his order.

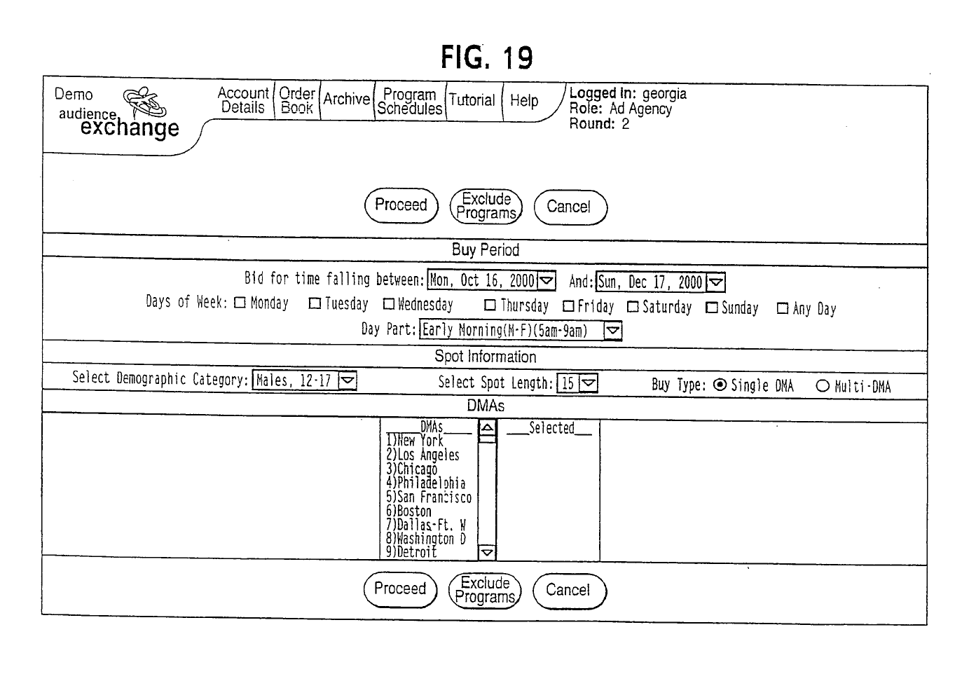

The present invention includes numerous electronic displayable files stored in trading system 11 and accessed by remote terminals 17 and 18. FIGS. 19-46 represent various screen shots corresponding to the electronic displayable files. As discussed hereinbelow, each screen provides important information to the user while including data fields for receiving data from the user for transmission to central trade exchange 11. Although not shown, various screens may be provided for interfacing with a system operator for performing monitoring and administration functions associated with the exchange.

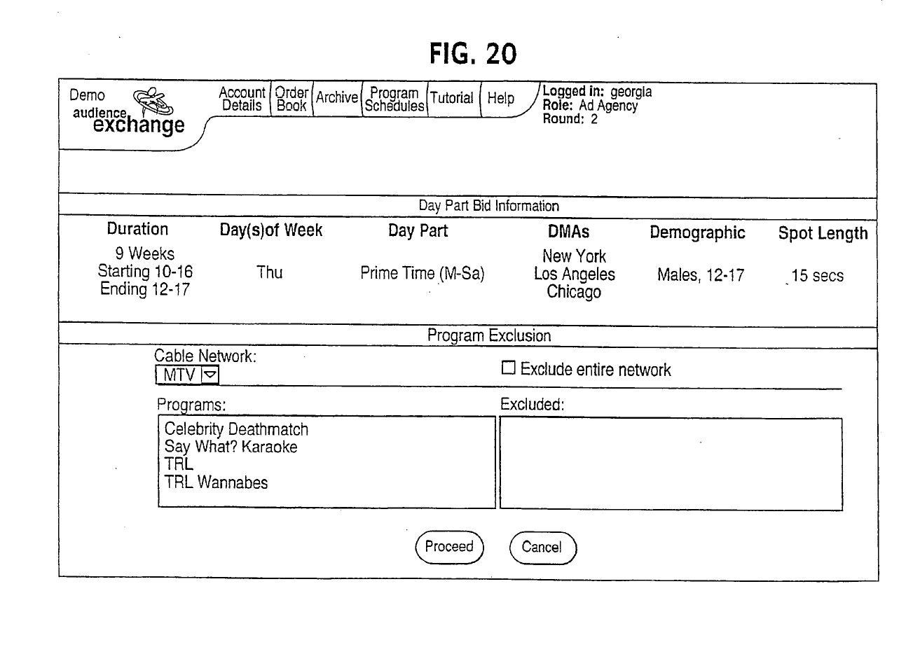

FIG. 19 discloses a screen shot involving the application of the system and method of the present invention to trading “access to viewers” (referred to on the screen as “viewers”) attracted to programs distributed by cable networks and exhibited by cable operators (“cable network viewers”). Employing the screen disclosed in FIG. 19, a buyer that wishes to acquire cable network viewers on a day-part basis specifies the campaign period over which its “buy” applies, the precise day and day-part in which it wishes to acquire its desired cable network viewers, its target audience, its desired spot length, the “buy” type (i.e., multi-DMA or single DMA) and the geographic location where it wishes to acquire its desired cable network viewers. FIG. 20 discloses a screen shot for the same application that enables a buyer to identify the set of programs from which its acquired cable network viewers cannot be drawn.

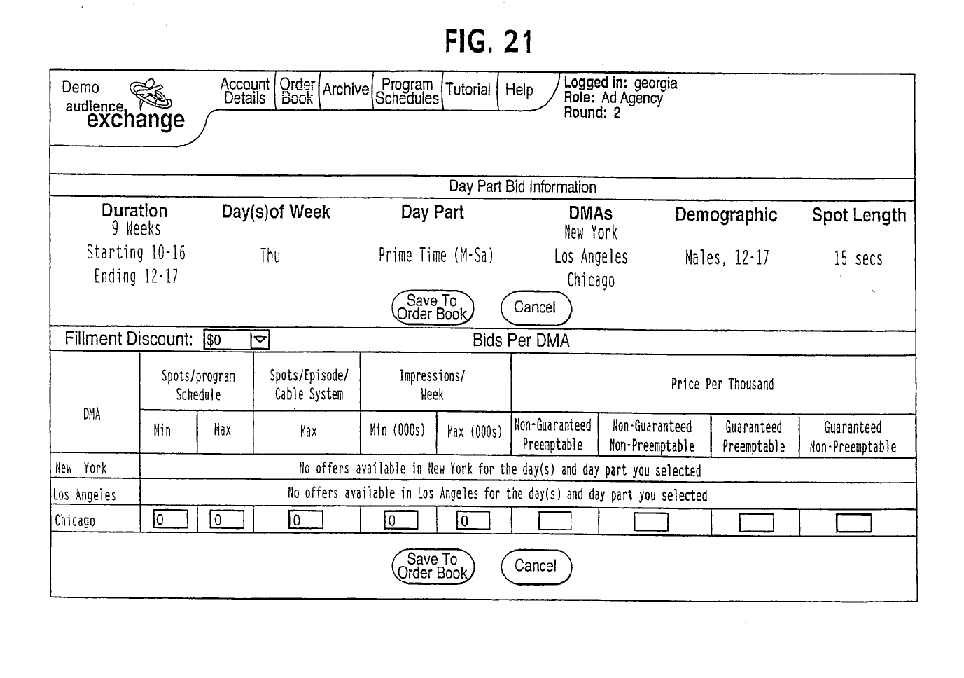

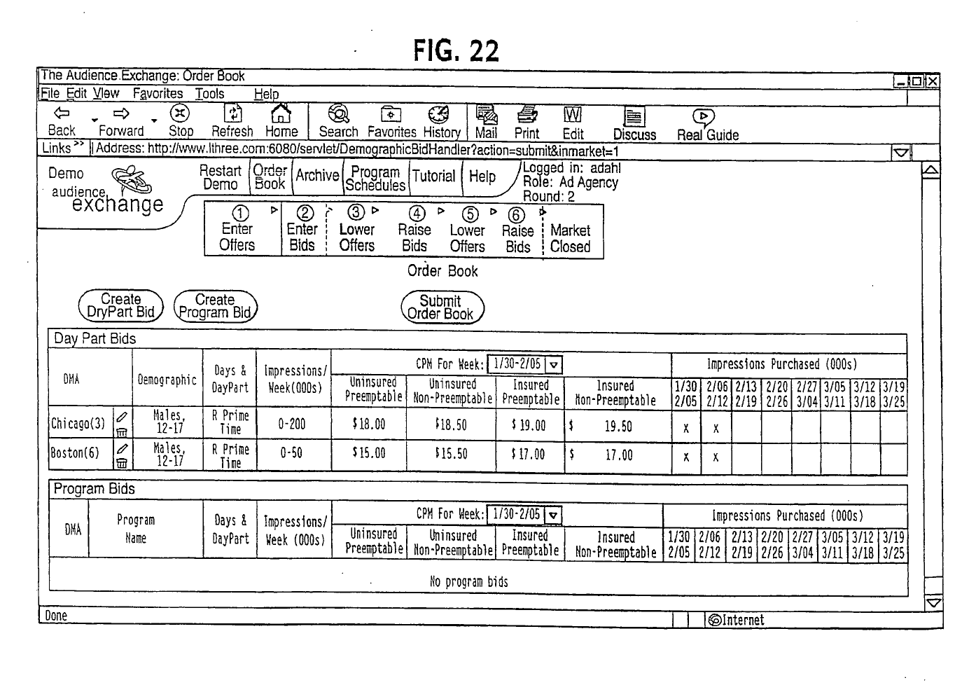

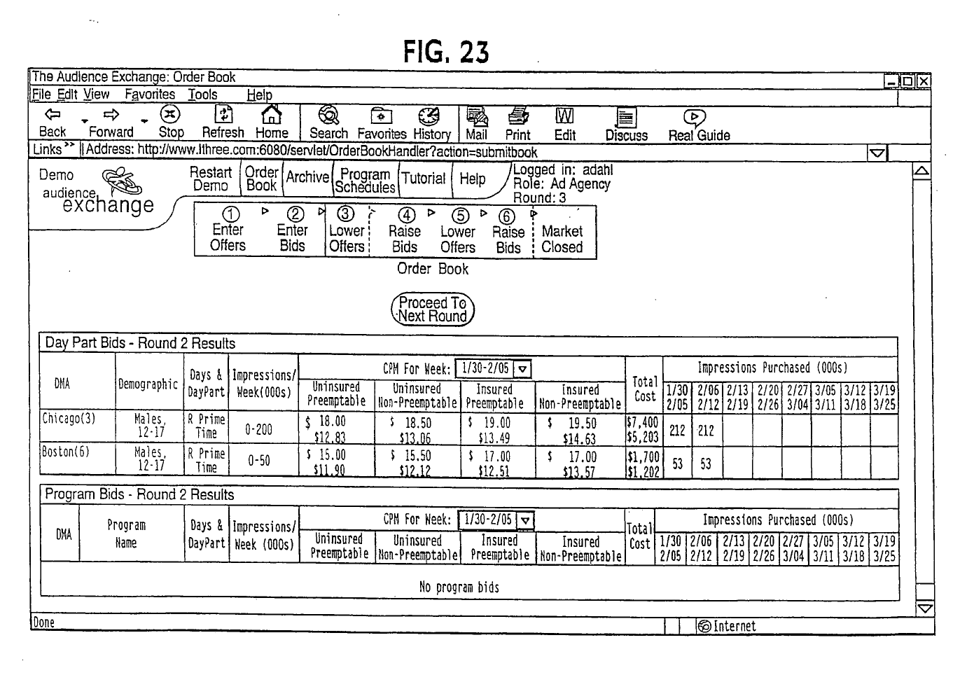

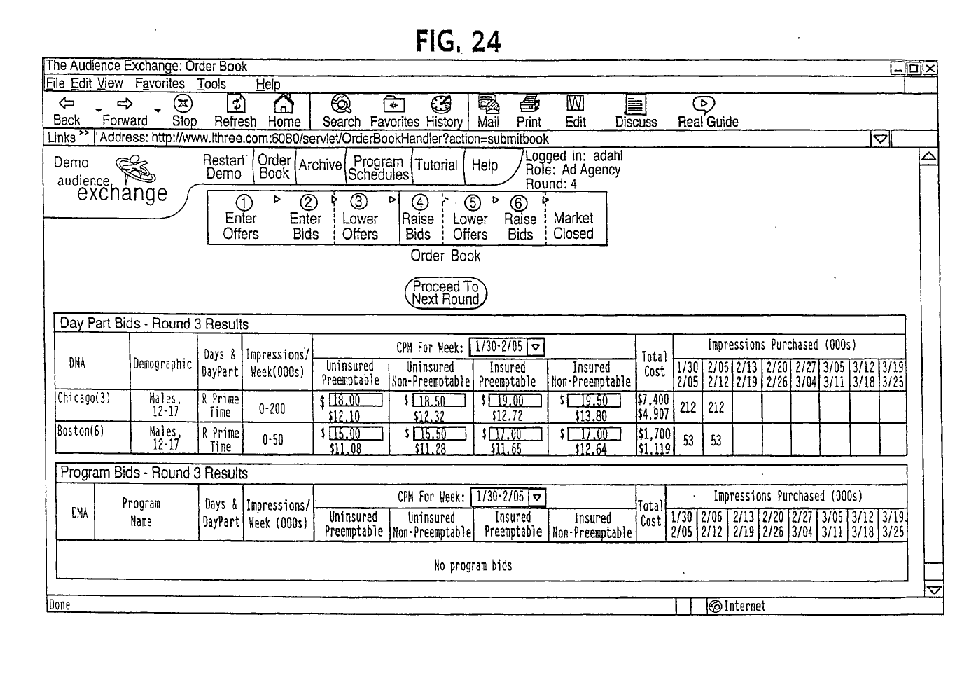

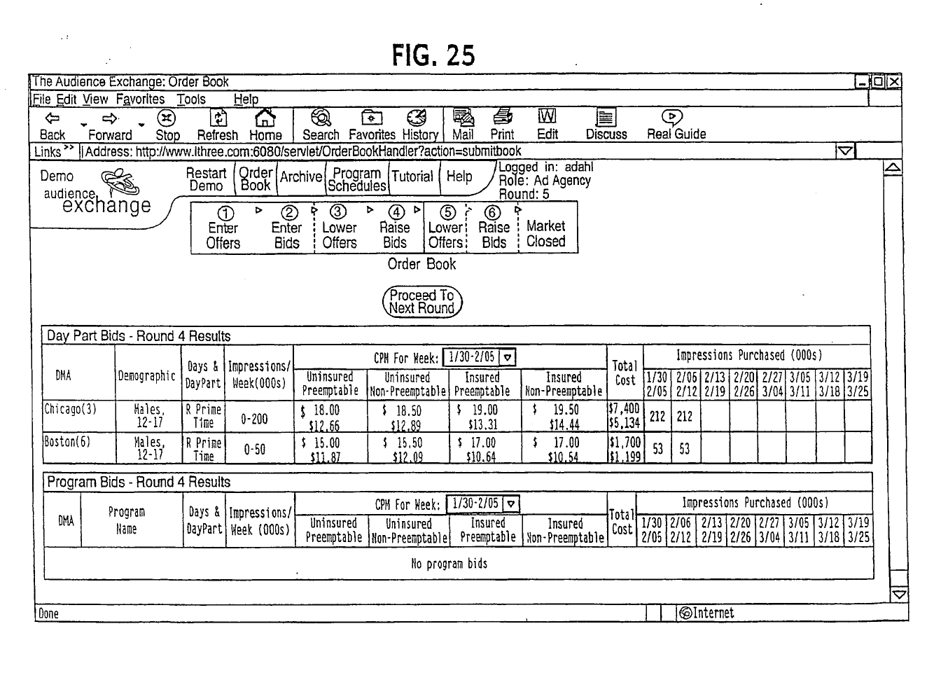

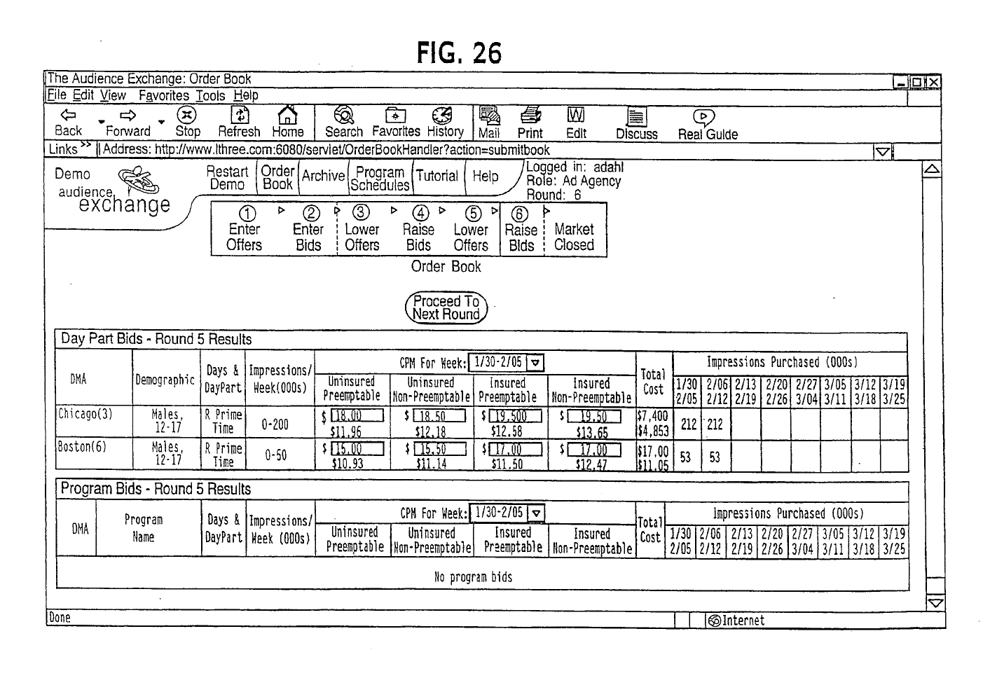

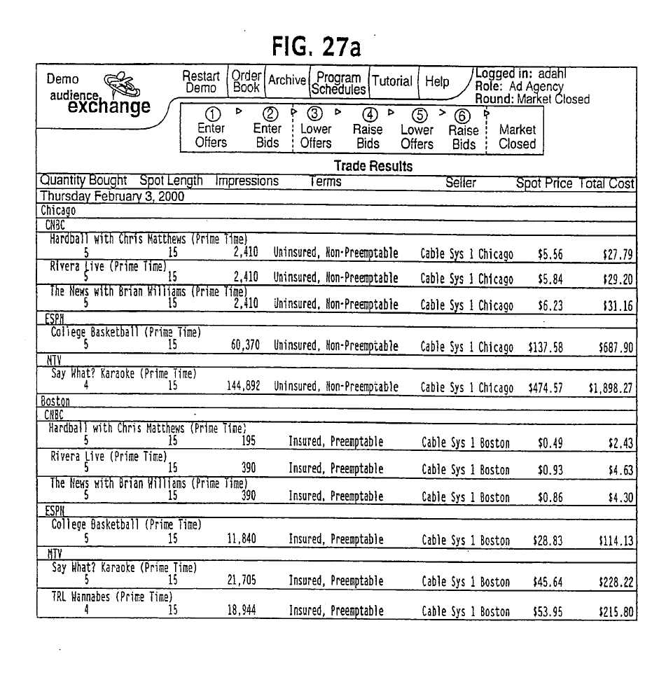

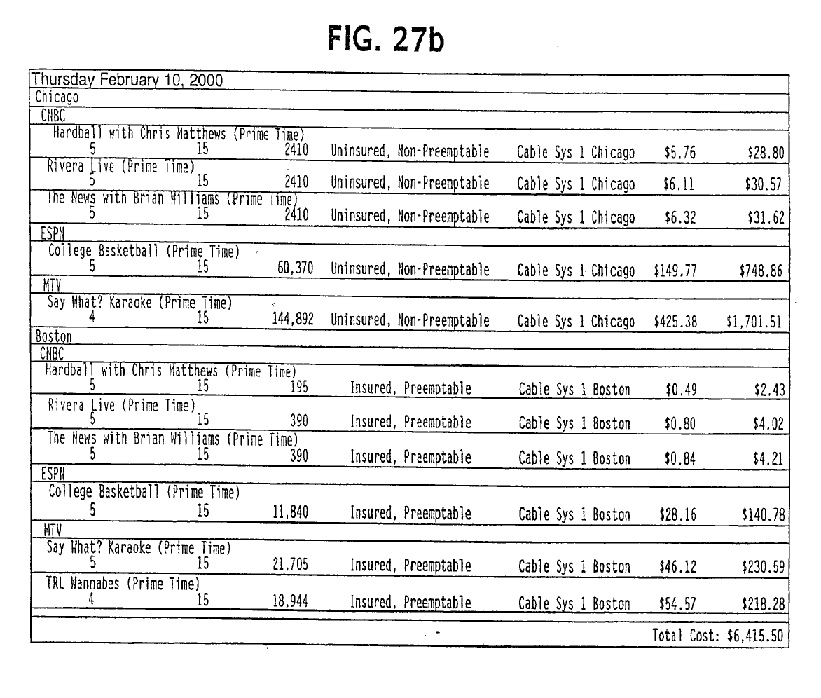

FIG. 21 discloses a screen shot that enables a buyer to specify the minimum and maximum number of commercial spots it wishes to be assigned from a given program, the maximum number of commercial spots the buyer is willing to accept per program episode per cable system, and the minimum and maximum number of impressions (e.g., cable network viewers) the buyer wishes to acquire per week during its buy campaign, and the maximum amount of money the buyer is willing to pay, expressed in terms of price per thousand impressions, for its desired cable network viewers under four different sets of flexible characteristics (i.e., Non-Guaranteed, Preemptable; Guaranteed, Preemptable; Non-Guaranteed, Non-Preemptable; Non-Guaranteed, Preemptable). Note that the terms “guaranteed” and “non-guaranteed” are intended to have the same meaning as “insured” and “uninsured” as defined herein, respectively. FIG. 22 discloses a screen shot that presents two day-part bids. FIG. 23 discloses a screen shot that displays the inter-round results information the buyer receives immediately following Round #2. FIG. 24 discloses a screen shot for the same application that displays the inter-round results information the buyer receives immediately following Round #3 and provides the buyer the opportunity to raise its bid prices. FIG. 25 discloses a screen shot that displays the inter-round results information the buyer receives immediately following Round #4. FIG. 26 discloses a screen shot that displays the inter-round results information the buyer receives immediately following Round #5 and provides the buyer the opportunity to raise its bid prices. FIG. 27 discloses a screen shot for the same application that displays the buyer's completed trades.

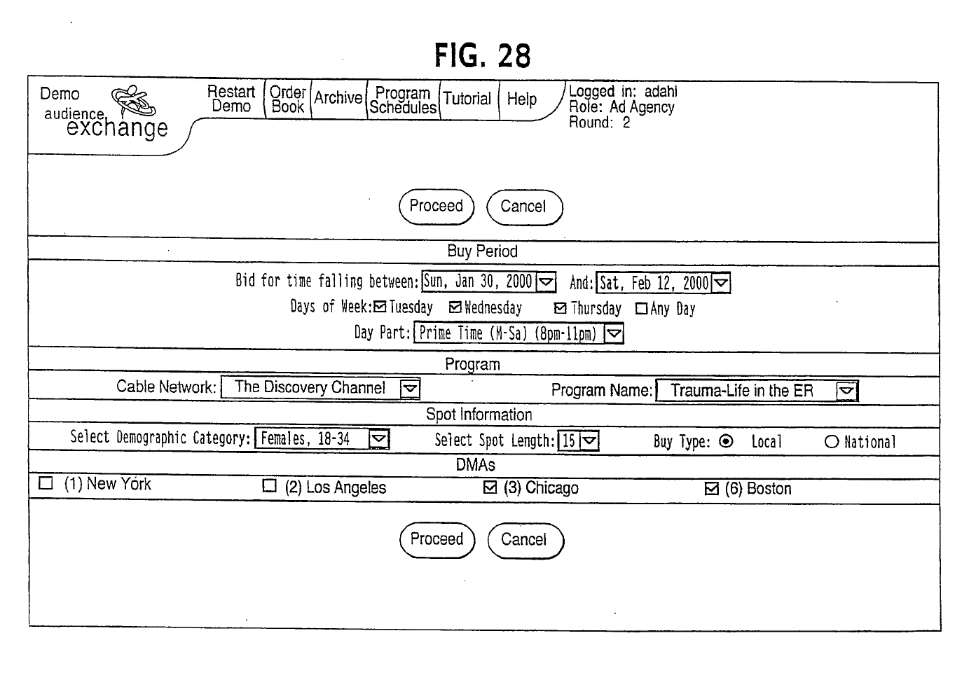

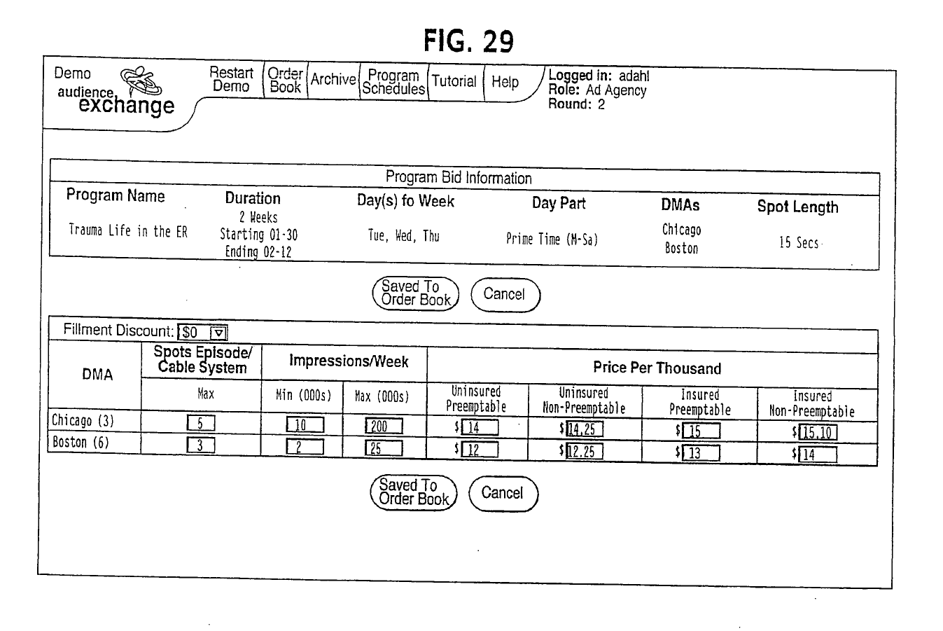

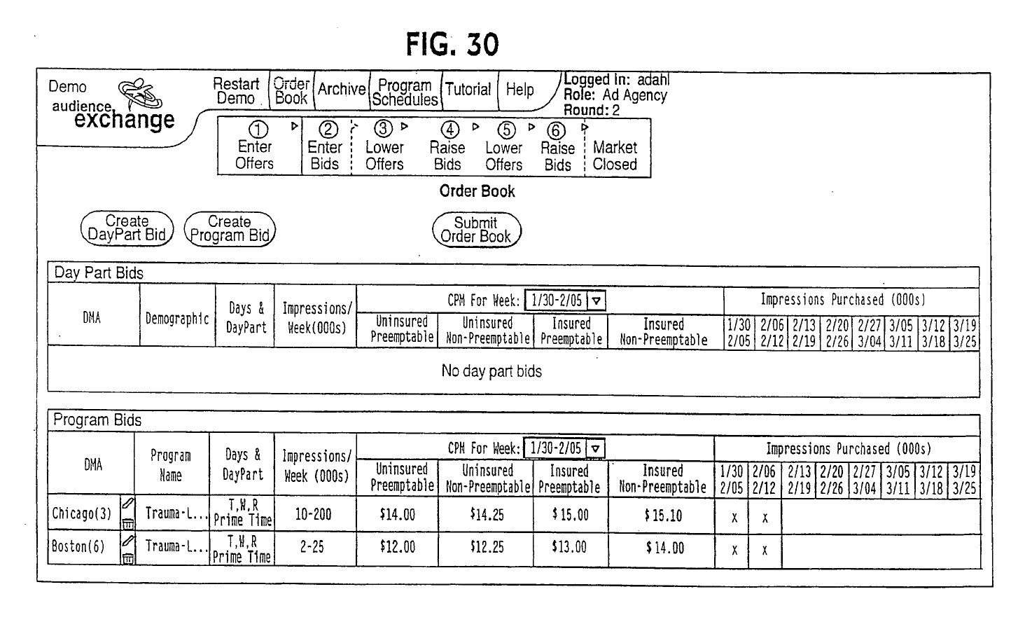

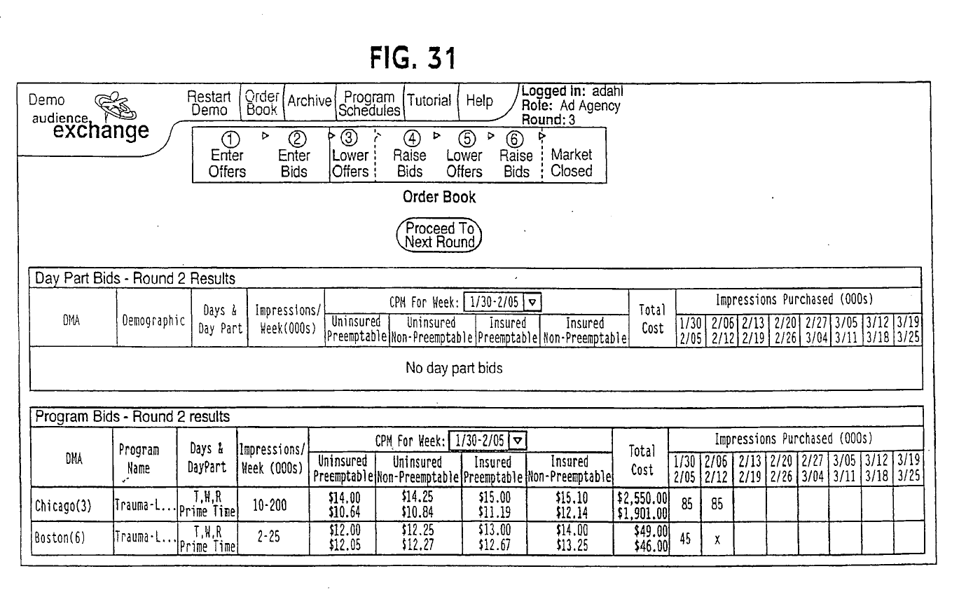

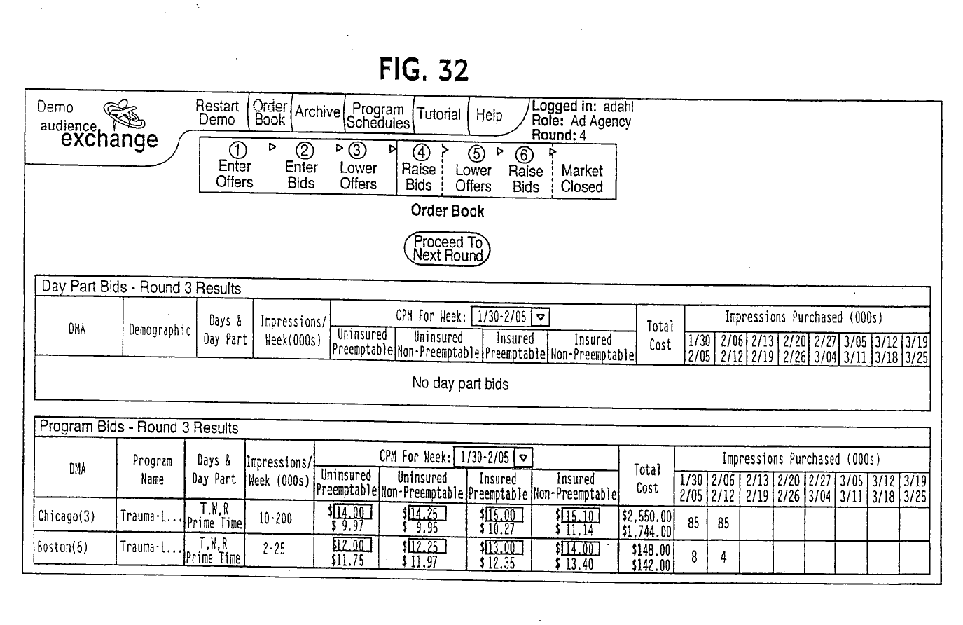

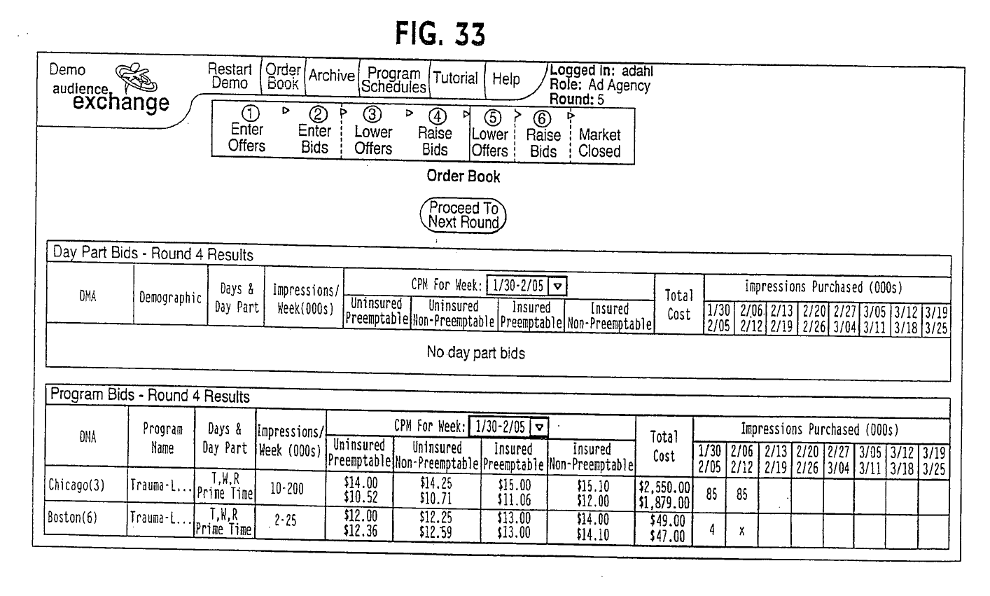

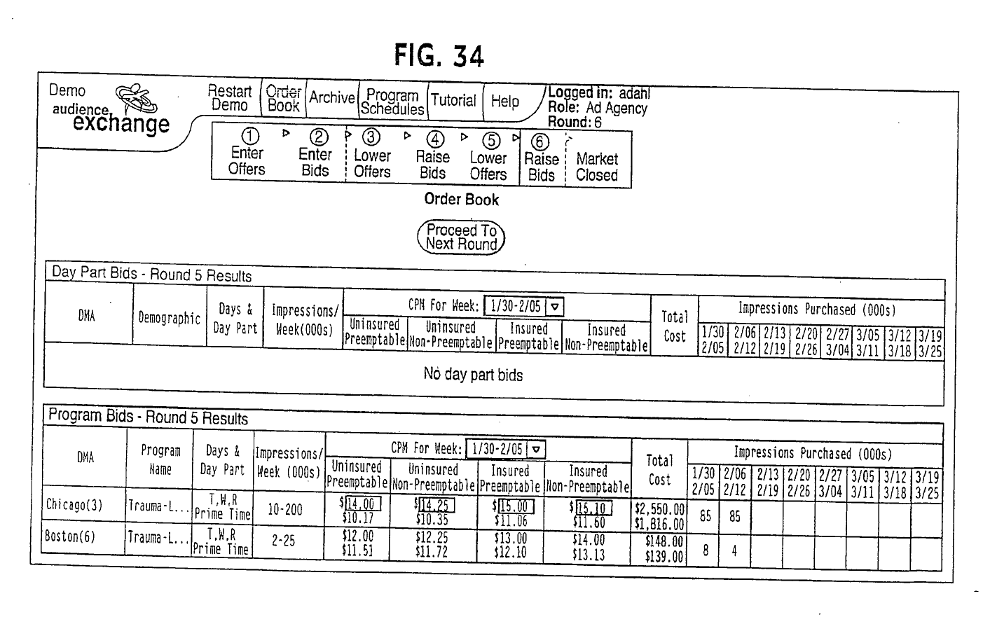

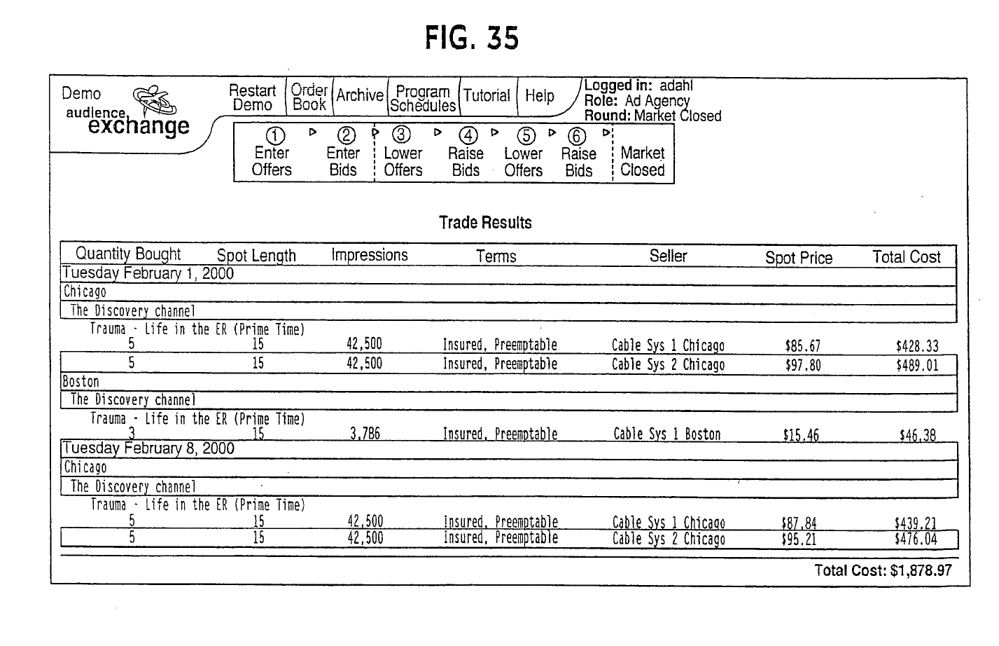

FIG. 28 discloses a screen shot in which a buyer that wishes to acquire cable network viewers on a program basis specifies the campaign period over which its “buy” applies, the precise day and day-part in which its wishes to acquire its desired cable network viewers, the cable network and program from which its desired viewers must be drawn, its desired spot length, its target audience, the buy “type” (i.e., local or national) and, if local, the geographic location where it wishes to acquire its desired cable network viewers. Employing the screen disclosed in FIG. 29, a buyer is able to specify the maximum number of commercial spots it is willing to accept per program episode per cable system, the minimum and maximum number of impressions (e.g., cable network viewers) the buyer wishes to acquire per week during its buy campaign, and the maximum amount of money it is willing to pay, expressed in terms of price per thousand impressions, for its desired cable network viewers under four different sets of flexible characteristics (i.e., Uninsured, Preemptable; Insured, Preemptable; Insured, Non-Preemptable; Uninsured, Non-Preemptable). FIG. 30 discloses a screen shot that presents two program bids. FIG. 31 discloses a screen shot for the same application that displays the inter-round results information the buyer receives following Round #2. FIG. 32 discloses a screen shot for the same application that displays the inter-round results information the buyer receives following Round #3 and provides the buyer the opportunity to raise its bid prices. FIG. 33 discloses a screen shot that displays the inter-round results information the buyer receives following Round #4. FIG. 34 discloses a screen shot that displays the inter-round results information the buyer receives following Round #5 and provides the buyer the opportunity to raise its bid prices. FIG. 35 discloses a screen shot that displays the buyer's completed trades.

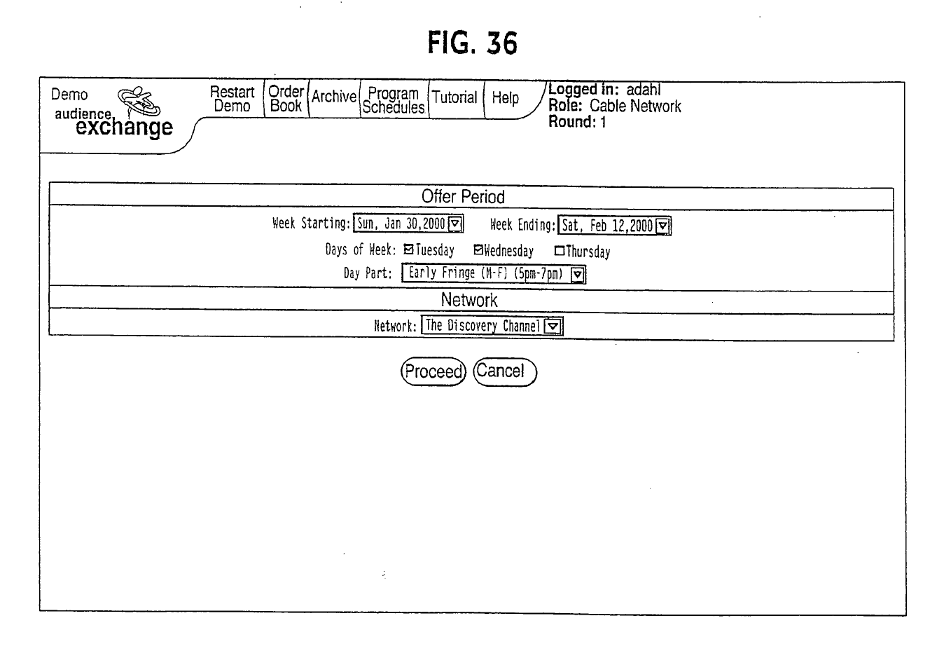

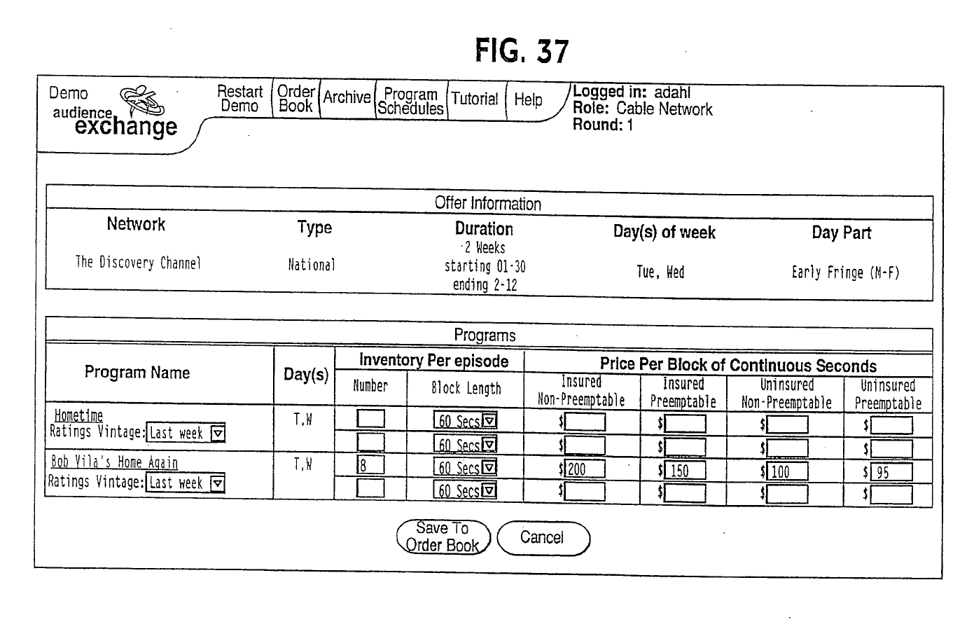

FIG. 36 discloses a screen shot in which a seller specifies the period over which its “avail offer” applies, the precise day and day-part location of the “avails” (i.e., blocks of continuous seconds of advertising time) it wishes to sell, as well as the cable network location of those avails. FIG. 37 discloses a screen shot in which the seller identifies the number of avails it wishes to sell, the length of each avail, and the minimum amount of money it requires, expressed in terms of price per block of continuous seconds, in exchange for its avails. Employing the screen disclosed in FIG. 37, the seller has the opportunity to sell its avails under four different sets of flexible characteristics (i.e., Uninsured, Preemptable; Insured, Preemptable; Insured, Non-Preemptable; Uninsured, Non-Preemptable). Employing the screen disclosed in FIG. 37, the seller has the opportunity to submit an estimate of the number of viewers, broken out by target audience category, attracted to a particular program.

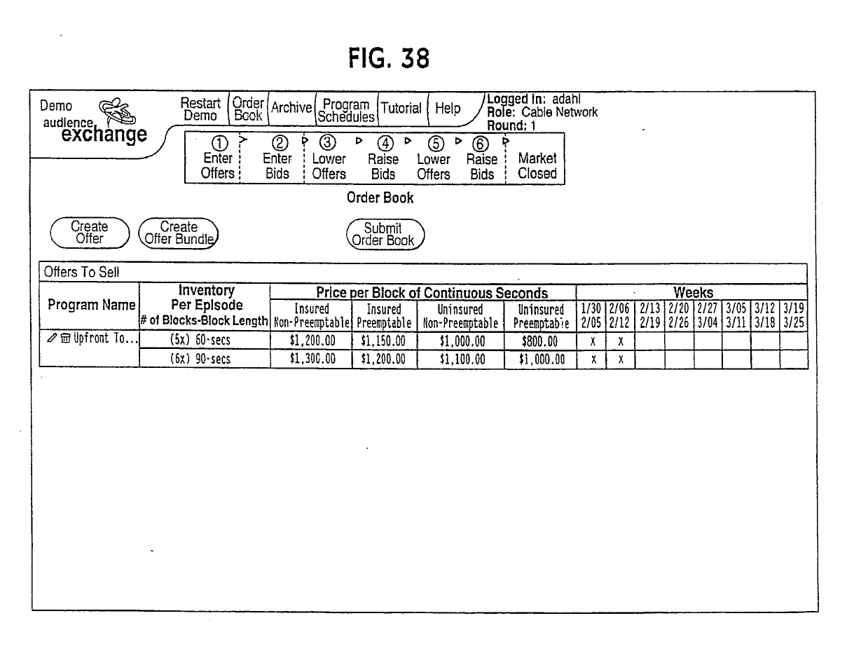

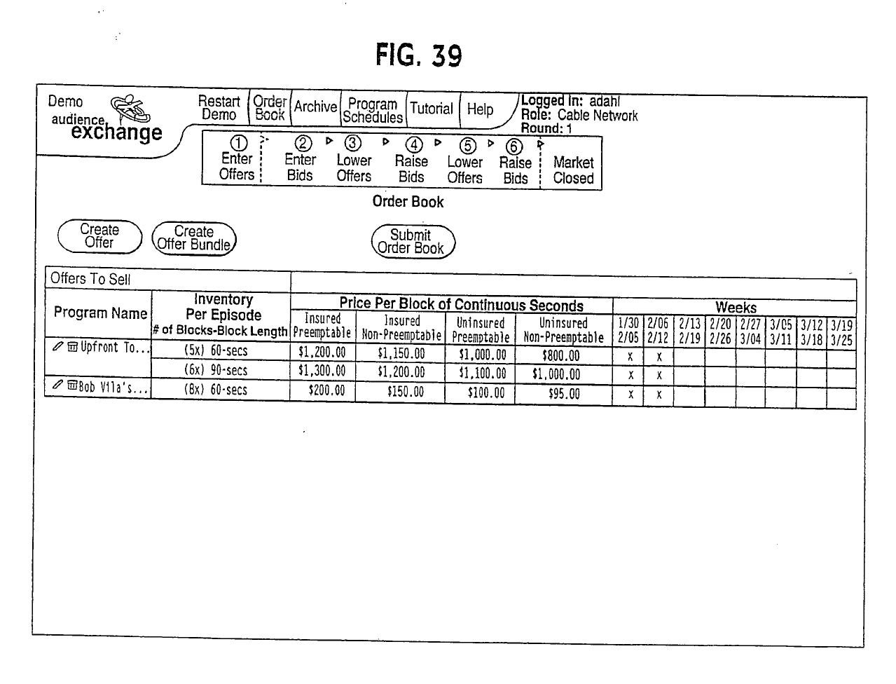

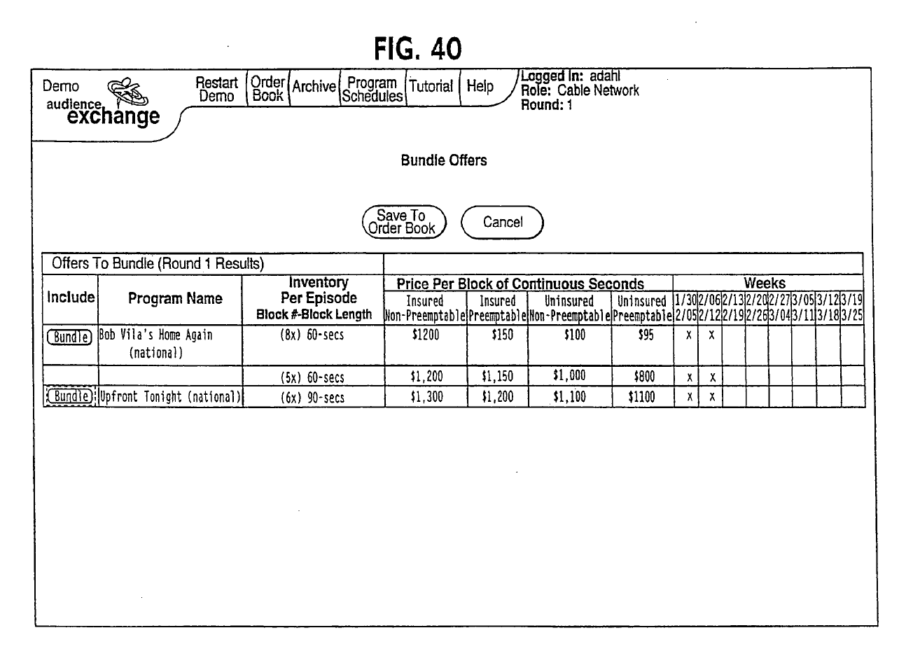

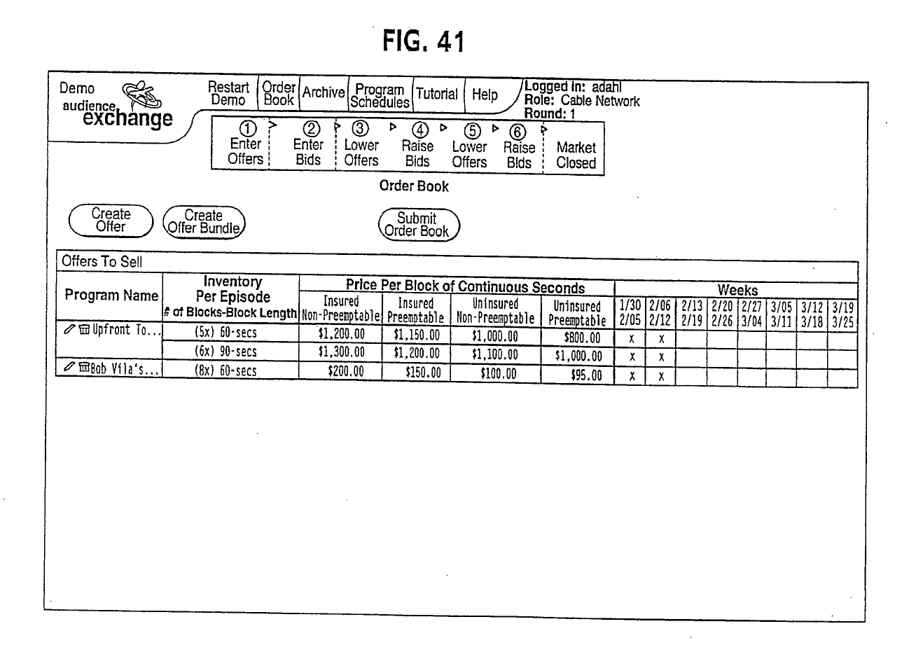

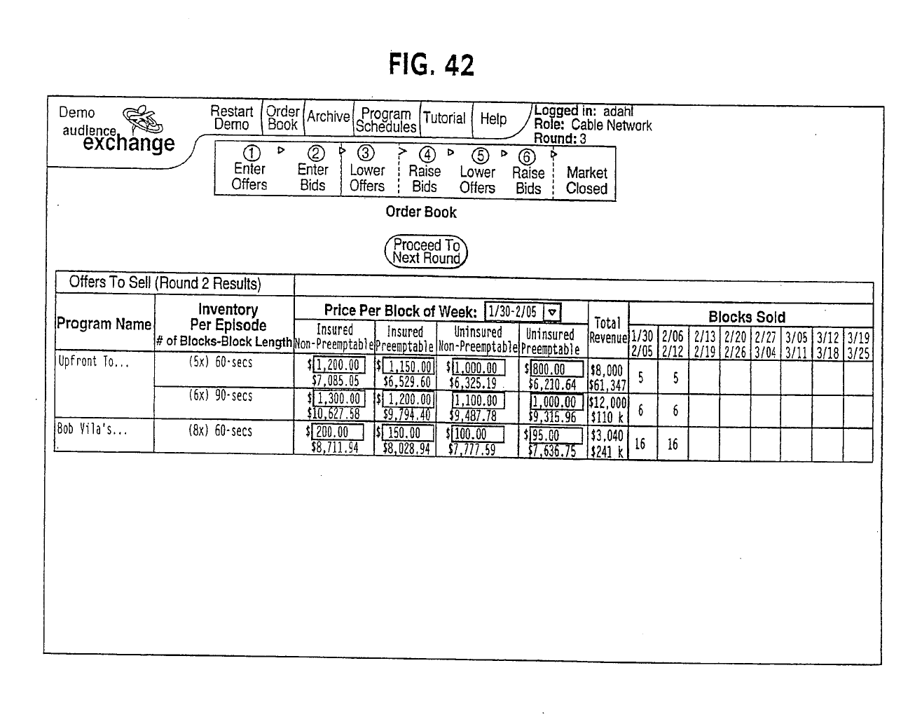

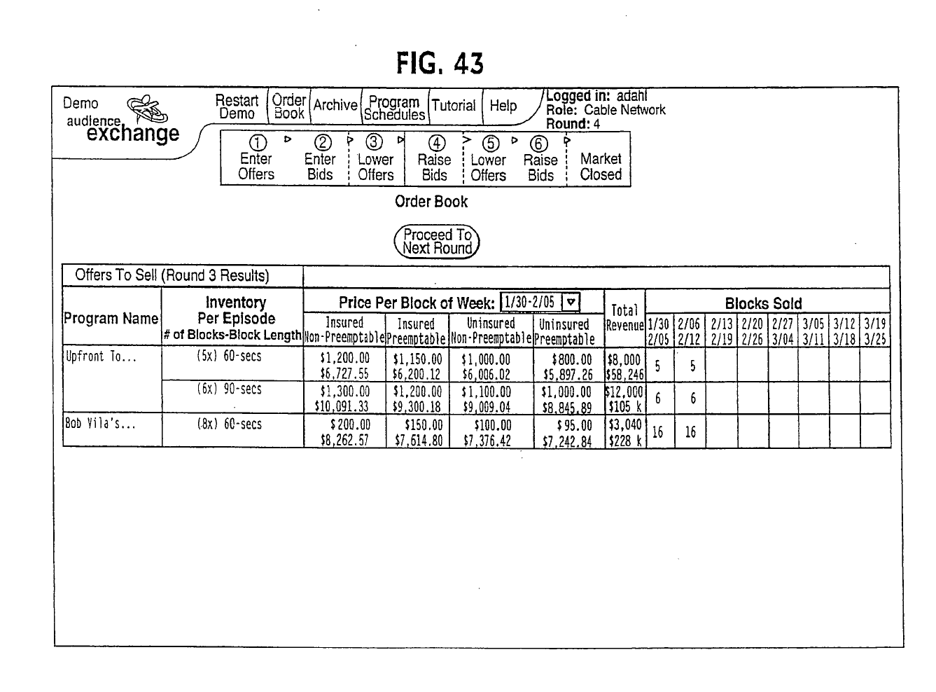

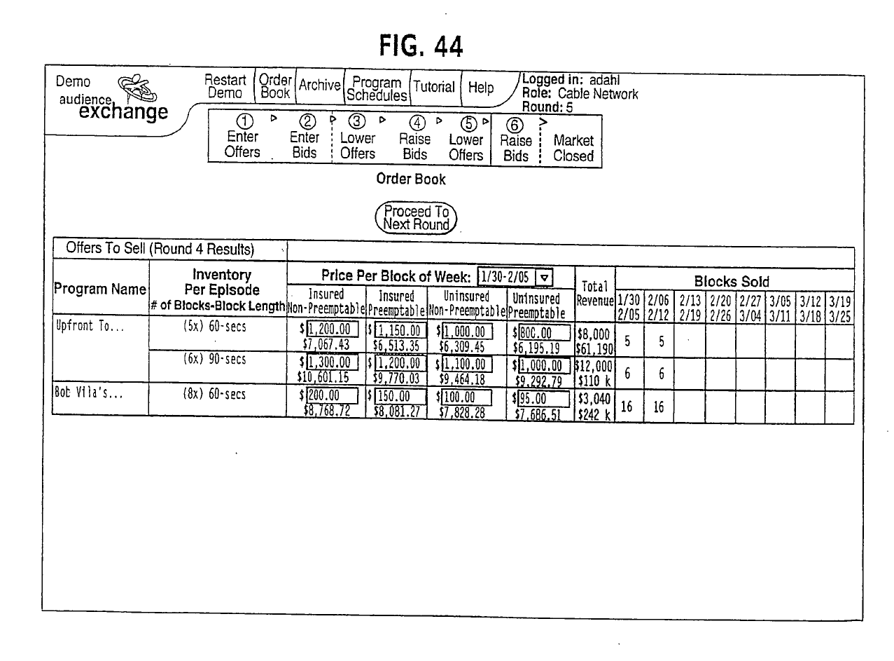

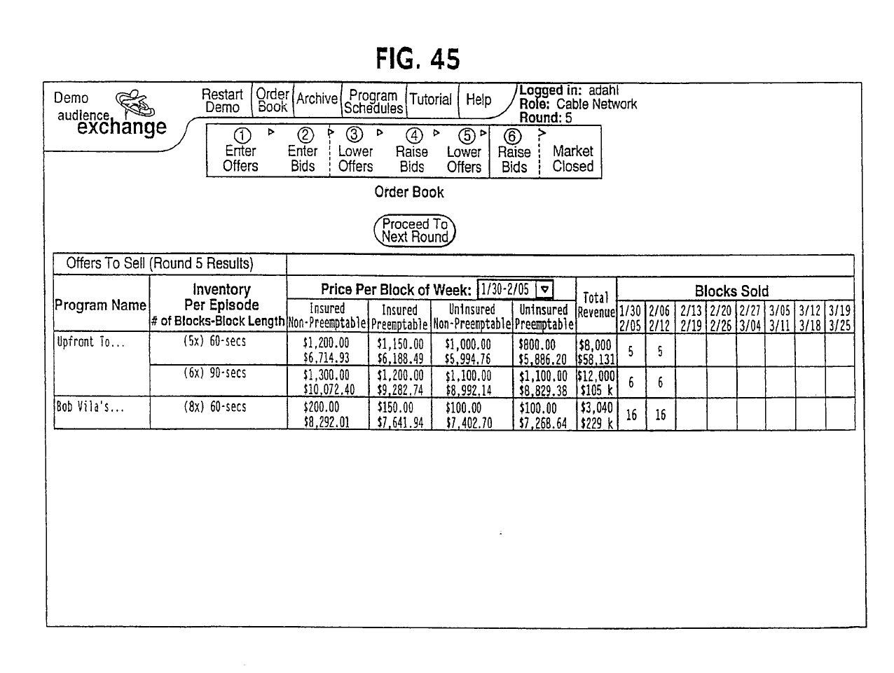

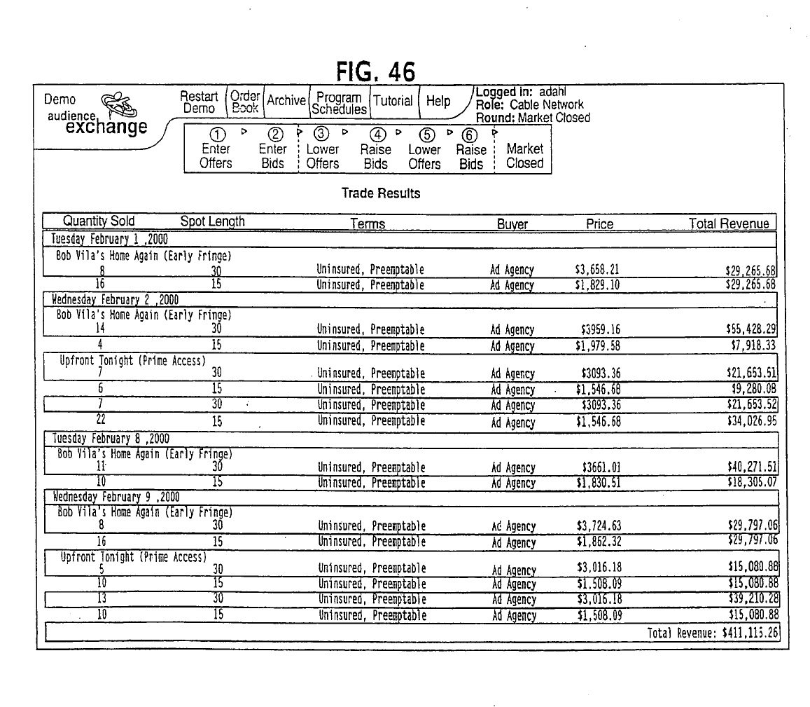

FIG. 38 discloses a screen shot that presents one sell order. FIG. 39 discloses a screen shot that presents two sell orders. Employing the screen disclosed in FIG. 40, a seller has the opportunity to identify the set of avails from different programs that are bundled together for sale. FIG. 41 discloses a screen shot that presents two programs that are bundled together for sale. FIG. 42 discloses a screen shot that displays the inter-round results information the seller receives following Round #2 and provides the seller the opportunity to lower its offer prices. FIG. 43 discloses a screen shot that displays the inter-round results the seller receives following Round #3. FIG. 44 discloses a screen shot that displays the inter-round results the seller receives following Round #4 and provides the seller the opportunity to lower its offer prices. FIG. 45 discloses a screen shot that displays the inter-round results the seller receives following Round #5. FIG. 46 discloses a screen shot that displays the seller's completed trades.

The present invention offers an important improvement to prior automated exchanges, including that presented in the '785 application. Like the '785 application, the present invention employs a “smart” electronic double auction (“SEDA”) for the assignment of audience items and involves the submission of single item and multi-item bids and offers (i.e., sell and buyer orders) and a set of logical constraints to a centralized trading platform and a set of specialized mathematical algorithms that determine the efficient assignment of audience items based upon those submitted bids and offers and logical constraints, and the calculation of a set of prices that is consistent with the efficient assignment of such items. In particular, each sell order is a single item or multiple-item offer that identifies a block of advertising time, to be assigned to buyers in the form of one or more advertising spots, on various programs in various geographic areas that the seller has the right to sell. Buyers (i.e., advertisers or their agents) submit to the automated exchange “buy orders” that reflect their complex preferences. Each buy order is a single or multiple-item bid that identifies the “type” of viewers (e.g., Males, Ages 18-49) that the buyer wishes to access, the geographic areas in which they wish to access those viewers, a set of logical constraints that assist in defining their buy order, and certain bank account information that permits an authorized third-party to transfer funds from the buyer's bank account in the event that he is assigned any advertising spots.

The SEDA of the automated exchange can be constructed as either a non-iterative, sealed-bid auction or an iterative auction. In the sealed bid version, buyers and sellers only have a single opportunity to submit buy and sell orders into the electronic exchange and no opportunity to modify them following their submission. In the iterative version, buyers and sellers have one or more opportunities to modify a previously submitted buy or sell order. Therefore, the only significant difference between the sealed bid and iterative versions of the two auctions is the number of opportunities buyers and sellers have to modify their buy and sell orders. Focusing on the iterative version, in Round #1 sellers “move” first by creating and submitting sell orders that identify the time interval for which the order holds, and the day, day-part, program, and geographic location of each block of advertising time they wish to offer for sale. Sellers also provide an estimate of the expected number of the various types of viewers that will be accessed during each block of advertising time. In addition, sellers identify the number of blocks of advertising time they wish to sell, as well as the length, measured in terms of continuous seconds, of such blocks. Finally, sellers also identify an “offer price,” defined as the minimum payment the sellers require in order to sell a block of continuous seconds of advertising time.

However, in sharp contrast to the '785 application, with the present invention sellers are able to assign a unique offer price, expressed on either a block or a cost per thousand basis (i.e., CPM), to each demographic category (e.g., Males 18-49, Females 50-64) across the four different bases upon which audience items are typically sold (i.e., preemptable, insured; preemptable, uninsured; non-preemptable, insured; and non-preemptable, uninsured basis). Absent this capability, the SEDA for the assignment of audience items under the '785 application is not able to satisfy the real world complex needs of buyers and sellers of audience items. In particular, absent the improved technology of the present invention, the SEDA for the assignment of audience items under the '785 application will typically generate a set of price signals that fail to accurately reflect the market's willingness to trade audience items on a particular basis. This distortion in price signals can prevent the efficient assignment of audience items across buyers and sellers as well as prevent the efficient assignment of rights across buyers and sellers.

In Round #2, buyers “move” second by creating and submitting buy orders that identify the time interval for which their orders hold, the “type” of viewers they wish to access defined in terms of demographics (e.g., sex, age), the geographic, day and day-part location of such access, and the set of programs from which access to viewers can be provided. In addition, buyers indicate the length of the advertising spots (in continuous seconds) they wish to be assigned. Before buyers submit their buy orders in Round #2, the automated exchange evaluates the internal consistency of each buy order and whether there are one or more sell orders that can fill a buy order. This reduces the probability that a buy order may be rejected because no seller has offered access to the desired viewers. Finally, buyers identify a “bid price,” defined as the maximum amount of money each is willing to pay, expressed on a cost per thousand (CPM) viewers basis, for access to their desired viewers (e.g., targeted demographic). Within a given buy order, the buyers have the opportunity to establish one or more bid prices, each of which corresponds to a different basis upon which its desired viewers can be acquired (e.g., Insured, Preemptable). Each bid price represents the maximum amount of money the buyer is willing to pay for advertising time based upon the specified set of bases upon which the viewers can be acquired (e.g., Insured, Preemptable). To encourage buyers to truthfully reveal their willingness to trade, bid price information is never revealed to sellers.

Following Rounds #1 and #2, based upon the submitted sell and buy orders of the first two rounds, a specially tailored mathematical algorithm identifies the set of trades that optimizes the gains from trade, and a second specially tailored algorithm generates a set of prices that, as nearly as possible, discriminates perfectly between accepted and rejected bids and offers. The phrase “optimizes the gains from trade” refers to a process that, constrained by certain technical factors such as algorithm processing time and the quality of the hardware and software employed in executing the numerical computations required by the algorithms, attempts to discover the optimum benefits that can be shared between buyers and sellers as revealed in the bids and offers they have submitted. As discussed below, in a preferred embodiment for the trading of audience items related to broadcast television advertising, the optimization process attempts to maximize the revealed gains from trade shared by buyers and sellers. Based upon such numerical computations, sellers receive under the preferred embodiment of the current invention current market price information, expressed either on a block or a CPM basis, for the avails they wish to sell. If one or more avails are tentatively sold, these prices are based upon the demographic (e.g., Males, 18-49) the provisional buyer has identified as his targeted demographic. In addition, sellers receive such price information across the set of bases upon which its avails can be sold. If sellers have tentatively sold one or more avails, it will receive information regarding the number of blocks of continuous seconds they have tentatively sold and the bases (e.g., Uninsured, Preemptable) upon which such blocks have tentatively sold. Similarly, buyers receive information regarding whether they have tentatively acquired access to viewers and, if so, the bases under which such access is tentatively acquired, the tentative price of such access, expressed on a CPM basis given their revealed targeted demographic, and the tentative prices for access to such viewers under different sets of bases.

Following receiving this information, participants are then permitted to modify their buy and sell orders in one or more subsequent rounds. In Rounds #3 and #5 buyers are inactive and sellers can only lower their offer prices, while in Rounds #4 and #6 sellers are inactive and buyers can only raise their bid prices. No other modifications of the buy and sell orders are permitted. All buy and sell orders that have not been modified are automatically entered “as is” into the next round. Modified buy and sell orders that are entered into the next round replace the previously submitted buy and sell orders. The calculated total gains from trade can only increase in each subsequent round as modified buy and sell orders provide increasingly beneficial terms for trade. The SEDA of the automated exchange ends after Round #4 if there are no tentative trades immediately following Round #2; otherwise, it ends after Round #6. After each round of modifications a new tentative assignment is computed. When the SEDA ends, the tentative assignment becomes final and all trades are executed accordingly by the automated exchange.

In a specific preferred embodiment discussed below, the automated exchange of the present invention is employed to facilitate the trading of audience items in the form of access to television viewers that are attracted to the television programs shown by cable television networks and carried by cable operators and offered for sale by such networks and operators. However, the automated exchange of the present invention may be applied to the trading of audience items in any media environment that attracts viewers, listeners, or readers. To this end, the automated exchange of the present invention may be used by participants to trade other types of audiences items, including access to broadcast television viewers, and/or direct broadcast satellite viewers, and/or radio listeners and/or movie theater viewers, and/or magazine and newspaper readers, and/or billboard viewers; and/or viewers of electronically displayed files over a computer network (e.g., Internet); by the airing, printing, or displaying of messages, as provided by or assigned to advertisers, program syndicators, program producers, broadcast television stations, radio stations, television networks, radio networks, basic cable networks, pay cable channels, cable operators, direct broadcast satellite providers, movie theatre owners, magazine and newspaper publishers, billboard owners or the appointed agents (e.g., advertising agencies, intermediaries) of any one of these users. For simplicity when referring to audience items hereafter, audience items will be referred to as blocks of advertising time (or their subdivision into advertising or commercial spots), or access to viewers.

Like the auction process under the '785 application, the automated exchange of the present invention determines, using one or more mathematical algorithms, the assignment of audience items from buyers to sellers and a set of transaction prices for the assignments of such audience items. A “transaction” price is a price that equates or attempts to equate the demand and supply for the item up for sale. Like the auction process under the '785 application, transaction prices are calculated in a manner that attempts to establish a uniform price to all buyers that acquire audience items in the same supply unit (e.g., same block of continuous seconds of advertising time) offered for sale and that wish to acquire the same demographic. The present invention represents a significant improvement in that the SEDA for the assignment of audience items in the '785 application generates a set of price signals that fail to properly reflect the market's willingness to trade audience items on a particular basis. This distortion in price signals can prevent the efficient assignment of audience items across buyers and sellers as well as prevent the efficient assignment of rights across buyers and sellers. This point can be demonstrated through proof by example, where the proof is shown by comparing the results of the preferred embodiment of this invention with the results of the preferred embodiment of the auction process under the '785 application.

Under the current sequential, bilateral trading process, buyers and sellers assign certain “rights” to each other. For example, buyers and sellers must choose between trading advertising time on an “insured” (or “guaranteed”) versus “uninsured” (or “non-guaranteed”) basis. If the premium the buyer is willing to pay the seller to guarantee that a minimum amount of impressions will be delivered by the program is greater than the premium the seller demands to provide that guarantee, then the advertising time is sold on an “insured” basis. Buyers and sellers must also choose whether to trade advertising time such that the seller can preempt (i.e., call back) the advertising time that was previously sold to the buyer. Therefore, a buyer and a seller have four different ways in which they can trade advertising time. If a single buyer negotiated with only eight sellers, it could acquire its impressions in 32 different ways, assuming that the buyer acquires all of its audience items from a single seller.

The auction method proposed in the '785 application attempted to improve on this assignment of rights across buyers and sellers by calculating and sending to market participants better price signals regarding the value “the market” (i.e., buyers and sellers) places on these rights. Better price signals would allow buyers and sellers to better compare the relative benefits and costs associated with selling/buying certain rights (i.e., preemptability, guaranty). However, the auction method proposed in the '785 application limits the degree to which sellers can express their willingness to sell certain rights and, in so doing, distorts the willingness to sell information the market receives from sellers. Importantly, this restriction on expressiveness distorts the price signals buyers and sellers receive when they compare the relative benefits and costs associated with selling/buying certain rights. This distortion in market prices may, in many instances, cause the audience item to be traded not only on the wrong basis (e.g., uninsured, preemptable versus uninsured, non-preemptable), but may also cause a mis-assignment of the audience item itself.

Importantly, if a simple example can be used to demonstrate an important problem, the same important problem can be easily shown to exist in a more complex setting. For purposes of simplicity, the example focuses on the allocation between the buyer and the seller of the buyer's right to demand that the seller compensate it if the program exhibited by the seller delivers fewer viewers within a targeted demographic category than expected by both the buyer and the seller at the time at which they conduct a trade. In the vernacular of industry participants, this “right” acquired by the buyer from the seller refers to the seller's obligation to “insure” that the program will deliver that agreed to minimum number of viewers within a given demographic category. If the program fails to deliver that minimum number of viewers, under this right the seller is obligated to compensate the buyer for the under-delivery of the targeted demographic through a financial payment or by providing the buyer additional ad time for free.

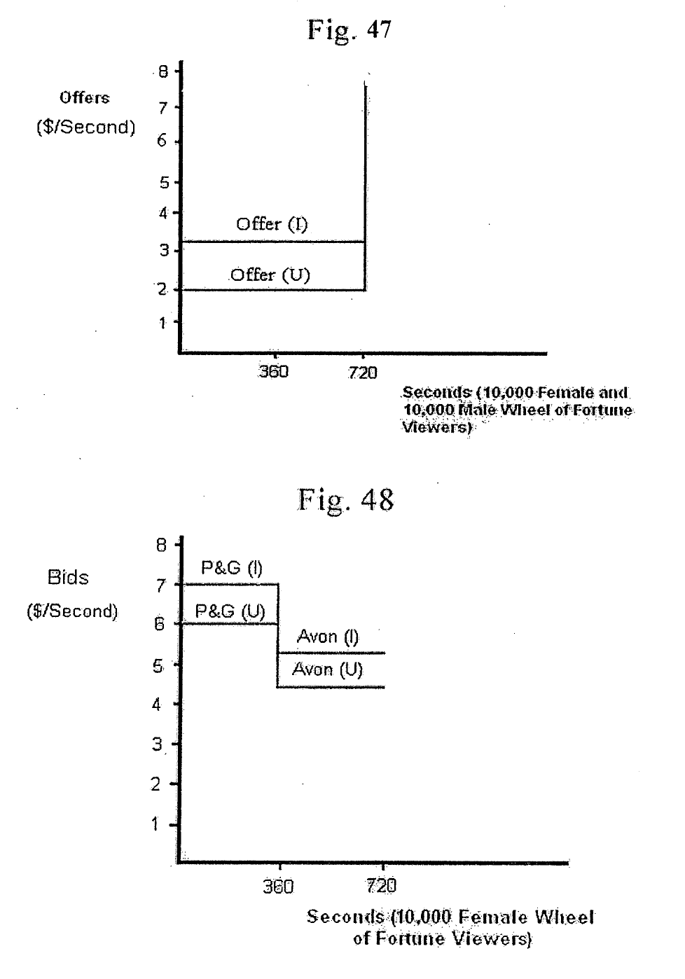

Suppose the ABC local affiliate in a local television market broadcasts “Wheel of Fortune” and that this program is expected to attract 10,000 Male and 10,000 Female viewers each time the program is exhibited by the ABC local affiliate. Suppose, further, that four different advertisers desire the viewers attracted (e.g., “delivered”) by the “Wheel of Fortune” program. Finally, suppose two advertisers, Procter and Gamble (P&G) and Avon, place a positive value on accessing the Female viewers, while Intel and IBM place a positive value on accessing the Male viewers. The auction method proposed in the '785 application requests that the seller submit a set of ask prices. An ask price represents the minimum payment the seller demands in order to sell an audience item (e.g., avail). In particular, the auction method proposed in the '785 application requests that the seller submit four different ask prices—one for each basis upon which its attracted sellers may be sold. For purposes of the example, and without loss of generality, suppose the ABC local affiliate is simply requested to provide two different ask prices—one ask price reflects the minimum payment the seller requests for selling its attracted viewers on an insured basis, while the other one reflects the minimum payment the seller requests for selling its attracted viewers on an uninsured basis. FIG. 47 illustrates a hypothetical set of such ask prices.

Given the units in which the x and y-axes are defined, the ABC local affiliate is offering to sell 720 seconds of advertising time that is estimated to attract, on a per episode basis, 10,000 Female viewers and 10,000 Male viewers. Moreover, the affiliate demands, independent of the length of the spot desired by the buyer, $2.00/second if it sells access to such viewers on an uninsured basis (“U”), and $3.25/second if it sells access to such viewers on an insured basis (“I”). The difference between the $3.25/second ask price and the $2.00/second ask price represents the premium the seller demands for guaranteeing that the program will attract both 10,000 Female and 10,000 Male viewers. Importantly, the buyer of ad time obtains access to both demographics simultaneously, despite placing a positive value for only one of those demographics.

Under the auction method proposed in the '785 application, the seller is uncertain about whether the eventual buyer of the ad time will acquire it based on the number of Males attracted to the program or the number of Females attracted to the program. This uncertainty, herein referred to as “buyer demographic uncertainty,” is not crucial (i.e., fails to create risk for the seller) if the seller is unwilling to sell its attracted viewers on an insured basis. However, in practice, buyers and sellers often find it mutually beneficial to trade the buyer's targeted demographic on an insured basis. Under these circumstances, the buyer demographic uncertainty sellers face is crucial because it creates an important risk for the seller. This risk stems from the fact that the risk that sellers face regarding under-delivery of a given demographic varies across demographics. Under the auction method proposed in the '785 application, sellers must respond to buyer demographic uncertainty by calculating an “average” premium that compensates it for having to guarantee the delivery of all the different demographics attracted to that program. In the current example, the average premium should reflect the ABC local affiliate's estimates of the probabilities that “Wheel of Fortune” will under-deliver on Male and Female viewers, the expected size of that under-delivery, and the probability that a buyer will acquire one or more avails based upon is desire to access Males or Females. Suppose the insured (I) ask price shown in the above figure reflects that complex calculation.

In order for a trade to occur, the market requires buyers. FIG. 48 illustrates a set of hypothetical bids submitted by P&G and Avon for access to the 10,000 Females attracted to one episode of the “Wheel of Fortune.” Given the units in which the x and y-axes are defined, P&G and Avon are willing to pay $7.00/second and $5.50/second, respectively, to acquire 360 seconds of access to 10,000 Female viewers on an insured basis (“I”). Moreover, these same buyers are willing to pay $6.00/second and $4.50/second, respectively, to acquire 360 seconds of access to 10,000 Female viewers on an uninsured basis (“U”). The difference between the “I” bid and the “U” bid represents the premium each buyer is willing to pay the ABC local affiliate in order to obtain the audience item on an insured basis.

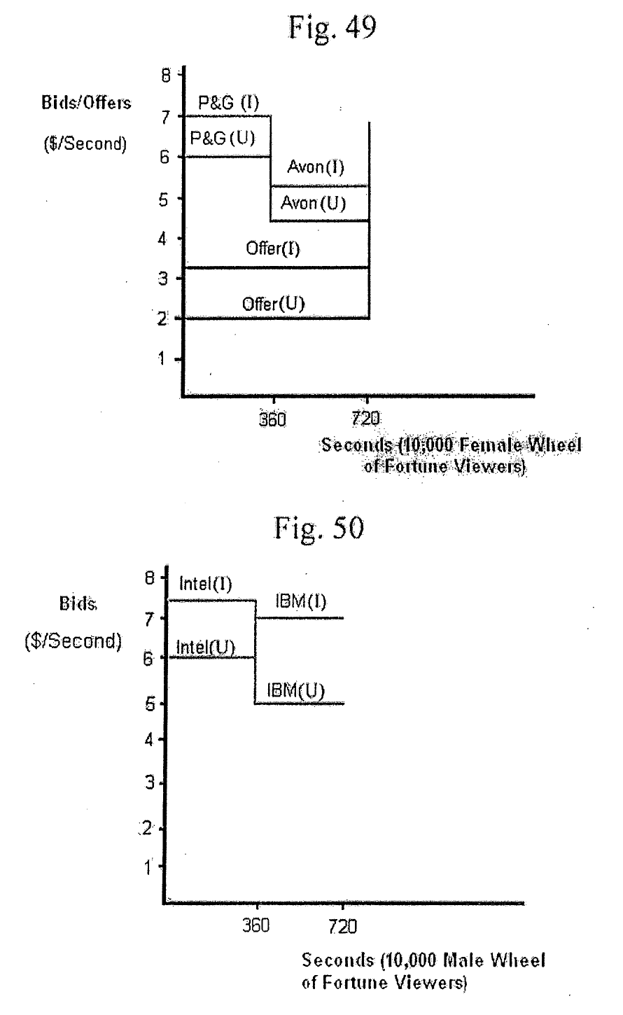

FIG. 49 combines the set of hypothetical asks submitted by the ABC local affiliate for the sale of, on both an insured and uninsured basis, 10,000 Female and 10,000 Male viewers the market expects to be attracted to a single episode of its “Wheel of Fortune” program and the set of hypothetical bids submitted by, P&G and Avon. Given that P&G and Avon only wish to acquire access to Female viewers, the x-axis is defined solely in terms of Female viewers.

If “Wheel of Fortune” only attracted Female viewers, identifying the efficient assignment of avails and the basis upon which those avails should be traded would be straightforward. In this instance, given that all bid prices exceed all ask prices, buyers and sellers trade ad time. However, given that the premium demanded by the ABC local affiliate for guaranteeing the attracted viewers, measured by the area created between the Offer (I) and Offer (U) lines, exceeds the premiums P&G and Avon wish to pay the seller for compensating them for guaranteeing the number of delivered Female viewers, both spots are sold on an uninsured basis. However, in our simple example, the “Wheel of Fortune” also attracts Male viewers.

FIG. 50 illustrates a hypothetical set of bids submitted by Intel and IBM for access to the 10,000 Male viewers attracted to one episode of the “Wheel of Fortune.” Given the units in which the x and y-axes are defined, Intel and IBM are willing to pay $7.50/second and $7.00/second, respectively, to acquire 360 seconds of access to 10,000 Male viewers on an insured basis (“I”). Moreover, these same buyers are willing to pay $6.00/second and $5.00/second, respectively, to acquire 360 seconds of access to 10,000 Male viewers on an uninsured basis (“U”). As before, the difference between the “I” bid and the “U” bids represent the premium each buyer is willing to pay in order to obtain the audience item on an insured basis.

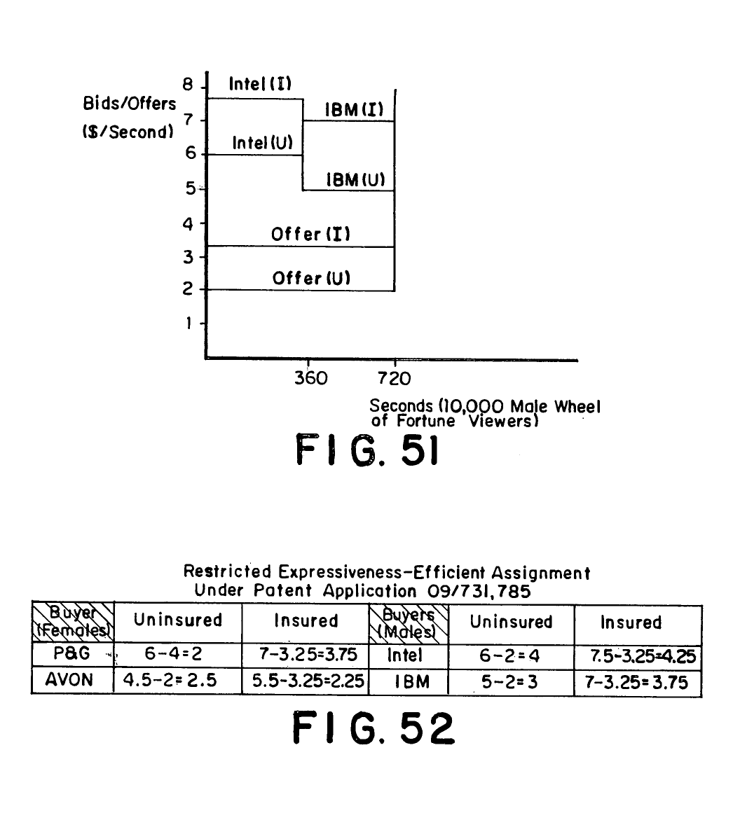

FIG. 51 combines the set of hypothetical asks submitted by the ABC local affiliate for the sale of, on both an insured and uninsured basis, 10,000 Female and 10,000 Male viewers the market expects to be attracted to a single episode of its “Wheel of Fortune” program and the set of hypothetical bids submitted by Intel and IBM. Given that Intel and IBM only wish to acquire access to Male viewers, the x-axis is defined solely in terms of Male viewers.

According to the auction method proposed in the '785 application, the identification of the efficient assignment of audience items (e.g., attracted viewers) and the proper assignment of right(s) among buyers and sellers involves identifying the set of trades among the buyers and sellers that maximizes the gains of trade. FIG. 52 presents the gains of trade generated from hypothetical trades between the ABC local affiliate and between P&G, Avon, Intel, and IBM on both an insured and uninsured basis for the 10,000 Female and 10,000 Male viewers attracted to a single episode of “Wheel of Fortune.”

According to FIG. 52, the efficient assignment of audience items and the right that defines that item across buyers and sellers involves assigning P&G ad time on an uninsured basis and assigning Intel ad time on an insured basis. Importantly, the above assignment is the efficient assignment subject to the constraint that the ABC local affiliate is not free to express and submit to the exchange a unique offer price for each demographic delivered by the program. As will be shown in the following section, the existence of such a constraint can prevent the efficient assignment of audience items, as well as the efficient assignment of rights across buyers and sellers. The invention contained in the present application removes this troublesome constraint on seller expressiveness contained in the '785 application and, therefore, substantially enhances the likelihood of an efficient assignment of audience items, as well as the rights that define those items. By eliminating the distortion in the information received by market participants regarding the price associated with trading audience items on different bases, the removal of this constraint on seller expressiveness represents an important improvement to the auction method proposed in the '785 application.

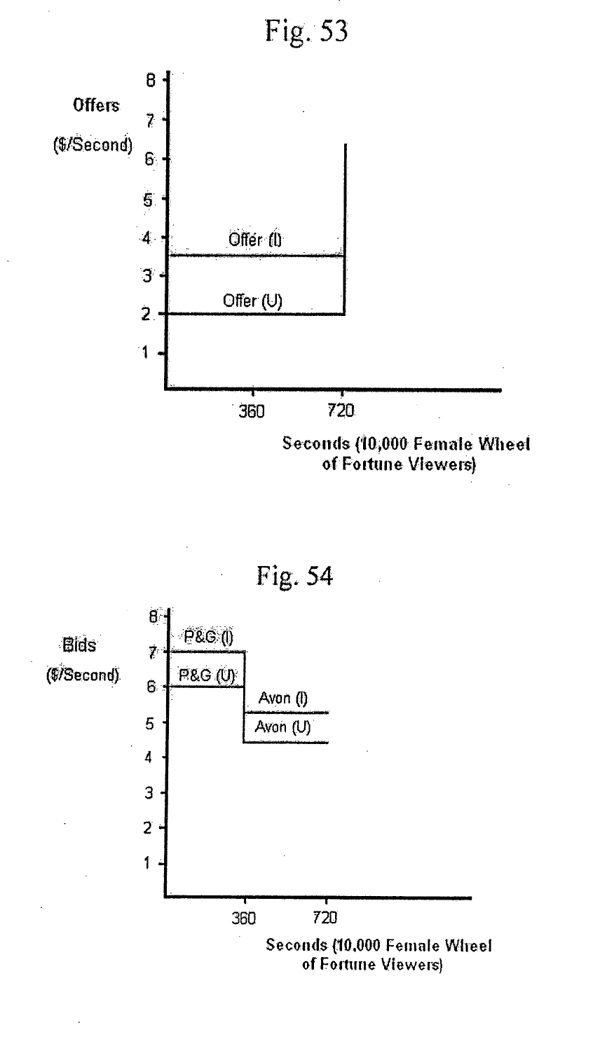

With the present invention, broadcast television stations or their agents submit offers to sell into the exchange. Based upon the cost it incurs from exhibiting a single episode of the “Wheel of Fortune” program, as well as the expected willingness of advertisers to pay for access to the viewers attracted to this program, the ABC local affiliate may submit the offers, expressed on a $/second basis for illustration purposes, to sell shown in FIG. 53. The length of each horizontal line represents the total number of continuous seconds the ABC local affiliate wishes to sell, expressed as a block length. The upper line represents the minimum payment the ABC local affiliate demands in exchange for selling, on an insured basis, the estimated 10,000 Female viewers attracted to “Wheel of Fortune,” while the lower line represents the minimum payment the ABC local affiliate demands in exchange for selling, on an uninsured basis, the estimated 10,000 Female viewers attracted to “Wheel of Fortune. According to FIG. 53, the affiliate demands, independent of the length of the spot desired by the buyer, $2.00/second if it sells access to such viewers on an uninsured basis (“U”), and $3.50/second if it sells access to such viewers on an insured basis (“I”). The difference between the $3.50/second ask price and the $2.00/second ask price represents the premium the seller demands for guaranteeing that the program will attract 10,000 Female. In contrast to the automated exchange under '785 application, the automated exchange of the present invention allows a seller to express and submit to the exchange a unique ask price for each demographic category across the complete set of bases upon which viewers may be traded.

Like the automated exchange in the '785 application, advertisers or their agents submit bids into the exchange. Each bid is based upon the revenue the advertiser expects to earn from obtaining access to its target viewers, and may also be based on the expected bids of their competitors. As in the automated exchange in the '785 application, upon receiving the respective bids, an algorithm within a central computer would, based upon this simple example, arrange the bids in descending order to form a “bid array.” FIG. 54 lists a collection of hypothetical bids—expressed in $/second—a set of advertisers (e.g., P&G, Avon) are willing to pay for access to the 10,000 Female viewers that are attracted to a single episode of the “Wheel of Fortune” both on an insured and uninsured basis. The differences in the bids placed across buyers result from the fact that advertisers may place different values on access to the same target audience or demographic. The length of each horizontal section or “step” corresponds to the number of commercial seconds the advertiser wishes to acquire. Given the units in which the x and y-axes are defined, P&G and Avon are willing to pay $7.00/second and $5.50/second, respectively, to acquire 360 seconds of access to 10,000 Female viewers on an insured basis (“I”). Moreover, these same buyers are willing to pay $6.00/second and $4.50/second, respectively, to acquire 360 seconds of access to 10,000 Female viewers on an uninsured basis (“U”). The difference between the “I” bid and the “U” bid represents the premium each buyer is willing to pay in order to obtain the audience item on an insured basis.

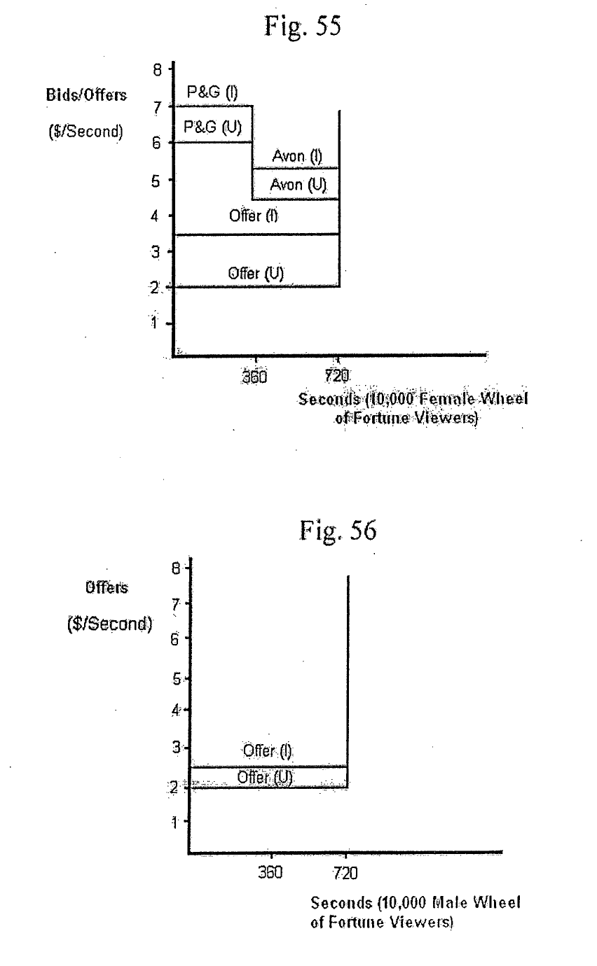

FIG. 55 combines the set of hypothetical asks submitted by the ABC local affiliate for the sale of, on both an insured and uninsured basis, the estimated 10,000 Female viewers attracted to a single episode of its “Wheel of Fortune” program and the set of hypothetical bids submitted by, P&G and Avon. If “Wheel of Fortune” only attracted Female viewers, identifying the efficient assignment of avails and the basis upon which those avails should be traded, as well as the transaction prices at which such avails should trade, would be straightforward. However, in our simple example, as well as in actuality, “Wheel of Fortune” also attracts Male viewers. Importantly, in sharp contrast to the automated exchange in the '785 application, the automated exchange under this invention allows a seller to submit a unique ask price for each demographic category across the complete set of bases upon which viewers may be traded.

FIG. 56 illustrates a hypothetical set of asks submitted by the ABC local affiliate. The upper line represents the minimum payment the ABC local affiliate demands in exchange for selling the estimated 10,000 Male viewers on an insured basis, while the lower represents the minimum payment the ABC local affiliate demands in exchange for selling the estimated 10,000 Males viewers on an uninsured basis. According to FIG. 56, the affiliate demands, independent of the length of the spot desired by the buyer, $2.00/second if it sells access to such viewers on an uninsured basis (“U”), and $2.50/second if it sells access to such viewers on an insured basis (“I”). The difference between the $2.50/second ask price and the $2.00/second ask price represents the premium the seller demands for guaranteeing that the program will attract 10,000 Male viewers.

The reader will notice that the ABC local affiliate demands a higher premium for guaranteeing the delivery of 10,000 Female viewers than 10,000 Male viewers. The difference in the seller's willingness to guarantee one demographic (e.g., Males) versus another demographic (e.g., Females) reflects the fact that different demographics may have different program viewing substitution possibilities. The greater the viewing substitution possibilities for a given demographic and the greater the changes in those substitution possibilities, the greater the uncertainty regarding the quantity of the demographic that will be delivered by a given program.

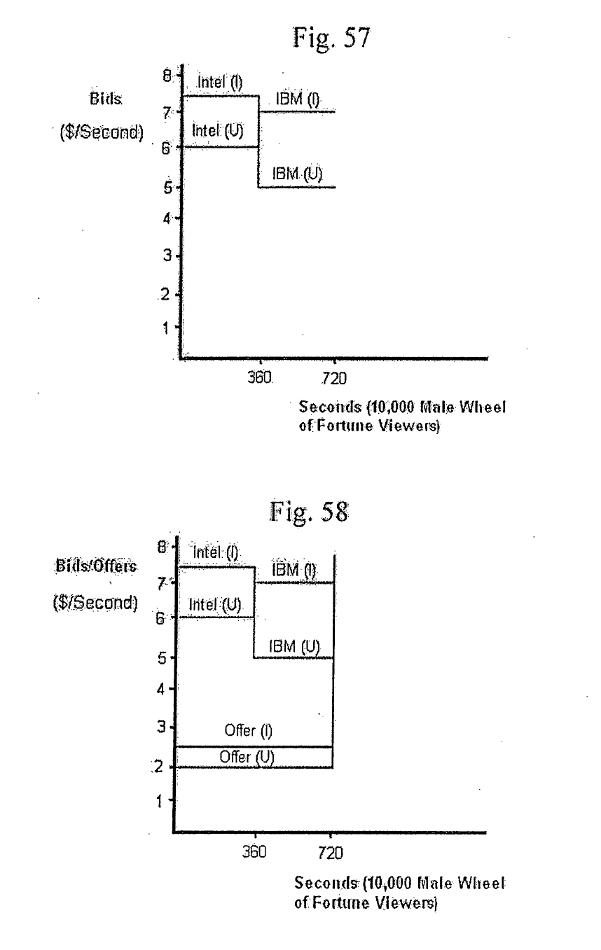

FIG. 57 lists a collection of hypothetical bids—expressed in $/second—a set of advertisers (e.g., Intel, IBM) are willing to pay for access to the 10,000 Male viewers that are attracted to a single episode of the “Wheel of Fortune” both on an insured and uninsured basis. The differences in the bids placed across buyers result from the fact that advertisers may place different values on access to the same target audience or demographic. The length of each horizontal section or “step” corresponds to the number of commercial seconds the advertiser wishes to acquire. Given the units in which the x and y-axes are defined, Intel and IBM are willing to pay $7.50/second and $7.00/second, respectively, to acquire 360 seconds of access to 10,000 Male viewers on an insured basis (“I”). Moreover, these same buyers are willing to pay $6.00/second and $5.00/second, respectively, to acquire 360 seconds of access to 10,000 Male viewers on an uninsured basis (“U”). The difference between the “I” bid and the “U” bid represents the premium each buyer is willing to pay the seller in order to obtain the audience item on an insured basis.

FIG. 58 combines the set of hypothetical asks submitted by the ABC local affiliate for the sale of, on both an insured and uninsured basis, the estimated 10,000 Male viewers attracted to a single episode of its “Wheel of Fortune” program and the set of hypothetical bids submitted by Intel and IBM. If “Wheel of Fortune” only attracted Male viewers, identifying the efficient assignment of avails and the basis upon which those avails should be traded, as well as the transaction prices at which such avails should trade would be straightforward. To promote the efficient assignment of viewers, the preferred embodiment of the present invention compares the revealed gains from trade involving the different target audiences and the different bases upon which they can trade and selects the assignment of viewers to buyers and bases that generates the largest economic surplus.

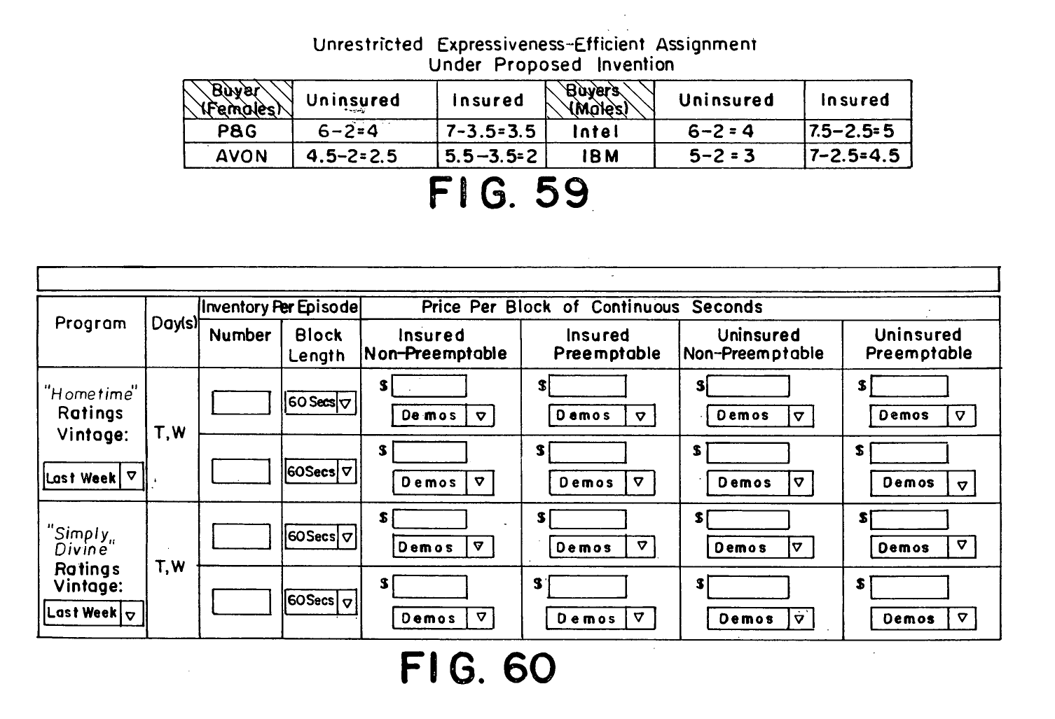

FIG. 59 illustrates the efficient assignment of viewers and bases upon which viewers are traded under the current invention which allows the seller (e.g., ABC local affiliate) to establish a unique ask price for each demographic across the different bases upon which viewers can be traded. According to FIG. 59, the efficient allocation involves assigning 360 seconds of ad time to both Intel and IBM on an insured basis. The total generated surplus from this assignment, as measured by the revealed bids and asks, is $9.50/second (i.e., $5/second+$4.5/second=$9.5/second).

As described earlier, FIG. 52 illustrates the efficient assignment of viewers and bases upon which viewers are traded under the auction process under the '785 application under which sellers are unable to establish a unique ask price for each demographic across the different bases upon which viewers can be traded. According to FIG. 52, in the '785 application the efficient allocation involves assigning 360 seconds of ad time to Intel on an insured basis and to P&G on an uninsured basis. Importantly, the total generated surplus from this assignment, as measured by the revealed bids and asks, is $8.25/second (i.e., $4/second+$4.25/second=$8.25/second). A comparison of this surplus value with the surplus value shown in FIG. 59 (i.e., $9.5/second) proves by example, that the limitation the auction process in the '785 application places on the ability of sellers to express their willingness to sell their avails on different bases based upon the different demographics attracted to a program can prevent the efficient assignment of audience items across buyers and sellers as well as prevent the efficient assignment of rights across buyers and sellers. This comparison is made valid by the fact that the bid curves for each prospective buyer remain the same across the preference restricted and preference non-restricted environments.

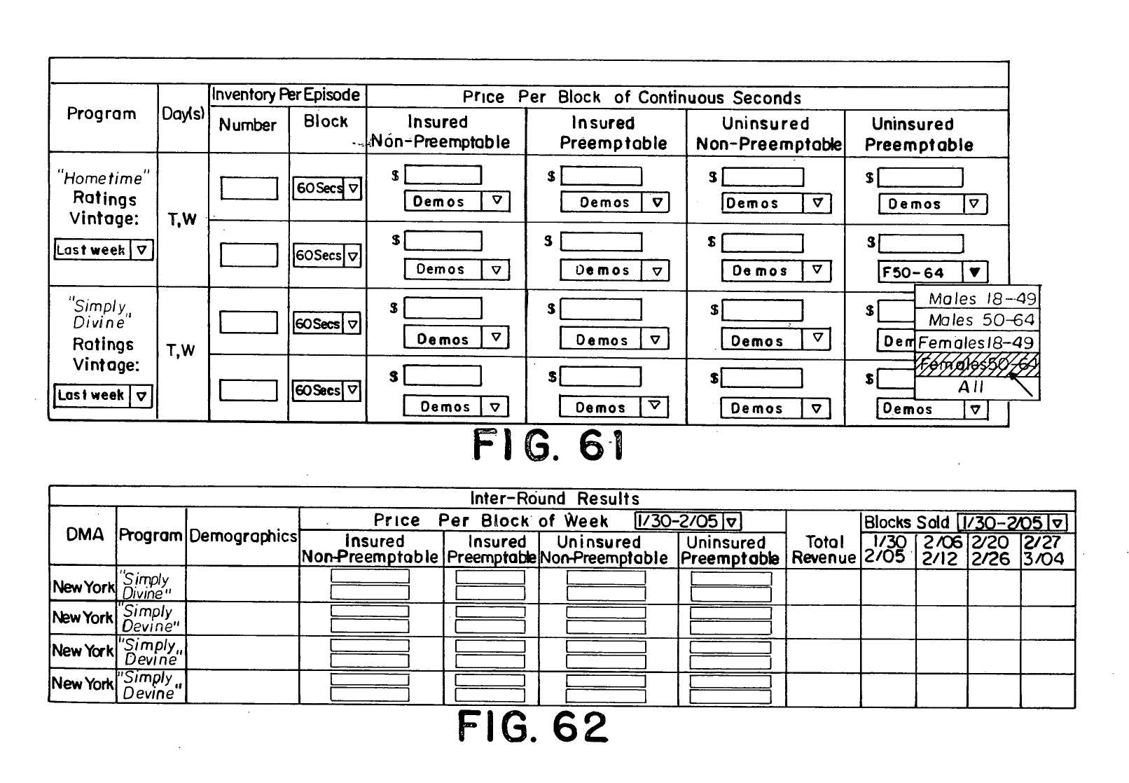

This simple example also demonstrates that the limitation the auction process in the '785 application places on the ability of sellers to express and submit to the exchange a unique ask price for each demographic category across the complete set of bases upon which viewers may be traded can also lead to the wrong bases upon which the viewer should be traded consistent with maximizing revealed gains of trade. For example, as shown in FIG. 59, when the ABC affiliate is free to express its preferences regarding ask price premiums involving selling its avails on an insured basis versus uninsured basis, both Intel and IBM acquire their spots on an insured basis. In contrast, when sellers are restricted from expressing such preference, P&G acquires its spots on an uninsured basis, while Intel acquires its spots on an insured basis. This comparison is made valid by the fact that the bid curves for each prospective buyer remain the same across the preference restricted and preference non-restricted environments. FIGS. 60-62 illustrate various screens disclosing how sellers interface with the present system to enter and submit detailed offer information across different demographics and the four different bases upon which those demographics can be traded, while also displaying important inter-round and other information. In particular, FIGS. 60-62 represent various screen shots corresponding to the electronic displayable files available to sellers or their representatives. Some screens include data fields which, when filled in by the seller, transmit data to the central trade exchange 11. Other screens provide important market information to the seller. FIG. 60 discloses a screen shot in which the seller identifies for two different programs, an estimate of the number of viewers, broken out by target audience category, attracted to a particular program, the number of blocks of continuous seconds it wishes to sell, the length of each block expressed in seconds, and the minimum amount of money it requires, expressed in terms of price per avail, in exchange for its avails. Employing the screen disclosed in FIG. 60, the seller has the opportunity to sell its avails under four different sets of flexible characteristics (i.e., preemptable, insured; preemptable, uninsured; non-preemptable, insured; and non-preemptable, uninsured basis). FIG. 61 shows how a seller, employing the screen initially disclosed in FIG. 60, has the opportunity to assign a unique offer price, expressed on a price per block basis, to each demographic category (e.g., Males 18-49, Females 50-64) across the four different bases upon which audience items are typically sold (i.e., preemptable, insured; preemptable, uninsured; non-preemptable, insured; and non-preemptable, uninsured basis).

FIG. 62 discloses a screen shot that displays the inter-round results information the seller receives following Round #2 and continues to receive until the close of the auction. This information includes the DMA, the program name, the demographic attracted to the program, the offer and market prices, the total revenue earned by the seller if the auction were to close at this point of the auction, and the number of blocks sold per week. Regarding the price information, the top number identifies the seller's offer price, while the bottom number refers to the current market price.

The present invention improves upon application '785 in other important ways. When buying audience items, buyers often wish to satisfy “reach” and “frequency” requirements. The term “reach” refers to the number of unduplicated viewers that are exposed to an advertisement, while the term “frequency” refers to the number of times the average viewer is exposed to an advertisement. When acquiring audience items, buyers often wish to access a minimum number of unduplicated viewers, while at the same time wish to ensure that the number of times an average viewer is exposed to the advertisement is, say, three times within a given period of time. Using industry terminology, a buyer that is buying time in the national spot market (TV), may wish to acquire access to Males, 18-34 years of age, in the New York and Boston DMAs, and may wish to acquire, in each DMA, a minimum of 120 “ratings points” involving that demographic (commonly referred to as targeted ratings points), with a minimum frequency of 3.0 over a period of one week. Here, a ratings point is simply the percentage of the Males, 18-34 year old population in the New York and Boston DMAs that is reached by the advertisement.

However, under the '785 application, the buyer cannot establish those exact buy parameters. Rather, the buyer must resort to crude proxies for these desired and industry accepted buy parameters. For example, in lieu of“frequency,” the '785 application requires that the buyer use “Spots per Program Schedule.” As a parameter, “Spot per Program Schedule” is equal to “frequency” only if all the viewers that watch a particular program keep on watching that program episode after episode. However, analysis of individual household viewing data clearly shows that this is not the case. Similarly, in lieu of “reach,” the '785 application requires that the buyer use “Impressions per Week” as a buy parameter. However, the term “impressions” refers to the number of viewers that see a particular advertisement, both duplicated and unduplicated. Analysis of individual household viewing data clearly shows that the simple addition of viewers across programs during a 30-miunute period fails to provide an accurate measure of reach given that viewers often migrate from one show to another show during a 30 minute period.

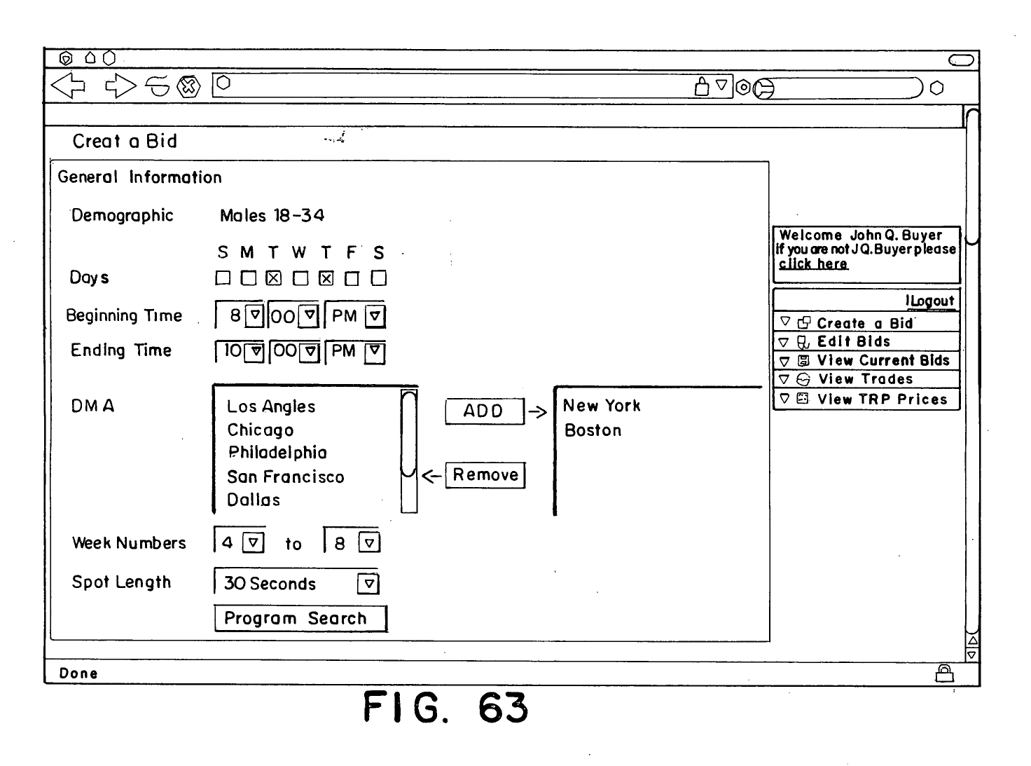

By making it impossible for the buyer to express exactly its buy preferences, the use of proxies distorts the buy information submitted to the market. In particular, it distorts information the market receives regarding what the buyers truly wish to acquire. It also distorts the information the market receives regarding the willingness of buyers to pay for the spots up for sale. Taken together, these distortions will lead to the wrong price signals and, thus, to an inefficient assignment of audience items. In addition, by increasing the likelihood that their buy order will be filled with less or undesirable spots, the use of proxies reduce the financial return buyers earn from their advertising investment. This reduction in financial return reduces the value buyers place on participating in the market. The present invention eliminates this significant impediment to an efficient and successful market by allowing buyers to employ the same buy parameters they employ in the current buying and selling process. For example, FIG. 63 discloses how buyers interface with the present system by identifying the viewer demographic they wish to “acquire,” the days on which they wish to acquire such viewers, the time of day they wish to acquire such viewers, the geographic location of the viewers, the number of weeks over which their buy program extends, and the length of their desired commercial spot. After identifying this information, buyers then activate the program search button in order to identify the set of programs that satisfy the buyers' complex buy program.

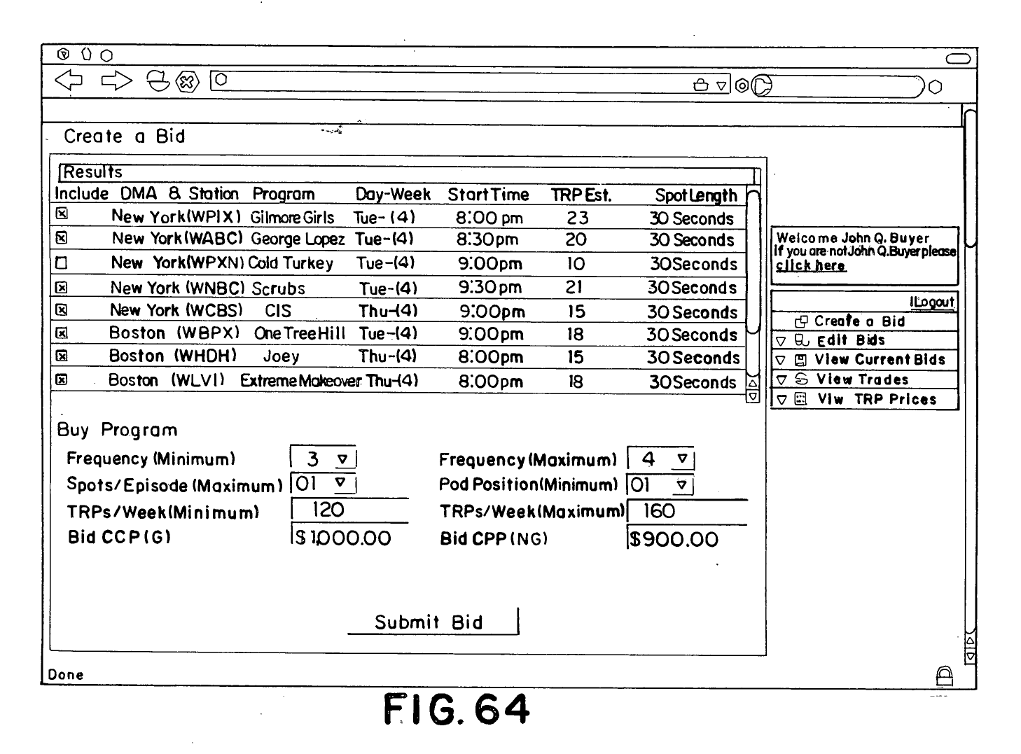

FIG. 64 discloses the set of programs that satisfy the buyers' time of day, geographic area, day of week, and week needs. As shown, buyers can select the programs they view as acceptable to fill their buy order by clicking on the box on the left-hand side of the screen next to the program list. Moreover, as shown in FIG. 64, under the automated exchange of the present invention, buyers can create a buy program that employs the commonly used buy program parameters. In particular, buyers can identify the minimum and maximum frequency the buy must have and the minimum and maximum number of targeted ratings points per week the buy must have. In addition, buyers can more precisely define its buy program by identifying the minimum and maximum number of spots per episode it wishes to acquire. After identifying its buy program and its bid prices, expressed on a cost per point basis, the buyer will then activate the Submit Bid button located at the bottom of FIG. 64.

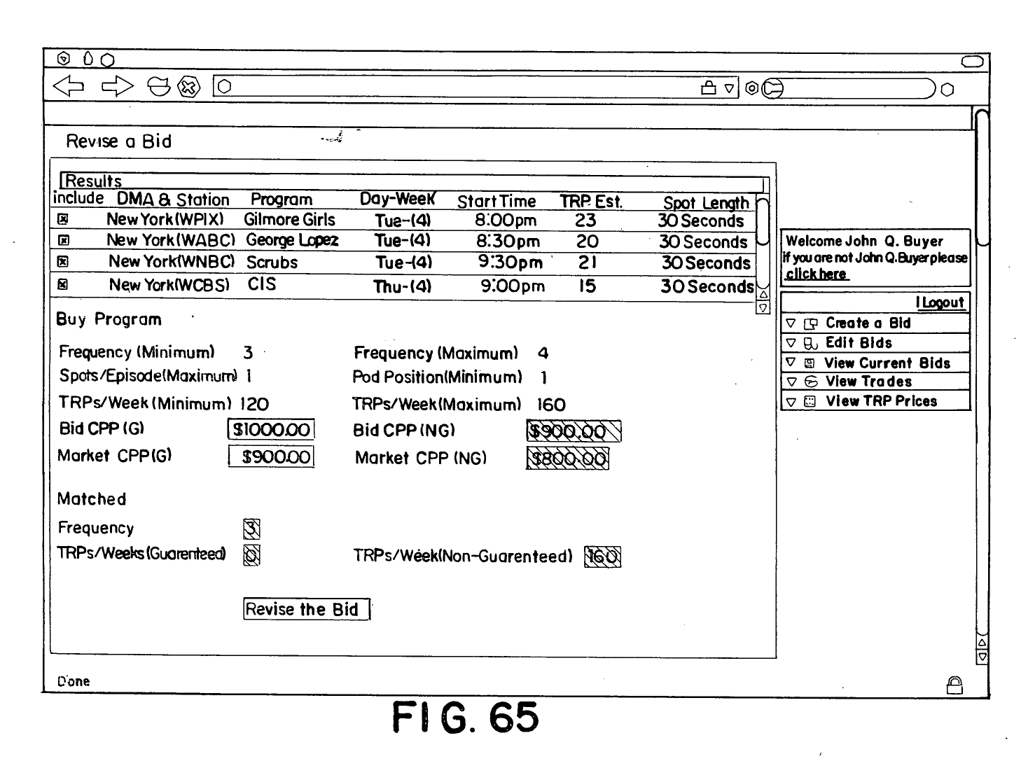

Upon activating the Submit Bid button, the buy program is sent to the exchange. FIG. 65 discloses the results of activating the Submit Bid button. The top of the screen lists the programs identified by the buyer as acceptable programs. The lower portion of the screen identifies current market prices for the buyer's desired viewers expressed on a Cost per Thousand (“CPP”) basis, and the very lower portion of the screen shows whether the buyer order is filled and, if it is, the “matched” values for frequency, reach (i.e., number of acquired targeted ratings points), and spots per episode, and whether the targeted ratings points have been acquired on an insured/guaranteed or uninsured/non-guaranteed basis.

The use of such parameters in a formal exchange setting is made possible by adjusting Nielsen Media Research's ratings data to take into account the extent to which viewers watch the same program episode after episode and the extent to which viewers migrate across programs. This is accomplished by applying known and existing statistical analyses to individual household viewing data (“IHVDA”). Several firms currently offer services that provide such analyses.

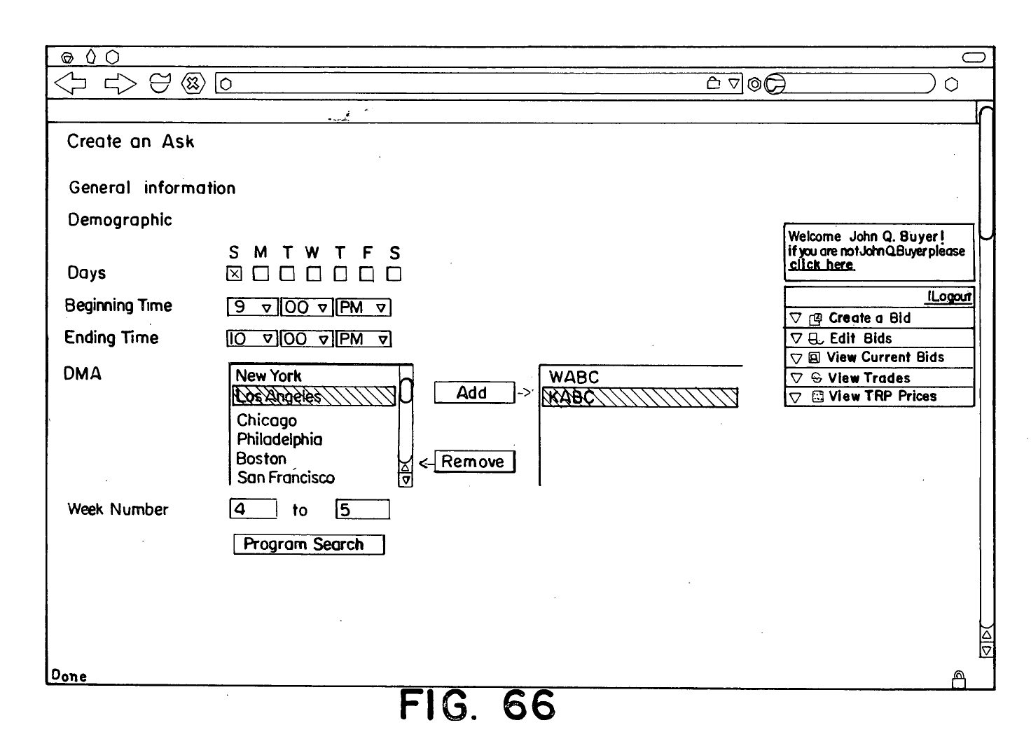

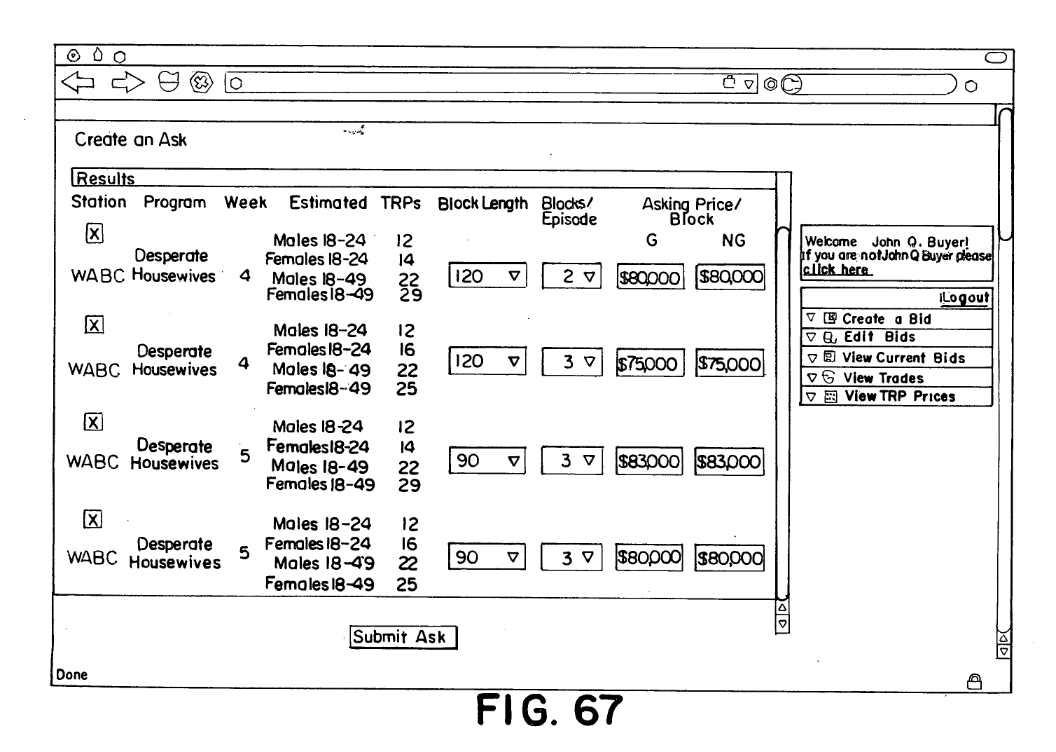

FIG. 66 discloses information on the day, time period, geographic location of the spots a media seller wishes to sell. As shown, sellers can select the day of the week, hour, geographic location (“DMA”), and week position of the spot they wish to sell. After identifying this information, sellers then activate the program search button in order to identify the set of programs that satisfy the sellers' market offer conditions. FIG. 67 discloses the set of programs that satisfy the seller's day of the week, hour, geographic area, and week program search requirements. As shown, sellers can select the programs spot from which they wish to offer to sell by clicking on the box on the left-hand side of the screen next to the program list. Included in this list are the estimates the seller provides to prospective buyers regarding the number of viewers, expressed on a TRP (“targeted ratings points”) basis, the seller believes will be attracted to its program during the relevant future period. In addition, sellers specify the number of continuous seconds the seller wishes to put up for sale, the number of such blocks it wishes to sell, and the asking price for each block if sold on either a guaranteed/insured or a non-guarantee/uninsured basis. After identifying its market order to sell, the seller will then activate the Submit Ask button located at the bottom of FIG. 67. Upon activating the Submit Ask button, the market order to sell is sent to the exchange.

The present invention improves upon the '785 application in other ways. Sellers are sometimes very concerned about the content of the advertisements that are inserted into their exhibited programs. In contrast to the '785 application, the present invention addresses this concern. One solution to this problem involves allowing the seller to identify a list of advertisers with whom trades are permitted. One problem with this solution is that there may be a price at which the seller is willing to air the advertiser's advertisement. The proposed solution cannot accommodate this possibility. The present invention provides sellers the flexibility they need to accommodate this possibility. In the present invention, in between rounds sellers are provided information showing the identity of the buyer with whom they have a provisional trade. If the seller is unhappy with a provisional trade, it has the ability to reject such a trade. A rejection serves to exclude that trade from the gains of trade calculation and, thus, the solution to the assignment problem. If the buyer wishes to acquire audience items from the seller, it has the opportunity to raise its bid in a subsequent round. At some point, the seller may accept the buyer's bid.

Finally, the present invention improves upon the '785 application in another important way. Buyers sometimes desire to have their advertisements placed after or before a competitor's advertisement or before or after an advertisement that has a complementary relationship with its own advertisement. For example, Intel currently pays computer makers (e.g., Dell, Gateway) for the right to insert an Intel promo into the computer maker's advertisement. Intel and the computer makers do this because there exists a complementary relationship between Intel's computer chip and the computer maker's equipment.

Rather than having Intel pay the computer makers for the right to insert its promo into the latter's advertisement, an alternative method for capitalizing on this complementary relationship is to permit Intel to place a bid that expresses its willingness to acquire several seconds of time immediately after the accepted bid of a computer maker. One advantage of this solution is that more informed market forces, rather than a bilateral negotiation between Intel and the computer maker, determine the price Intel pays for its several seconds of advertising time. Implementing such a process requires specifying a logical condition to the computer marker's market order. The logical condition, which is accounted for in the present invention, ensures that Intel's bid is only accepted if a computer maker's bid is also accepted, but not vice versa. There are numerous other opportunities to employ logical conditions in the bidding language. All of these conditions follow the same general form: Bid X for an N-second spot that immediately follows/precedes a spot acquired by firm i.

An automobile manufacturer sometimes desires to be the only advertiser in its product market (i.e., automobiles) that places an ad within a given pod. Implementing such a process requires specifying a logical XOR condition to the computer marker's market order. In this instance, the logical XOR condition, which is accounted for in the present invention, ensures that the automaker's bid is only accepted if another automobile maker's bid is not accepted. It also requires that the buyer submit to the information regarding how much it is willing to pay to be the sole advertiser in its product market within a given pod. There are several ways of implementing this. The most flexible method is to elicit from the buyer two pieces of information. The first piece of information represents the amount the buyer is willing to pay to acquire a spot in a pod. The second piece of information represents the premium the buyer is willing to pay to be the sole advertiser in its product market within a given pod.

In a particularly preferred embodiment of the present invention, the problem of identifying a set of trades that maximizes the gains from trade based upon the bids and offers placed in the market is called the “allocation problem.” Solving the allocation problem at each round involves solving the following mixed integer linear programming problem (MILP):

First define:

i=1, . . . , N_{B} indexes the market buy orders submitted;
j=1, . . . , N_{S} indexes the market sell orders submitted;
m=1, . . . , (N_{B}+N_{S}) indexes all the market orders submitted;
t=1, . . . , Nₚ indexes the program time slots available;
Price Bases: B=<insured-nonpreemptable, insured-preemptable, noninsured-nonpreemptable, noninsured-preemptable>;
Demographic Categories D={males 14-28, females 14-28, etc . . . };
Time Placement T=<week, day, time interval>;
Program Prg=<program name, network, DMA (or National), time placement>;
Offerⱼ: oⱼ=<program, price bases, impressions (by demographic), slots made available>;
oⱼₖ=Price bases for offer j, bases k=1,2,3,4;
Demographic Bidᵢ; bᵢ¹=<demographic, DMA Set, time placement, impressions constraints, slot constraints, price bases>;
Program Bidᵢ; bᵢ²=<program, DMA Set, time placement, impressions constraints, slot constraints, price bases>;
Bᵢₖ=Price bases for bid i, bases k=1,2,3,4 . . .
   Maximize:
   i V=ΣᵢΣⱼΣₖ (bᵢₖ−oⱼₖ) xᵢⱼ Gains from Exchange; (14)
   subject to:
bᵢ and oⱼ match by program or by demographic, DMA, time placement;
Impressions constraints are met;
Slot constraints are met;

m indicates a match between i and j.

| | |
|---|---|
| (15) I(bᵢ₁) + I(bᵢ₂) + I(bᵢ₃) + I(bᵢ₄) ≦ 1 | Only 1 bid base price allowed; |
| (16) I(oᵢ₁) + I(oᵢ₂) + I(oᵢ₃) + I(oᵢ₄) ≦ 1 | Only 1 offer base price allowed; |
| (17) 0 ≦ xₘ ≦ qⱼ ∀m | Feasibility Constraints; |
| (18) qₘₜ ≦ xₘₜ ≦ q̅ₘₜ ∀(m, t) | Feasibility Constraints; |
| (19) Σₘqₘₜ − Σₘxₘₜ ≦ 0 ∀t | Zero Excess Demand |
| | Constraints; |
| (20) Σ_{m∈L}ᵢⱼ intxₘ ≦ kᵢⱼ | Logical Constraints; |
| (21) xₘₜ ∈ I | Integer Feasibility Constraints; |

where V is the sum of producer and consumer surplus; and the decision variables are:
xₘ, the level at which market order m is allocated;
x=(x₁, x₂, . . . ,x_{M}) is the vector of all market order decision variables;
xᵢ is the sub-vector of market order decision variables that belong to individual i;

xₘₜ, the number of program time slots of type t which are allocated to market order m;
xₘ=(xₘ₁, xₘ₂, . . . ,x_{mT}) is the vector of program slots allocated to market order m;
   and the parameters (i.e., information) input by the buyers and sellers are:
xⱼₜ number of program slots of type t offered by seller j;
qₘₜ≧0 the minimum number of slots that bid i requests of type t;
q̅ₘₜ>0 the maximum number of slots that bid i requests of type t;
Lᵢⱼ defines the j^{th} logically bound subset of the set of market orders submitted by individual i;

The maximal total surplus generated by solving the above program V* is always greater than or equal to 0, the “do-nothing” alternative. The solution to the allocation problem is given by a set of market order acceptance levels {x*ₘ} governed by the constraints, where x*ₘ=0 indicates that market order m is not filled, and x*ₘ>0 indicates the market order m is filled to level x*ₘ; and a set of allocation vectors {x*ₘ} which assign a vector of program time slots to each market order and whose upper and lower bounds are governed by constraints (4) and (5). Constraints (2) and (3) restrict the trade between i and j to use only one price basis (i.e., a particular slot can not be sold on both a preemptable and non-preemptable basis, simultaneously). Constraint (6) requires that the allocated demand for a particular type of time slot not exceed its allocated supply. Finally, constraint (7) requires that in order for a market order to be accepted, the set of logical constraints associated with that order must be satisfied (e.g. “I'd like to fill order #3 or order #7 but not both.”).

To facilitate the price discovery process as well as to clear the final trades, the market requires the calculation of a set of prices for the traded slots/viewers given the solution to the above allocation problem. This problem can be referred to as the “pricing problem.” Such prices determine how much the buyers are charged and how much sellers receive from a particular trade. In other trading mechanisms for advertising time, either the pricing mechanism involves bilateral bargaining (i.e., BuyMedia, AdOutlet), was found to be objectionable by the buyers (i.e., AdAuction), or employing the complete set of buy and sell order submitted to the market multiple complex steps and computations which, if a competitive equilibrium price does not exist, results in a set of non-uniform, pseudo-competitive equilibrium prices (i.e., the '785 application) for the slot. The pricing algorithm proposed here involves two simple steps and results in a competitive equilibrium price for a slot if it exists or a uniform (i.e., single) pseudo-competitive equilibrium price for the slot if a competitive equilibrium price does not exist.

The prices calculated under the proposed algorithm satisfy, at the minimum, two criteria: (1) successful buyers must pay no more than they bid while successful sellers must receive no less than they asked, and; (2) the total amount that buyers pay must balance the total amount that sellers receive. This calculation is complicated by the fact that there might not exist, given the set of bids and offers submitted to the market and the requirement that the decision variables xₘ and xₘₜ are required to be integers, a set of competitive equilibrium prices. Using the information generated by the solution to the allocation problem, a competitive equilibrium set of prices would exist if the following conditions were satisfied.

| | |
|---|---|
| bᵢ − p · qᵢ ≧ 0 | for all accepted orders |
| oᵢ − p · qᵢ ≦ 0 | for all rejected orders |
| pₖ · Σ_{i∈A} qᵢ = 0 | Walras Law. |

Where a set of competitive equilibrium prices does not exist, a set of pseudo-competitive equilibrium prices is calculated. This preferred embodiment of the pricing algorithm includes only those market orders that are accepted by the market allocation algorithm. The pricing algorithm is formalized as follows:

$${Z}_{1} = {MAX}_{{p}_{t} dk , {W}_{i}} ( {\sum }_{k} {p}_{tdk} + {\sum }_{i} 1000.0 * {W}_{i} ) \qquad ( 22 )$$

subject to:
p_{tdk}≧0 for all t, d, k. (23)
Wᵢ≧0 for all i. (24)

$$\begin{matrix}{\sum }_{t} {p}_{tdk} * {v}_{td} * {x}_{it} + {W}_{i} \leq {b}_{ik} if i is a buy order . & ( 25 ) \\ {\sum }_{t} {p}_{tdk} * {v}_{td} * {x}_{it} - {W}_{i} \geq {o}_{ik} if i is a sell order . & ( 26 ) \\ {\sum }_{i \vert ( sells )} {W}_{i} = {\sum }_{i \vert ( buys )} {W}_{i} . & ( 27 )\end{matrix}$$

where:
p_{tdk} is the price of impressions for program t, demographic d, and price basis k;
ν_{td} is the number of impressions for program t, demographic d;
Wᵢ is the amount bid or offer i pays for receives because of the non-existence of a set of competitive equilibrium prices.

The problem can be solved by any standard linear programming routine or software; and a solution is guaranteed to exist. The amount order i pays or is paid is

$${\sum }_{t} {p}_{tdk} * {v}_{td} * {x}_{it} + {W}_{i} .$$

The uniqueness of a set of prices is not guaranteed. To address this problem, the set of prices that maximizes Z₁ are identified. The prices that minimize Z₂ are also identified where:

$${Z}_{2} = {MIN}_{{p}_{t} dk , {W}_{i}} ( {\sum }_{k} {p}_{tdk} - {\sum }_{i} 1000.0 * {W}_{i} ) \qquad ( 28 )$$

And, for each program demographic and price basis, the midpoint of these two prices is taken.

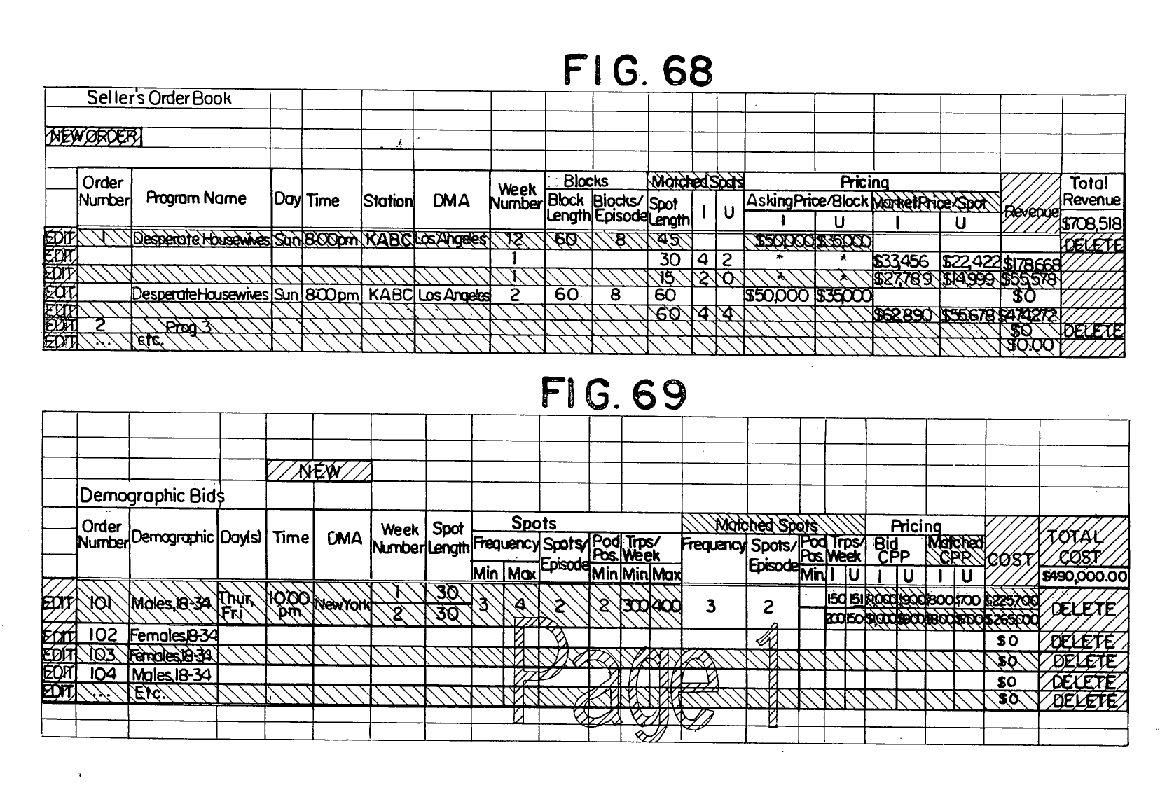

The present invention includes numerous electronic displayable files stored in trading system 11 and accessed by remote terminals 17 and 18. In a particularly preferred embodiment, FIGS. 68-73 represent various screen shots corresponding to the electronic displayable files. As discussed hereinbelow, each screen provides important information to the user while including data fields for receiving data from the user for transmission to central trade exchange 11. Although not shown, various screens may be provided for interfacing with a system operator for performing monitoring and administration functions associated with the exchange.

FIG. 68 displays a screen shot of the Seller's Order Book. A review of the screen shot indicates that the Seller's Order Book contains two different types of information: parameter information and market results information. Parameter information includes information that defines the sell order and that is specified by the seller, including Order Number, Program Name, Day of Week, Time of Day, Station, DMA, Week Number, Blocks, and Asking Price/Block. The Blocks parameter is further subdivided into Block Length and Blocks/Episode. Block length defines the number of continuous seconds up for sale, while Blocks/Episode defines the number of such blocks available per program episode. The Asking Price/Block, defined as the minimum price the seller would accept in exchange for one of its blocks, in this case a 120-second block, is further subdivided into I (Insured), and U (Uninsured).

The Order Number parameter is preferably auto-incrementing, assigned by the system of the present invention. In a further preferred embodiment, the system allows the seller to identify an order by name (assigned by the seller), such as ‘Premium’, ‘Bundle A’, etc. The Time of Day parameter identifies the start time of the program. In other embodiments, this can be changed to Day-Part, e.g. Prime Time. The Week Number parameter specifies which week in the schedule this order applies to. In a preferred embodiment of the system, this can span multiple weeks (but must be contiguous).

A user would preferably edit an existing order by selecting the edit button adjacent to the order (left side of screen). In this instance, the word “edit” refers to a change in the entries created by the seller and changes that occur prior to the order book's submission into the exchange. The selection of the edit button causes a new order edit screen to appear, filled with the contents of the order in question. Only one edit screen is allowed open at any time. A warning should be displayed if another edit screen is currently open. An order is deleted by selecting the delete button adjacent to the order (right side of screen). A confirmation screen appears.

A review of the screen shot also indicates that the Seller Order Book also contains market result information. The market result information is generated following the solution of the allocation and pricing problems based on the market order information submitted to the exchange by market participants. As noted elsewhere, the allocation problems refers to the identification of the set of trades that maximizes the total gains of trade, and the pricing problem refers to the identification of a set of prices that are consistent with that assignment. The Matched Spots field presents the results of the solution to the allocation and pricing problems as it applies to this particular seller. Specifically, the Matched Spots field is subdivided into the Spot Length and I (Insured) and U (Uninsured) fields. The Spot Length field depicts the length of the spot provisionally or otherwise sold, while the I (Insured) and U (Uninsured) fields depict the number of spots of sold provisionally or otherwise on an I (Insured) or an U (Uninsured) basis according to spot length. The Market Price/Spot field, which itself is subdivided into I (Insured) and U (Uninsured) fields, identifies the market prices established by the current invention for the seller's available blocks of time broken out by spot length and whether the spot is provisionally sold on either an insured or uninsured basis. The numerical values beneath the Revenue field satisfies the following mathematical expression:=I-Matched Spots*I-Match-Price+U-Matched*U-Match-Price. The Total Revenue field represents the sum of all the revenue the seller has earned, either provisionally or not, from all of its trades. At the appropriate time, the seller has the opportunity to revise, directly onto its Order Book, its Asking Price per Block Price in an attempt to sell additional blocks of time.

FIG. 69 displays a screen shot of the Buyer's Order Book—Demographic Bids. A review of the screen shot indicates that the Buyer's Order Book—Demographic Bids contains two different types of information: parameter information and market results information. Parameter information includes information that defines the buy order and that is specified by the buyer, including Order Number, Demographic, Days of Week, Time, DMA, Week Number, Spot Length, Spots, and Bid CPP. The Spots parameter is further subdivided into Frequency, Spots/Episode, Minimum Pod Position, and Targeted Ratings Points (TRPs) per Week. The Frequency parameter is further subdivided into Minimum and Maximum. The TRPs Per Week parameter is further subdivided into Minimum and Maximum. The CPP (i.e., cost per targeted rating point) parameter is further subdivided into I (Insured) and U (Uninsured). The numerical value established for the Bid CPP parameter defines the maximum amount the buyer is willing to pay for the target rating point.

As before, Order Number is auto-incrementing, assigned by the system. In a preferred embodiment of the system, the buyer has the ability to identify an order by name (assigned by the seller), such as ‘Premium’, etc. The Week Number parameter specifies which week in the schedule this order applies to. In a preferred embodiment of the system, this can span multiple weeks (but must be contiguous). Time of Day represents the start time of program. In other embodiments, this can be changed to Day-Part, e.g. Prime Time.

A user would preferably edit an existing order by selecting the edit button adjacent to the order (left side of screen). In this instance, the word “edit” refers to a change in the entries created by the buyer and changes that occur prior to the order book's submission into the exchange. The selection of the edit button causes a new order edit screen to appear, filled with the contents of the order in question. Only one edit screen is allowed open at any time. A warning should be displayed if another edit screen is currently open. An order is deleted by selecting the delete button adjacent to the order (right side of screen). A confirmation screen appears to verify the action.

A review of the screen shot also indicates that the Buyer's Order Book—Demographic Bids—also contains market result information. The market result information is generated following the solution to the allocation and pricing problems based on the market order information submitted to the exchange by market participants. As noted elsewhere, the allocation problems refers to the identification of the set of trades that maximizes the total gains of trade, and the pricing problem refers to the identification of a set of prices that are consistent with that assignment. The Matched Spots field presents the results of the solution to the allocation and pricing problems as it applies to this particular buyer. Specifically, the Matched Spots field is subdivided into Frequency, Spots/Episode, Minimum Pod Position, and TRPs per Week. The numerical values contained in these sub-fields depict how the buyer's buy order is “filled.” Because the assignment problem is a constrained optimization problem and the constraints include the parameters established by each buyer, if a buyer's order is filled, it will, by definition, be filled in a manner that satisfies the buyer's buy parameters.

The TRPs per Week subdivision is further subdivided into I (Insured), and U (Uninsured). The numerical values contained in these sub-fields depict the number of TRPs the buyer has provisionally or otherwise acquired on such bases. The Matched CPP (i.e., cost per targeted rating point) field is further subdivided into I (Insured), and U (Uninsured), and depicts the market prices for the buyer's provisionally or otherwise acquired TRPs. The numerical values beneath the Cost field satisfies the following mathematical expression:=I-Matched TRPs/Week*I-Matched-CPP+U-Matched TRPs/Week*U-Matched-CPP. The Total Cost field represents the sum of all the costs the buyer has incurred has earned, either provisionally or not, from all of its trades. At the appropriate time, the buyer has the opportunity to revise, directly onto its Order Book, its Bid CPP Price in an attempt to buy additional blocks of time.

The numerical values contained in all fields labeled “Matched” depict if and how the buyer's buy order is “filled.” Because the assignment problem is a constrained optimization problem and the constraints include the parameters established by each buyer, if a buyer's order is filled, it will, by definition, be filled in a manner that satisfies the buyer's buy parameters.

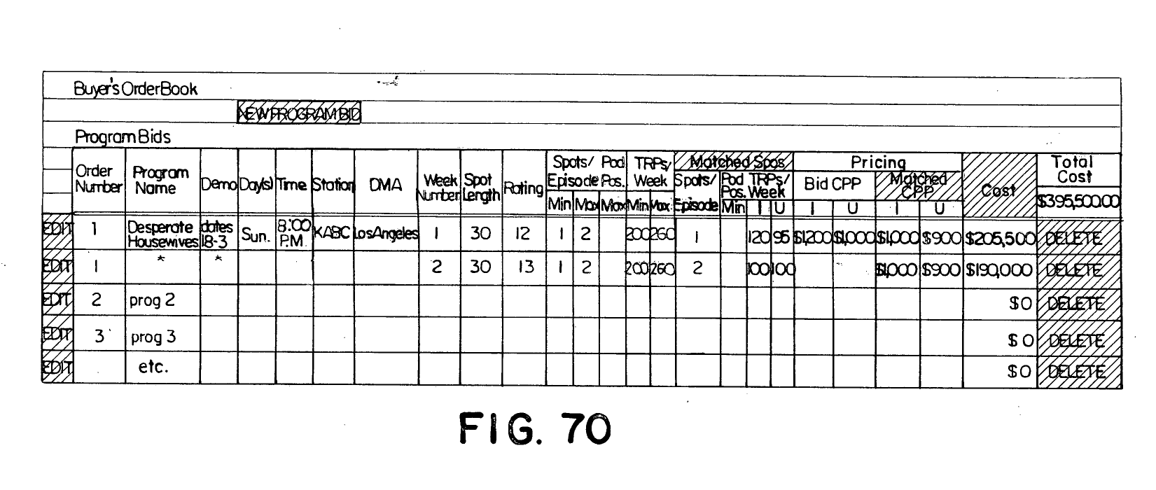

FIG. 70 displays a screen shot of the Buyer's Order Book—Program Bids. A review of the screen shot indicates that the Buyer's Order Book—Program Bids contains two different types of information: parameter information and market results information. Parameter information includes information that defines the buy order and that is specified by the buyer, including Order Number, Program Name, Demographic, Days of Week, Time, Station, DMA, Week Number, Spot Length, Rating, Spots per Episode, TRPs per Week, and Bid CPP. The Spots per Episode parameter is further subdivided into Minimum and Maximum. The TRPs per Week parameter is further subdivided into Minimum and Maximum and the Pricing parameter is divided into Bid CPP (i.e., cost per targeted rating point), which is further subdivided into I (Insured) and U (Uninsured). The numerical value established for the Bid CPP parameter defines the maximum amount the buyer is willing to pay for the targeted rating point.

As before, Order Number is auto-incrementing, assigned by the system. In a preferred embodiment of the system, the buyer has the ability to identify an order by name (assigned by the seller), such as ‘Premium’, etc. The Week Number parameter specifies which week in the schedule this order applies to. In a preferred embodiment of the system, this can span multiple weeks (but must be contiguous). Time of Day represents the start time of program. In other embodiments, this can be changed to Day-Part, e.g., Prime Time.

A user would preferably edit an existing order by selecting the edit button adjacent to the order (left side of screen). In this instance, the word “edit” refers to a change in the entries created by the buyer and changes that occur prior to the order book's submission into the exchange. The selection of the edit button causes a new order edit screen to appear, filled with the contents of the order in question. Only one edit screen is allowed open at any time. A warning should be displayed if another edit screen is currently open. An order is deleted by selecting the delete button adjacent to the order (right side of screen). A confirmation screen appears to verify this action.

A review of the screen shot also indicates that the Buyer's Order Book—Program Bids—also contains market result information. The market result information is generated following the solution to the allocation and pricing problems based on the market order information submitted to the exchange by market participants. As noted elsewhere, the allocation problems refers to the identification of the set of trades that maximizes the total gains of trade, and the pricing problem refers to the identification of a set of prices that are consistent with that assignment. The Matched Spots field presents the results of the solution to the allocation and pricing problems as it applies to this particular buyer. Specifically, the Matched Spots field is subdivided into Frequency, Spots/Episode, Maximum Pod Position, and TRPs per Week. The TRPs per Week subdivision is further subdivided into I (Insured), and U (Uninsured). The numerical values contained in these sub-fields depict the number of TRPs the buyer has provisionally or otherwise acquired on such bases. The Matched CPP (i.e., cost per targeted rating point) field is further subdivided into I (Insured) and U (Uninsured), and depicts the market prices for the buyer's provisionally or otherwise acquired TRPs. The numerical values beneath the Cost field satisfies the following mathematical expression:=I-Matched TRPs/Week*I-Matched-CPP+U-Matched TRPs/Week*U-Matched-CPP. The Total Cost field represents the sum of all the costs the buyer has incurred, either provisionally or not, from all of its trades. At the appropriate time, the buyer has the opportunity to revise, directly onto its Order Book, its Bid CPP Price in an attempt to buy additional blocks of time.

The numerical values contained in all fields labeled “Matched” depict if and how the buyer's buy order is “filled.” Because the assignment problem is a constrained optimization problem and the constraints include the parameters established by each buyer, if a buyer's order is filled, it will, by definition, be filled in a manner that satisfies the buyer's buy parameters.

Another figure is a preferred embodiment of a Buy Order screen. This screen is preferably used as the first screen for creating a new Buy Order. Upon the user's entry to this screen, the user must identify its desired demographic, the day(s) of the week it wishes to acquire its audience items, the beginning and ending time periods, the DMA(s) it wishes to acquire audience items in, the weeks during which it wishes to acquires its audience items, and its desired spot length. Upon activating the program search button, a search algorithm identifies the set of programs that satisfy the buyer's search requirements.

Another figure displays a list of programs that satisfies the buyer's search requirements, including the DMA location of the offered program, its exhibition day and time, estimated TRP expressed in terms of the demographic desired by the buyer, and its desired spot length. The buyer can identify the set of programs from which its buyer order can be filled by simply checking, for each program, the check box to the left of the DMA and Station field. Depending on the number of programs that are checked, the buyer either creates a program bid, or a demographic bid. Under a program bid, the only checks a single program, while under a demographics bid, the buyer checks more than one program.

This figure also displays a set of fields that, once responded to by the buyer, allows the buyer to identify their exact buy program, expressed in terms of predicted frequency (minimum) and frequency (maximum), spots per episode (maximum), pod position (minimum), TRPs per week (minimum), and TRPs per week (maximum). Because a buy program's “reach” is simply the number of TRPs/week acquired divided by the number “frequency,” it is clear that this figure shows that buyers have the ability to express their buy orders in terms of reach and frequency, the two parameters that define a buyer's buy order (i.e, buy program) under the current media trading process. However, unlike the current media trading process, under the present invention, buyers are able to explicitly define their buy programs and to have them efficiently filled. Under the conditions of the mathematical optimization, if the buyer completes a trade, the conditions of his/her buy program are completely satisfied. Under the current media trading process, buyers attempt to satisfy these conditions in a sequential fashion. Because the buyer is committed to each trade, this sequential process makes it possible that the buyer will be incapable of satisfying its buy program needs either because it has insufficient funds, the prices are too high, or because the desired audience items are unavailable for sale. Upon filling in all the requested information, the buyer can submit its buy order to the buyer's Order Book by activating the submit buy order button. The Order Book lists all of the buyer's created market orders.

Another figure is a preferred embodiment of a Sell Order screen. This screen is preferably used as the first screen for creating a new Sell Order. Upon the user's entry to this screen, the user must identify the day(s) of the week it wishes to sell its audience items, the beginning and ending time periods, the DMA(s) in which it wishes to sell its audience items, and the weeks for which it wishes to sell its audience items. Upon activating the program search button, a search algorithm searches through a data file that contains the seller's program schedule for all of its stations and identifies that set of programs that satisfies its search requirements.

Another figure displays a list of programs that satisfies the seller's search requirements, including the station call letters, program name, the exhibition week, a column where the seller inserts its estimate of the number of TRPs that will be delivered by its program across the different demographic categories, block length, the number of blocks per episode up for sale, and the minimum amount of money the seller requests per block for selling the block on a guaranteed versus an non-guaranteed basis. Upon filling in all the requested information, the seller can submit its sell order to the seller's Order Book by simply activating the submit ask button. The Order Book lists all of the seller's created market orders.

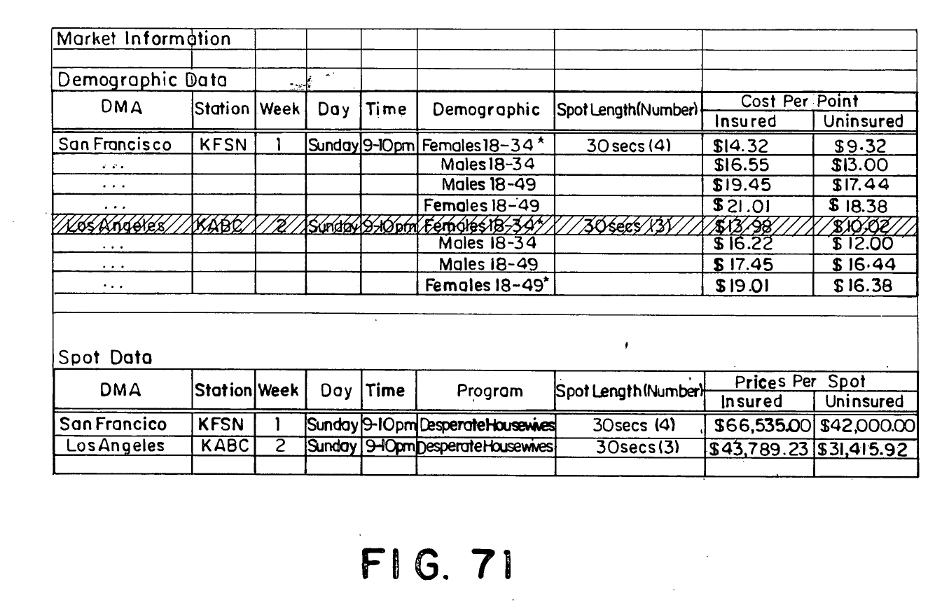

FIG. 71 displays a screen shot of the Market Information Screen available to sellers. A review of this screen indicates that it is split into two components, the Demographic Data and the Spot Data. The Demographic Data portion of this screen presents several fields of information, including DMA, Station, Week, Day, Time, Demographic, Spot Length and Number, I CPP, and U CPP. The Spot Data component presents several fields of information, including DMA, Station, Week, Day, Time, Program, Spot Length and Number, and Price per Spot. The Price per Spot component is further subdivided into two subdivisions, I (Insured) and U (Uninsured). In a preferred embodiment of the present invention, the Market Information screen permits sorting by any column of information.

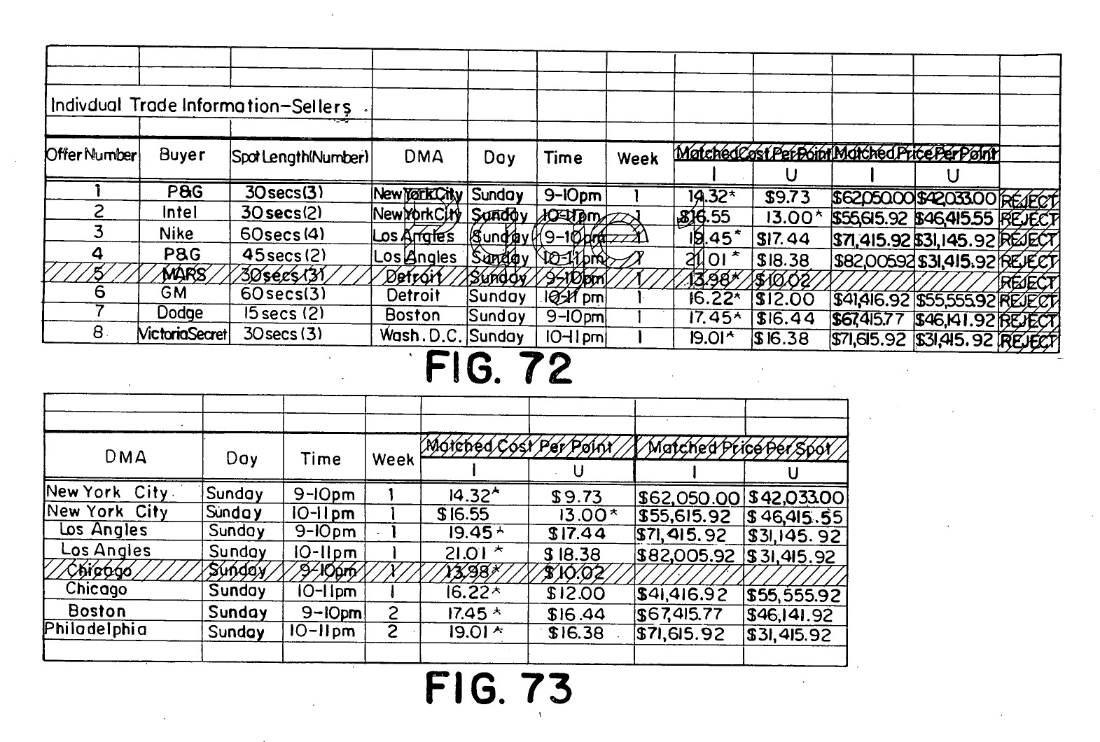

FIG. 72 displays a screen shot of the Individual Trade Information Screen—Sellers. It presents several fields of information, including Offer Number, Buyer, Spot Length and Number, DMA, Day, Time, Week, and Matched Cost Per Point, and Matched Price Per Spot. Both the Matched Cost Per Point and Matched Price Per Spot are further subdivided into two subdivisions, G (Guaranteed) and NG (Non-guaranteed).

FIG. 73 displays a screen shot of the Individual Trade Information Screen—Buyers. It presents several fields of information, including Buy Number, Station, Spot Length and Number, DMA, Day, Time, Week, and Matched Cost Per Point, and Matched Price Per Spot. Both the Matched Cost Per Point and Matched Price Per Spot are further subdivided into two subdivisions, I (Insured) and U (Uninsured).

In summary, the present invention provides an automated exchange system including a smart electronic double auction for allocating audience items among prospective buyers and sellers and for calculating a set of prices for the audience items based on buyer bids from the buyers and seller offers from the sellers, comprising: remote terminals for initiating and transmitting data including buyer bids and seller offers; and a central trade exchange system including a trading means for receiving buyer bids and seller offers from said remote terminals, simultaneously processing the buyer bids and the seller offers, identifying a set of trades in audience items between buyers and sellers which optimize gains obtained by buyers and sellers from the set of trades in audience items based on the bids and offers received by said trading means, and calculating a price for each audience item in the set of trades, and identifying rejected buyer bids and rejected seller offers. A logical XAND condition is preferably employed to identify a set of trades in audience items between buyers and sellers. The buyer preferably has the ability to express his/her buy orders in terms of reach and frequency.

The system can preferably assign a unique offer price to each demographic category across four different bases upon which audience items are typically sold (i.e., preemptable, insured; preemptable, uninsured; non-preemptable, insured; and non-preemptable, uninsured basis). Buyer bids preferably include single-item bids and multi-item bids and said seller offers include single-item offers and multi-item offers. Buyer bids and said seller offers can include program bids and day-part bids. Buyer bids preferably include adjacency bids for adjacency audience items positioned in time early in a program, the remote terminal capable of receiving an adjacency bid including an adjacency premium and transmitting the adjacency bid to the central exchange system. Buyer bids can include a bid excluding a program, and the trading means can further function to receive and process the buyer bid excluding the program.

Audience items can include a specific time length, where the trading means functions to for partition the specific time length audience item into multiple advertising spots. The set of trades can be a set of tentative trades, the trading means further functioning for calculating gains from the set of tentative trades received during a first pair of bidding rounds, calculating gains from a set of second trades received during a second pair of bidding rounds and selecting one of the set of tentative trades and the set of second trades having a largest gains from trade. The trading means can further function to perform a feasibility and internal consistency assessment of the buyer bids based on the seller offers.

The trading means can further function to determine whether a set of tentative trades exist after receiving both seller offers and buyer bids and closing the auction if no set of tentative trades exist after receiving both seller offers and buyer bids. Another function for trading means is to receive and process seller offer prices and buyer bid prices during a first set of bidding rounds and receive and process modified seller offer prices and modified buyer bid prices during a second set of bidding rounds, the trading means being preferably adapted to accept and process modified seller offer prices during said second set of bidding rounds which are less than the seller offer prices during the first set of bidding rounds and to reject modified seller offer prices during the second set of bidding rounds which are greater than the seller offer prices during the first set of bidding rounds, the trading means being further adapted to accept and process modified buyer bid prices during the second set of bidding rounds which are greater than the buyer bid prices during the first set of bidding rounds and to reject modified buyer bid prices during the second set of bidding rounds which are less than the buyer bid prices during the first set of bidding rounds.

This invention has been described in connection with the preferred embodiments. These embodiments are intended to be illustrative only. It will be readily appreciated by those skilled in the art that modifications may be made to these preferred embodiments without departing from the scope of the invention as defined herein.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An automated exchange system including a smart electronic double auction for allocating audience items among prospective buyers and sellers and for calculating a set of prices for the audience items based on buyer bids from the buyers and seller offers from the sellers, comprising:
remote terminals for initiating and transmitting data including buyer bids and seller offers; and
a central trade exchange system including
a trading means for receiving buyer bids and seller offers from said remote terminals,
processing the buyer bids and the seller offers,
identifying a set of trades in audience items between buyers and sellers which optimize gains obtained by buyers and sellers from the set of trades in audience items based on the bids and offers received by said trading means, and
calculating a price for each audience item in the set of trades,
wherein the audience items comprise a plurality of categories, and
wherein the sellers can submit a unique offer for each category in the plurality of categories.

2. The system of claim 1, wherein the plurality of categories consists essentially of: (1) preemptable, insured; (2) preemptable, uninsured; (3) non-preemptable, insured; and (4) non-preemptable, uninsured basis.

3. The system of claim 1, wherein the system is adapted so that each of the buyers can specify its own reach and frequency requirements.

4. The system of claim 1, wherein the system is adapted so that a seller can identify a specific prospective buyer as an undesirable buyer and adjust an asking price of the seller upward in order to reduce the likelihood of a trade with the undesireable buyer.

5. The system of claim 4, wherein the system is adapted so that the undesireable buyer can bid again with a higher bid.

6. The system of claim 1, wherein the audience items include available advertising time on specified broadcast shows, other programming, viewing content and/or listening content, and wherein the system is adapted so that a buyer can bid on available advertising time on specified broadcast shows, other programming, viewing content and/or listening content, wherein the specified broadcast show, other programming, viewing content and/or listening content that the buyer bids on is selected from a list, and the list is generated from a search procedure over content that satisfies self-identified buy program parameters of the buyer.

7. The system of claim 1, wherein the system is adapted such that one buyer can specify a placement relationship for an audience item with respect to a placement of an audience item by another buyer.

8. An automated method of allocating audience items among prospective buyers and sellers based on buyer bids from the buyers and seller offers from the sellers, comprising the steps of:
receiving, in a computer, buyer bids to buy audience items and seller offers to sell audience items, wherein the buyer bids specify reach and/or frequency requirements;
processing the buyer bids and the seller offers;
identifying, given constraints imposed by individual reach and/or frequency of requirements of buyers, all different possible sets of trades between buyers and sellers in audience items and identifying a set of trades in audience items which optimize gains obtained by buyers and sellers based on the bids and the offers received by the computer;
calculating a price for each audience item in a set of trades that optimize gains obtained by buyers and sellers;
identifying rejected buyer bids and rejected seller offers;
transmitting electronic notifications of accepted buyer bids and seller offers forming the set of trades, said rejected buyer bids and said rejected seller offers, to respective remote buyer terminals and remote seller terminals.

9. The automated method of claim 8, wherein the audience items comprise more than one type of audience item, and wherein the seller offers can differ for each type of audience item.

10. The automated method of claim 9, wherein the audience items are in the form of access to television viewers, and wherein demographic type refers to a distinct viewer demographic.

11. The automated method of claim 8, wherein the buyer bids further specify spots per episode requirements of the individual buyers and the different possible sets of trades identified take into account the spots per episode requirements of the individual buyers.

12. The automated method of claim 11, wherein buyers create a buy program that includes parameters, wherein reach, frequency and spots per episode are the parameters, and wherein the buyers can set a minimum and a maximum of the reach, frequency, and spots per episode parameters for the buy program.

13. The automated method of claim 12, wherein the audience items are in the form of access to television viewers, radio listeners, and internet users, there is more than one type of a distinct viewer demographic, listener demographic, or internet user demographic and wherein viewing, listening and/or internet use data are provided for measuring the number of viewers, listeners and/or users, by viewer, listener and/or user demographic, for the viewing, listening or internet using content, and the method further comprises adjusting the viewing, listening and/or internet use data by applying statistical analyses to the viewing, listening and/or internet use data for determining an extent to which viewers view a program episode after episode, listeners listen or migrate across a radio broadcast program and/or the internet users use and visit a specific website.

14. The automated method of claim 8, wherein a prospective trade is found between a particular seller and a particular buyer, and the method further comprises showing the particular seller the identity of the particular buyer.

15. The automated method of claim 14, wherein the particular seller rejects the particular buyer's bid, wherein there are multiple rounds of buyer bids and seller offers, and wherein the particular buyer can submit a higher bid in a subsequent round.

16. The automated method of claim 8, wherein each of a first buyer and a second buyer submit bids, further comprising specifying a logical condition for the first buyer's bid of a form “bid X for an N-Second spot that immediately follows/precedes a spot acquired by the second buyer” so that the second buyer's bid is accepted only if the first buyer's bid is accepted.

17. The automated method of claim 16, wherein each of a first buyer and a second buyer submit bids, and the method further comprises specifying a logical XOR condition for the first buyer's bid so that its bid is only accepted if the second buyer's bid is not.

18. The automated method of claim 16, wherein the audience items are opportunities to advertise to viewers of viewing content, listeners of listening content and/or internet users of an internet website, wherein each of the first and second buyers' bids are accepted, and the method further comprises specifying that the second buyer's opportunity to advertise occurs after the first buyer's opportunity to advertise.

19. A method for sellers to sell advertising spots and for buyers to buy the advertising spots, comprising the steps of:
providing a computer system adapted to receive asking prices from sellers and bid prices from buyers, wherein the computer system is adapted to compare the bid price for a spot with the asking price for the spot;
adapting the computer system so that sellers can designate different asking prices for each viewer demographic category;
adapting the computer system so that buyers can designate reach, frequency, and/or spots per episode;
showing a first seller a prospective trade with a first buyer; and
allowing the first seller to reject the prospective trade with the first buyer.

20. The method of claim 19, wherein a third buyer can specify a time or spacing relationship between an advertising spot that the third buyer bids on and a different advertising spot that a fourth buyer bids on.

21. The method of claim 20, wherein the advertising spots are in a media selected from the group consisting of television, radio, movies, magazines, newspapers, billboards, computer files, internet and telephone.

22. The method of claim 19, further comprising the steps of:
receiving and processing seller asking prices and buyer bid prices during a first set of bidding rounds;
receiving and processing modified seller asking prices and modified buyer bid prices during a second set of bidding rounds including accepting and processing modified seller asking prices during the second set of bidding rounds which are less than the seller asking prices during the first set of bidding rounds,
rejecting modified seller asking prices during the second set of bidding rounds which are greater than the seller asking prices during the first set of bidding rounds;
accepting and processing modified buyer bid prices during the second set bidding rounds which are greater than the buyer bid prices during the first set of bidding rounds; and
rejecting modified buyer bid prices during said second set of bidding rounds which are less than the buyer bid prices during the first set of bidding rounds.
